(19) United States
(12) Patent Application Publication
(10) Pub. No.: US 2023/0107880 A1
(43) Pub. Date: Apr. 6, 2023

(54) METHOD AND APPARATUS FOR BEAM FAILURE DETECTION AND RECOVERY

(71) Applicant: Samsung Electronics Co., Ltd., Suwon-si (KR)

(72) Inventors: Dalin Zhu, Richardson, TX (US); Eko Onggosanusi, Coppell, TX (US); Emad N. Farag, Flanders, NJ (US)

(21) Appl. No.: 17/935,027

(22) Filed: Sep. 23, 2022

Related U.S. Application Data
(60) Provisional application No. 63/251,426, filed on Oct. 1, 2021.
(60) Provisional application No. 63/272,548, filed on Oct. 27, 2021.
(60) Provisional application No. 63/275,822, filed on Nov. 4, 2021.
(60) Provisional application No. 63/280,880, filed on Nov. 18, 2021.

(51) Int. Cl. H04L 5/00

(52) U.S. Cl. CPC H04L 5/006; H04L 5/0023; H04L 5/0094; H04L 5/0051

(57) ABSTRACT

Methods and apparatuses for beam failure detection in a wireless communication system. A method for operating a user equipment (UE) includes receiving downlink control information (DCI) including a first TCI field indicating a first transmission configuration indication (TCI) state; receiving information about a type of the first TCI state; and determining, based on the first TCI state and the type of the first TCI state, a first set of beam failure detection (BFD) reference signal (RS) resource configuration indexes. The type of the first TCI state is a joint TCI state indicated by a DLorJointTCIState parameter, a separate downlink (DL) TCI state indicated by a DLorJointTCIState parameter, or a separate UL TCI state indicated by a UL-TCIState parameter. The BFD RS resource configuration indexes correspond to periodic CSI-RS resource configuration indexes.

### CROSS-REFERENCE TO RELATED APPLICATIONS AND CLAIM OF PRIORITY

The present application claims priority to:
U.S. Provisional Patent Application No. 63/251,426, filed on Oct. 1, 2021;
U.S. Provisional Patent Application No. 63/272,548, filed on Oct. 27, 2021;
U.S. Provisional Patent Application No. 63/275,822, filed on Nov. 4, 2021; and
U.S. Provisional Patent Application No. 63/280,880, filed on Nov. 18, 2021. The contents of the above-identified patent documents are incorporated herein by reference.

### TECHNICAL FIELD

The present disclosure relates generally to wireless communication systems and, more specifically, the present disclosure relates to beam failure detection and recovery in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to beam failure detection and recovery in a wireless communication system.

In one embodiment, a user equipment (UE) is provided. The UE includes a transceiver configured to receive downlink control information (DCI) including a first TCI field indicating a first transmission configuration indication (TCI) state and receive information about a type of the first TCI state. The UE further includes a processor operably coupled to the transceiver. The processor is configured to determine, based on the first TCI state and the type of the first TCI state, a first set of beam failure detection (BFD) reference signal (RS) resource configuration indexes. The first TCI state indicates at least one of: a RS for quasi co-location for at least one of: (1) a demodulation RS (DM-RS) of a first physical downlink shared channel (PDSCH) in a component carrier (CC), (2) a DM-RS of a first physical downlink control channel (PDCCH) in the CC, and (3) a first channel state information RS (CSI-RS), and a reference for determining an uplink (UL) transmission spatial filter for at least one of: (1) a dynamic-grant and configured-grant based first physical uplink shared channel (PUSCH) in the CC, (2) a first physical uplink control channel (PUCCH) resource in the CC, and (3) a first sounding reference signal (SRS). The type of the first TCI state is a joint TCI state indicated by a DLorJointTCIState parameter, a separate downlink (DL) TCI state indicated by a DLorJointTCIState parameter, or a separate UL TCI state indicated by a UL-TCIState parameter. The BFD RS resource configuration indexes correspond to periodic CSI-RS resource configuration indexes.

In another embodiment, a base station (BS) is provided. The BS includes a transceiver configured to transmit DCI including a first TCI field indicating a first TCI state; and transmit information about a type of the first TCI state. The first TCI state and the type of the first TCI state indicate, at least in part, a first set of BFD RS resource configuration indexes. The first TCI state indicates at least one of: a RS for quasi co-location for at least one of: (1) a DM-RS of a first physical PDSCH in a CC, (2) a DM-RS of a first PDCCH in the CC, and (3) a first CSI-RS; and a reference for determining an UL transmission spatial filter for at least one of: (1) a dynamic-grant and configured-grant based first PUSCH in the CC, (2) a first PUCCH resource in the CC, and (3) a first SRS. The type of the first TCI state is a joint TCI state indicated by a DLorJointTCIState parameter, a separate DL TCI state indicated by a DLorJointTCIState parameter, or a separate UL TCI state indicated by a UL-TCIState parameter. The BFD RS resource configuration indexes correspond to periodic CSI-RS resource configuration indexes.

In yet another embodiment, a method for operating a UE is provided. The method includes receiving DCI including a first TCI field indicating a first TCI state; receiving information about a type of the first TCI state; and determining, based on the first TCI state and the type of the first TCI state, a first set of BFD RS resource configuration indexes. The first TCI state indicates at least one of: a RS for quasi co-location for at least one of: (1) a DM-RS of a first PDSCH in a CC, (2) a DM-RS of a first PDCCH in the CC, and (3) a first CSI-RS; and a reference for determining an UL transmission spatial filter for at least one of: (1) a dynamic-grant and configured-grant based first PUSCH in the CC, (2) a first PUCCH resource in the CC, and (3) a first SRS. The type of the first TCI state is a joint TCI state indicated by a DLorJointTCIState parameter, a separate DL TCI state indicated by a DLorJointTCIState parameter, or a separate UL TCI state indicated by a UL-TCIState parameter. The BFD RS resource configuration indexes correspond to periodic CSI-RS resource configuration indexes.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of PCell beam failure according to embodiments of the present disclosure;

FIG. 9 illustrates an example of SCell beam failure according to embodiments of the present disclosure;

FIG. 10 illustrates an example of MAC CE based TCI state/beam activation/indication for the single-TRP operation according to embodiments of the present disclosure;

FIG. 11 illustrates an example of DCI based TCI state/beam indication for the single-TRP operation according to embodiments of the present disclosure;

FIG. 12 illustrates an example of DCI based TCI state/beam indication with MAC CE activated TCI states for the single-TRP operation according to embodiments of the present disclosure;

FIG. 13 illustrates an example of MAC CE based TCI state/beam activation/indication for the multi-TRP operation according to embodiments of the present disclosure;

FIG. 14 illustrates an example of DCI based TCI state/beam indication for the multi-TRP operation according to embodiments of the present disclosure;

FIG. 15 illustrates another example of DCI based TCI state/beam indication with MAC CE activated TCI states for the multi-TRP operation according to embodiments of the present disclosure;

FIG. 16 illustrates a signaling flow of beam failure recovery procedures according to embodiments of the present disclosure;

FIG. 17 illustrates a signaling flow of SCell beam failure recovery procedures according to embodiments of the present disclosure; and

FIG. 18 illustrates an example of beam failure in a multi-TRP system according to embodiments of the present disclosure.

### DETAILED DESCRIPTION

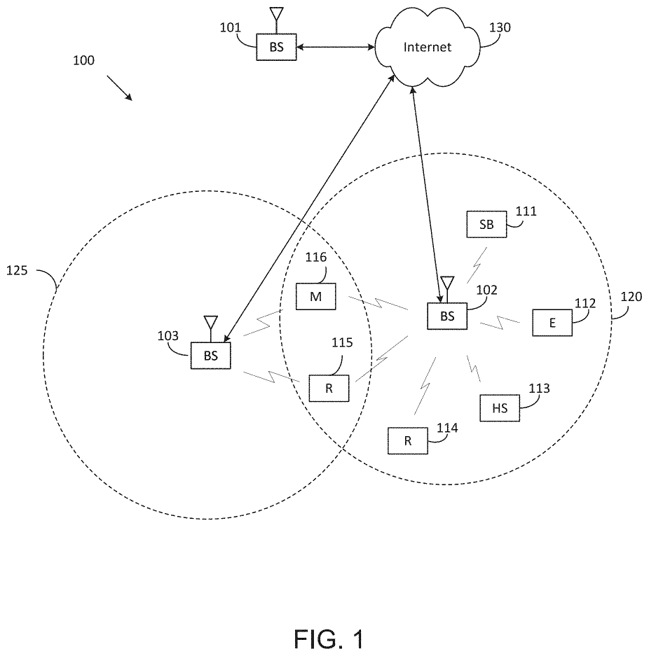

FIG. 1 through FIG. 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for beam failure detection and recovery in a wireless communication system. In certain embodiments, and one or more of the gNBs 101-103 includes circuitry, programing, or a combination thereof, for beam failure detection and recovery in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

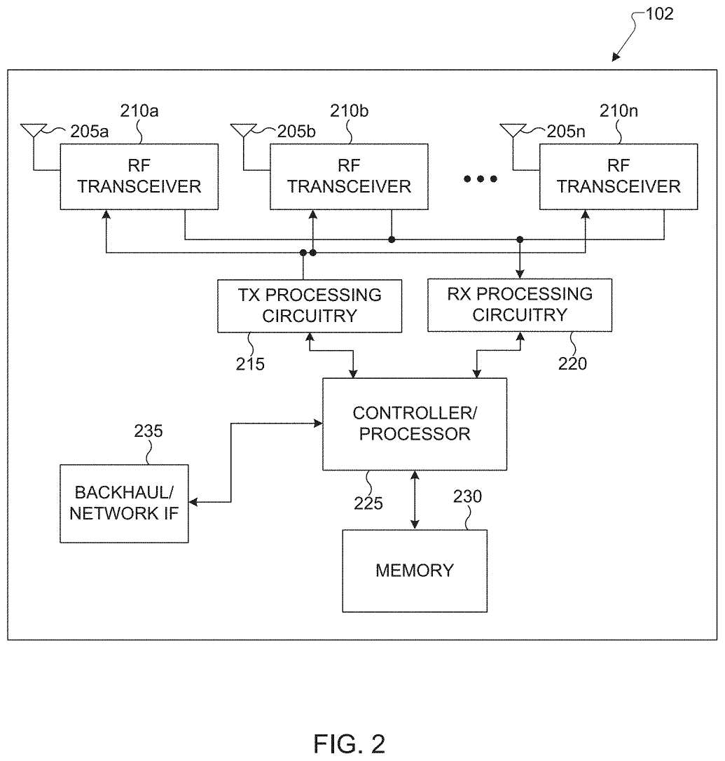

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support beam failure detection and recovery in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

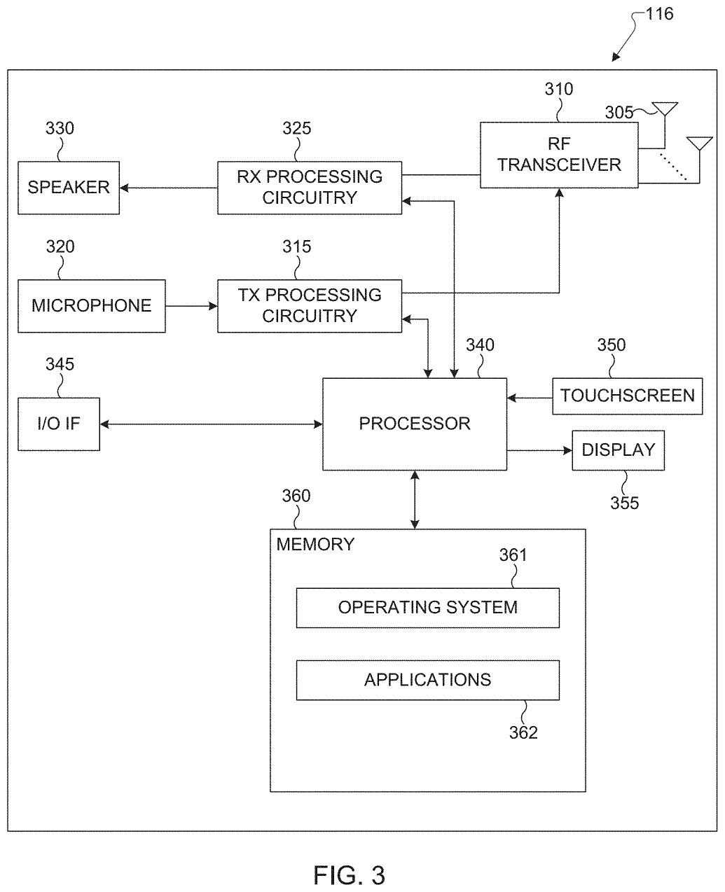

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and RX processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam failure detection and recovery in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

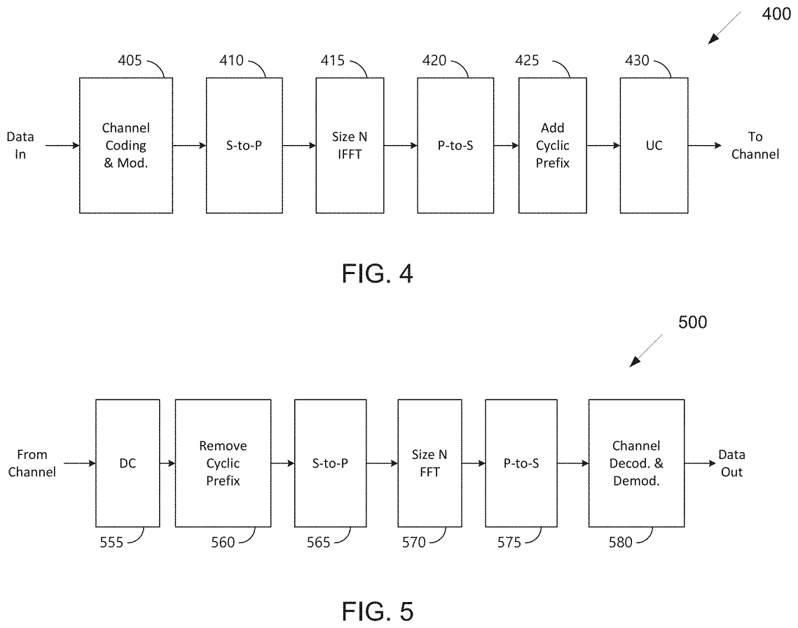

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a downconverter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

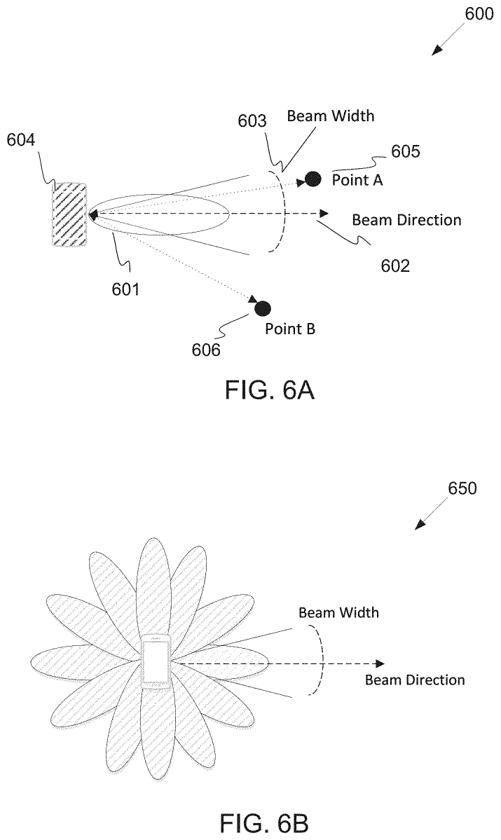

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

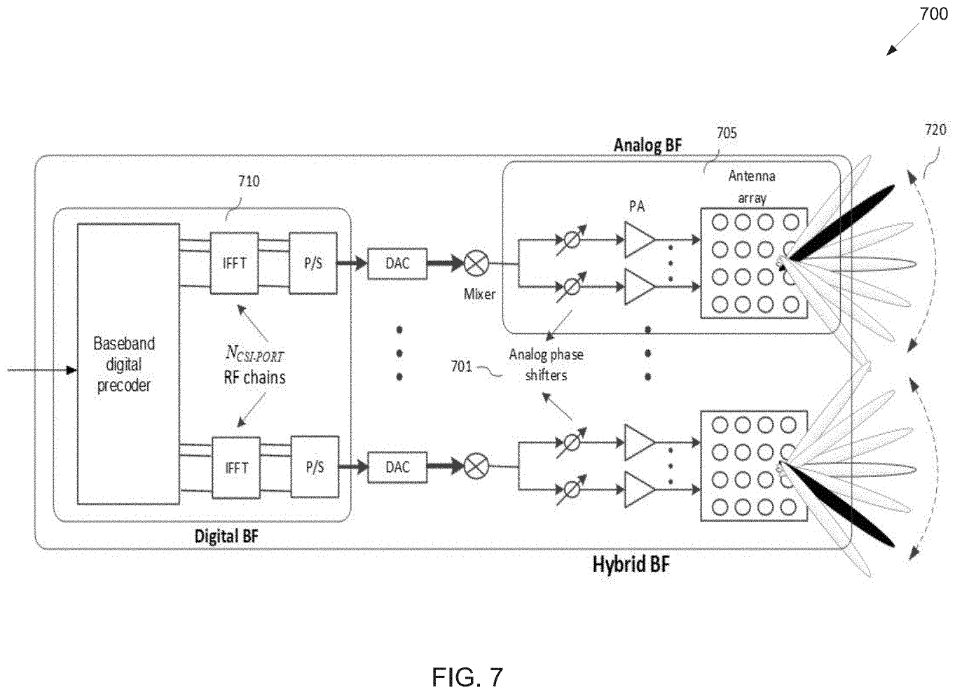

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CS}I-PORT A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @ 100 m distance), larger number of and sharper analog beams (hence larger number of radiators in the array) may be needed to compensate for the additional path loss.

In a wireless communications system, a radio link failure (RLF) could occur if a significant/sudden link quality drop is observed at the UE side. If a RLF occurs, fast RLF recovery mechanisms, therefore, become essential to promptly re-establish the communication link(s) and avoid severe service interruption. At higher frequencies, e.g., millimeter-wave (mmWave) frequencies or FR2 in the 3GPP NR, both the transmitter and receiver could use directional (analog) beams to transmit and receive various RSs/channels such as SSBs, CSI-RSs, PDCCHs or PDSCHs. Hence, prior to declaring a full RLF, the UE could first detect and recover a potential beam failure if the signal qualities/strengths of certain beam pair links (BPLs) are below a certain threshold for a certain period of time.

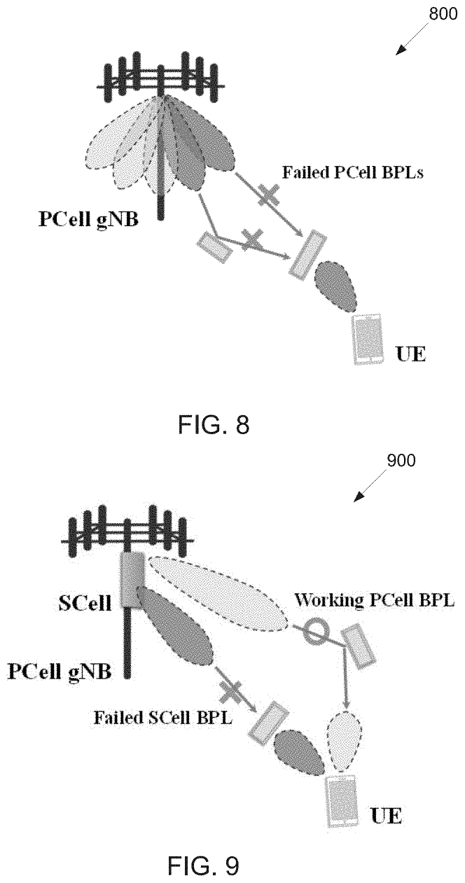

FIG. 8 illustrates an example of PCell beam failure 800 according to embodiments of the present disclosure. An embodiment of the PCell beam failure 800 shown in FIG. 8 is for illustration only.

The 3GPP Rel. 15 beam failure recovery (BFR) procedure mainly targets for a primary cell (PCell or PSCell) under the carrier aggregation (CA) framework as shown in FIG. 8. The BFR procedure in the 3GPP Rel. 15 comprises the following key components: (1) beam failure detection (BFD); (2) new beam identification (NBI); (3) BFR request (BFRQ); and (4) BFRQ response (BFRR).

The UE is first configured by the gNB a set of BFD RS resources to monitor the link qualities between the gNB and the UE. One BFD RS resource could correspond to one (periodic) CSI-RS/SSB RS resource, which could be a quasi-co-located (QCL) source RS with typeD in a TCI state for a CORESET. If the received signal qualities of all the BFD RS resources are below a given threshold (implying that the hypothetical BLERs of the corresponding CORESETs/PDCCHs are above a given threshold), the UE could declare a beam failure instance (BFI). Furthermore, if the UE has declared N_BFI consecutive BFIs within a given time period, the UE may declare a beam failure.

After declaring/detecting the beam failure, the UE may transmit the BFRQ to the gNB via a contention-free (CF) PRACH (CF BFR-PRACH) resource, whose index is associated with a new beam identified by the UE. Specifically, to determine a potential new beam, the UE may be first configured by the network a set of SSB and/or CSI-RS resources (NBI RS resources) via a higher layer parameter candidateBeamRSList. The UE may then measure the NBI RSs and calculate their L1-RSRPs. If at least one of the measured L1-RSRPs of the NBI RSs is beyond a given threshold, the UE may select the beam that corresponds to the NBI RS with the highest L1-RSRP as the new beam.

To determine a CF BFR-PRACH resource to convey the BFRQ, the UE could be first configured by the network a set of PRACH resources, each associated with a NBI RS resource. The UE could then select the PRACH resource that has the one-to-one correspondence to the selected NBI RS resource (the new beam) to send the BFRQ to the gNB. From the index of the selected CF PRACH resource, the gNB could also know which beam is selected by the UE as the new beam.

Four slots after the UE has transmitted the BFRQ, the UE could start to monitor a dedicated CORESET/search space for BFRQ response. The dedicated CORESET is addressed to the UE-specific C-RNTI and may be transmitted by the gNB using the newly identified beam. If the UE detects a valid UE-specific DCI in the dedicated CORESET for BFRR, the UE may assume that the beam failure recovery request has been successfully received by the network, and the UE may complete the BFR process. Otherwise, if the UE does not receive the BFRR within a configured time window, the UE may initiate a contention based (CB) random access (RA) process to reconnect to the network.

FIG. 9 illustrates an example of SCell beam failure 900 according to embodiments of the present disclosure. An embodiment of the SCell beam failure 900 shown in FIG. 9 is for illustration only.

In the 3GPP Rel. 16, the BFR procedures were customized for the secondary cell (SCell) under the CA framework, in which the BPL(s) between the PCell and the UE is assumed to be always working. An illustrative example of the SCell beam failure is given in FIG. 9.

After declaring/detecting the beam failure for the SCell, the UE may transmit the BFRQ in form of a scheduling request (SR) over a PUCCH for the working PCell. Furthermore, the UE could only transmit the BFRQ at this stage without indicating any new beam index, failed SCell index or other information to the network. This is different from the Rel. 15 PCell/PSCell procedure, in which the UE may indicate both the BFRQ and the identified new beam index to the network at the same time. Allowing the gNB to quickly know the beam failure status of the SCell without waiting for the UE to identify a new beam could be beneficial. For instance, the gNB could deactivate the failed SCell and allocate the resources to other working SCells.

The UE could be indicated by the network uplink grant in response to the BFRQ SR, which may allocate necessary resources for the MAC CE to carry new beam index (if identified), failed SCell index and etc. over the PUSCH for the working PCell. After transmitting the MAC CE for BFR to the working PCell, the UE may tart to monitor the BFRR. The BFRR could be a TCI state indication for a CORESET for the corresponding SCell. The BFRR to the MAC CE for BFR could also be a normal uplink grant for scheduling a new transmission for the same HARQ process as the PUSCH carrying the MAC CE for BFR. If the UE could not receive the BFRR within a configured time window, the UE could transmit BFR-PUCCH again, or fall back to CBRA process.

As mentioned herein, in the current 3GPP Rel. 15/16 based BFR designs, the UE could be explicitly configured by the network (via higher layer RRC signaling) one or more BFD RS resources to measure. Alternatively, the UE could implicitly determine the one or more BFD RS resources as the QCL source RS(s) indicated in active TCI state(s) for one or more PDCCH(s). The explicit and implicit BFD RS configurations described herein are based on the Rel. 15/16 TCI framework. Under the Rel. 17 unified TCI framework, wherein a TCI state update could be indicated via DCI, enhancements to both the explicit and implicit BFD RS configurations are needed.

The present disclosure considers various design aspects for BFD RS configuration following the unified TCI framework specified in Rel. 17, wherein a common beam indication could be applied for all DL and UL channels via DCI.

As described in the U.S. patent application Ser. No. 17/584,239, which is incorporated by reference in its entirety, a unified TCI framework could indicate/include N≥1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s).

There could be various design options/channels to indicate to the UE a beam (i.e., a TCI state) for the transmission/reception of a PDCCH or a PDSCH. As described in the U.S. patent application Ser. No. 17/584,239, which is incorporated by reference in its entirety: (1) in one example, a MAC CE could be used to indicate to the UE a beam (i.e., a TCI state and/or a TCI state ID) for the transmission/reception of a PDCCH or a PDSCH; and (2) in another example, a DCI could be used to indicate to the UE a beam (i.e., a TCI state and/or a TCI state ID) for the transmission/reception of a PDCCH or a PDSCH: (i) for example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (ii) for another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and (iii) yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state can be used at least for UE-dedicated DL channels; or (3) in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

As discussed herein, a UE could be provided by the network, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination of N>1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources.

Throughout the present disclosure, the term “configuration” or “higher layer configuration” and variations thereof (such as “configured” and so on) could be used to refer to one or more of: a system information signaling such as by a MIB or a SIB (such as SIB1), a common or cell-specific higher layer/RRC signaling, or a dedicated or UE-specific or BWP-specific higher layer/RRC signaling.

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values: (1) ‘typeA’: {Doppler shift, Doppler spread, average delay, delay spread}, (2) ‘typeB’: {Doppler shift, Doppler spread}, (3) ‘typeC’: {Doppler shift, average delay}, and (4) ‘typeD’: {Spatial Rx parameter}.

The UE can be configured with a list of up to 128 DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS.

If the DLorJointTCIState or UL-TCIState configurations are absent in a BWP of the CC, the UE can apply the DLorJointTCIState or UL-TCIState configurations from a reference BWP of a reference CC. The UE is not expected to be configured with TCI-State, SpatialRelationInfo or PUCCH-SpatialRelationInfo, except SpatialRelationInfoPos in a CC in a band, if the UE is configured with DLorJointTCIState or UL-TCIState in any CC in the same band. The UE can assume that when the UE is configured with TCI-State in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with DLorJointTCIState or UL-TCIState in any CC within the same band in the CC list.

The UE receives an activation command, as described in clause 6.1.3.14 of [10, TS 38.321] or 6.1.3.x of [10, TS 38.321], used to map up to 8 TCI states and/or pairs of TCI states, with one TCI state for DL channels/signals and one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.

The Unified TCI States Activation/Deactivation MAC CE is identified by a MAC subheader with eLCID as specified in Table 6.2.1-1b in TS 38.321. It has a variable size consisting of one or more of the following fields: (1) serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331, this MAC CE applies to all the Serving Cells in the set simultaneousU-TCI-UpdateList1, simultaneousU-TCI-UpdateList2, simultaneousU-TCI-UpdateList3 or simultaneousU-TCI-UpdateList4, respectively; (2) DL BWP ID: This field indicates a DL BWP for which the MAC CE applies as the codepoint of the DCI bandwidth part indicator field as specified in TS 38.212. The length of the BWP ID field is 2 bits; (3) UL BWP ID: This field indicates a UL BWP for which the MAC CE applies as the codepoint of the DCI bandwidth part indicator field as specified in TS 38.212. The length of the BWP ID field is 2 bits; (4) Pᵢ: This field indicates whether each TCI codepoint has multiple TCI states or single TCI state. If Pᵢ field set to 1, it indicates that i^{th} TCI codepoint includes the DL TCI state and the UL TCI state. If Pᵢ field set to 0, it indicates that i^{th} TCI codepoint includes only the DL TCI state or the UL TCI state; (5) D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink; (6) TCI state ID: This field indicates the TCI state identified by TCI-StateId as specified in TS 38.331. If D/U is set to 1, 7-bits length TCI state ID i.e. TCI-StateId as specified in TS 38.331 is used. If D/U is set to 0, the most significant bit of TCI state ID is considered as the reserved bit and remainder 6 bits indicate the UL-TCIState-Id as specified in TS 38.331. The maximum number of activated TCI states is 16; (7) R: Reserved bit, set to 0.

The CellGroupConfig IE specified in the TS 38.331 is used to configure a master cell group (MCG) or secondary cell group (SCG). A cell group comprises of one MAC entity, a set of logical channels with associated RLC entities and of a primary cell (SpCell) and one or more secondary cells (SCells).

simultaneousTCI-UpdateList1, simultaneousTCI-UpdateList2 are list of serving cells which can be updated simultaneously for TCI relation with a MAC CE. The simultaneousTCI-UpdateList1 and simultaneousTCI-UpdateList2 shall not contain same serving cells. Network should not configure serving cells that are configured with a BWP with two different values for the coresetPoolIndex in these lists.

simultaneousU-TCI-UpdateList1, simultaneousU-TCI-UpdateList2, simultaneousU-TCI-UpdateList3, simultaneousU-TCI-UpdateList4 are list of serving cells for which the Unified TCI States Activation/Deactivation MAC CE applies simultaneously, as specified in [TS 38.321 v17.1.0 clause 6.1.3.47]. The different lists shall not contain same serving cells. Network only configures in these lists serving cells that are configured with unifiedtci-StateType.

When the bwp-id or cell for QCL-TypeA/D source RS in a QCL-Info of the TCI state configured with DLorJointTCIState is not configured, the UE assumes that QCL-TypeA/D source RS is configured in the CC/DL BWP where TCI state applies.

When tci-PresentInDCI is set as ‘enabled’ or tci-PresentDCI-1-2 is configured for the CORESET, the UE with activated DLorJointTCIState or UL-TCIState receives DCI format 1_1/1_2 providing indicated DLorJointTCIState or UL-TCIState for a CC or all CCs in the same CC list configured by simultaneousTCI-UpdateList1-r17, simultaneousTCI-UpdateList2-r17, simultaneousTCI-UpdateList3-r17, simultaneousTCI-UpdateList4-r17. The DCI format 1_1/1_2 can be with or without, if applicable, DL assignment. If the DCI format 1_1/1_2/ is without DL assignment, the UE can assume the following: (1) CS-RNTI is used to scramble the CRC for the DCI, (2) the values of the following DCI fields are set as follows: RV=all ‘1’s, MCS=all ‘1’s, NDI=0, and set to all ‘0’s for FDRA Type 0, or all ‘1’s for FDRA Type 1, or all ‘0’s for dynamicSwitch (same as in Table 10.2-4 of [6, TS 38.213]).

After a UE receives an initial higher layer configuration of more than one DLorJoint-TCIState and before application of an indicated TCI state from the configured TCI states: the UE assumes that DM-RS of PDSCH and DM-RS of PDCCH and the CSI-RS applying the indicated TCI state are quasi co-located with the SS/PBCH block the UE identified during the initial access procedure.

After a UE receives an initial higher layer configuration of more than one DLorJoint-TCIState or UL-TCIState and before application of an indicated TCI state from the configured TCI states: the UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during the initial access procedure.

After a UE receives a higher layer configuration of more than one DLorJoint-TCIState as part of a Reconfiguration with sync procedure as described in [12, TS 38.331] and before applying an indicated TCI state from the configured TCI states: the UE assumes that DM-RS of PDSCH and DM-RS of PDCCH, and the CSI-RS applying the indicated TCI state are quasi co-located with the SS/PBCH block or the CSI-RS resource the UE identified during the random access procedure initiated by the Reconfiguration with sync procedure as described in [12, TS 38.331].

After a UE receives a higher layer configuration of more than one DLorJoint-TCIState or UL-TCIState as part of a Reconfiguration with sync procedure as described in [12, TS 38.331] and before applying an indicated TCI state from the configured TCI states: the UE assumes that the UL TX spatial filter, if applicable, for dynamic-grant and configured-grant based PUSCH and

PUCCH, and for SRS applying the indicated TCI state, is the same as that for a PUSCH transmission scheduled by a RAR UL grant during random access procedure initiated by the Reconfiguration with sync procedure as described in [12, TS 38.331].

If a UE receives a higher layer configuration of a single DLorJoint-TCIState, that can be used as an indicated TCI state, the UE obtains the QCL assumptions from the configured TCI state for DM-RS of PDSCH and DM-RS of PDCCH, and the CSI-RS applying the indicated TCI state.

If a UE receives a higher layer configuration of a single DLorJoint-TCIState or UL-TCIState, that can be used as an indicated TCI state, the UE determines an UL TX spatial filter, if applicable, from the configured TCI state for dynamic-grant and configured-grant based PUSCH and PUCCH, and SRS applying the indicated TCI state.

When the UE would transmit the last symbol of a PUCCH with HARQ-ACK information corresponding to the DCI carrying the TCI State indication and without DL assignment, or corresponding to the PDSCH scheduling by the DCI carrying the TCI State indication, and if the indicated TCI State is different from the previously indicated one, the indicated DLorJointTCIState or UL-TCIstate should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

If a UE is configured with pdsch-TimeDomainAllocationListForMultiPDSCH-r17 in which one or more rows contain multiple SLIVs for PDSCH on a DL BWP of a serving cell, and the UE is receiving a DCI carrying the TCI-State indication and without DL assignment, the UE does not expect that the number of indicated SLIVs in the row of the pdsch-TimeDomainAllocationListForMultiPDSCH-r17 by the DCI is more than one.

If the UE is configured with NumberOfAdditionalPCI and with PDCCH-Config that contains two different values of coresetPoolIndex in ControlResourceSet, the UE receives an activation command for CORESET associated with each coresetPoolIndex, as described in clause 6.1.3.14 of [10, TS 38.321], used to map up to 8 TCI states to the codepoints of the DCI field ‘Transmission Configuration Indication’ in one CC/DL BWP. When a set of TCI state IDs are activated for a coresetPoolIndex, the activated TCI states corresponding to one coresetPoolIndex can be associated with one physical cell ID and activated TCI states corresponding to another coresetPoolIndex can be associated with another physical cell ID.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ} + \frac{{2}^{μ}}{{2}^{{μ}_{{K}_{m a c}}}} \cdot {k}_{m a c}$$

where m is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationFor [symbol] CL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling a PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationFor [symbol] CL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

When a UE is configured with both sfnSchemePdcch and sfnSchemePdsch scheduled by DCI format 1_0 or by DCI format 1_1/1_2, if the time offset between the reception of the DL DCI and the corresponding PDSCH of a serving cell is equal to or greater than a threshold timeDurationFor [symbol] CL if applicable: if the UE supports DCI scheduling without TCI field, the UE assumes that the TCI state(s) or the QCL assumption(s) for the PDSCH is identical to the TCI state(s) or QCL assumption(s) whichever is applied for the CORESET used for the reception of the DL DCI within the active BWP of the serving cell regardless of the number of active TCI states of the CORESET. If the UE does not support dynamic switching between SFN PDSCH and non-SFN PDSCH, the UE should be activated with the CORESET with two TCI states; else if the UE does not support DCI scheduling without TCI field, the UE shall expect TCI field present when scheduled by DCI format 1_1/1_2.

When a UE is configured with sfnSchemePdsch and sfnSchemePdcch is not configured, when scheduled by DCI format 1_1/1_2, if the time offset between the reception of the DL DCI and the corresponding PDSCH of a serving cell is equal to or greater than a threshold timeDurationFor [symbol] CL if applicable, the UE shall expect TCI field present.

For PDSCH scheduled by DCI format 1_0, 1_1, 1_2, when a UE is configured with sfnSchemePdcch set to ‘sfnSchemeA’ and sfnSchemePdsch is not configured, and there is no TCI codepoint with two TCI states in the activation command, and if the time offset between the reception of the DL DCI and the corresponding PDSCH is equal or larger than the threshold timeDurationFor [symbol] CL if applicable and the CORESET which schedules the PDSCH is indicated with two TCI states, the UE assumes that the TCI state or the QCL assumption for the PDSCH is identical to the first TCI state or QCL assumption which is applied for the CORESET used for the PDCCH transmission within the active BWP of the serving cell.

If a PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationFor [symbol] CL, where the threshold is based on reported UE capability [13, TS 38.306]. For a single slot PDSCH, the indicated TCI state(s) should be based on the activated TCI states in the slot with the scheduled PDSCH. For a multi-slot PDSCH or the UE is configured with higher layer parameter pdsch-TimeDomainAllocationListForMultiPDSCH-r17, the indicated TCI state(s) should be based on the activated TCI states in the first slot with the scheduled PDSCH(s), and UE shall expect the activated TCI states are the same across the slots with the scheduled PDSCH(s). When the UE is configured with CORESET associated with a search space set for cross-carrier scheduling and the UE is not configured with enableDefaultBeamForCCS, the UE expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and a corresponding PDSCH is larger than or equal to the threshold timeDurationFor [symbol] CL.

Independent of the configuration of tci-PresentInDCI and tci-PresentDCI-1-2 in RRC connected mode, if the offset between the reception of the DL DCI and the corresponding PDSCH is less than the threshold timeDurationFor [symbol] CL and at least one configured TCI state for the serving cell of scheduled PDSCH contains qcl-Type set to ‘typeD’, the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

Independent of the configuration of tci-PresentInDCI and tci-PresentDCI-1-2 in RRC connected mode, if the offset between the reception of the DL DCI and the corresponding PDSCH is less than the threshold timeDurationFor [symbol] CL and at least one configured TCI state for the serving cell of scheduled PDSCH contains qcl-Type set to ‘typeD’, If a UE is configured with enableDefaultTCI-StatePerCoresetPoolIndex and the UE is configured by higher layer parameter PDCCH-Config that contains two different values of coresetPoolIndex in different ControlResourceSets, the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same value of coresetPoolIndex, the UE is expected to prioritize the reception of PDCCH associated with that CORESET. This also applies to the intra-band CA case (when PDSCH and the CORESET are in different component carriers).

Independent of the configuration of tci-PresentInDCI and tci-PresentDCI-1-2 in RRC connected mode, if the offset between the reception of the DL DCI and the corresponding PDSCH is less than the threshold timeDurationFor [symbol] CL and at least one configured TCI state for the serving cell of scheduled PDSCH contains qcl-Type set to ‘typeD’, If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationFor [symbol] CL, the mapping of the TCI states to PDSCH transmission occasions is determined according to clause 5.1.2.1 in TS 38.214 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

Independent of the configuration of tci-PresentInDCI and tci-PresentDCI-1-2 in RRC connected mode, if the offset between the reception of the DL DCI and the corresponding PDSCH is less than the threshold timeDurationFor [symbol] CL and at least one configured TCI state for the serving cell of scheduled PDSCH contains qcl-Type set to ‘typeD’, if a UE is not configured with sfnSchemePdsch, and the UE is configured with sfnSchemePdcch set to ‘sfnSchemeA’ and there is no TCI codepoint with two TCI states in the activation command and the CORESET with the lowest ID in the latest slot is indicated with two TCI states, the UE may assume that the DM-RS ports of PDSCH of a serving cell are quasi co-located with the RS(s) with respect to the QCL parameter(s) associated with the first TCI state of two TCI states indicated for the CORESET.

Independent of the configuration of tci-PresentInDCI and tci-PresentDCI-1-2 in RRC connected mode, if the offset between the reception of the DL DCI and the corresponding PDSCH is less than the threshold timeDurationFor [symbol] CL and at least one configured TCI state for the serving cell of scheduled PDSCH contains qcl-Type set to ‘typeD’, in all cases above, if none of configured TCI states for the serving cell of scheduled PDSCH is configured with qcl-Type set to ‘typeD’, the UE shall obtain the other QCL assumptions from the indicated TCI state(s) for its scheduled PDSCH irrespective of the time offset between the reception of the DL DCI and the corresponding PDSCH.

If the PDCCH carrying the scheduling DCI is received on one component carrier, and a PDSCH scheduled by that DCI is on another component carrier: (1) the timeDurationFor [symbol] CL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationFor [symbol] CL, where d is defined in 5.2.1.5.1a-1 in TS 38.214, otherwise d is zero; or (2) when the UE is configured with enableDefaultBeamForCCS, if the offset between the reception of the DL DCI and the corresponding PDSCH is less than the threshold timeDurationFor [symbol] CL, or if the DL DCI does not have the TCI field present, the UE obtains its QCL assumption for the scheduled PDSCH from the activated TCI state with the lowest ID applicable to PDSCH in the active BWP of the scheduled cell.

A UE that has indicated a capability beamCorrespondenceWithoutUL-BeamSweeping set to ‘1’, as described in [18, TS 38.822], can determine a spatial domain filter to be used while performing the applicable channel access procedures described in [16, TS 37.213] to transmit a UL transmission on the channel as follows: (1) if UE is indicated with an SRI corresponding to the UL transmission, the UE may use a spatial domain filter that is same as the spatial domain transmission filter associated with the indicated SRI, or (2) if UE is configured with TCI-State configurations with DLorJointTCIState or UL-TCIState, the UE may use a spatial domain transmit filter that is same as the spatial domain receive filter the UE may use to receive the DL reference signal associated with the indicated TCI state.

When the PDCCH reception includes two PDCCH from two respective search space sets, as described in clause 10.1 of [6, TS 38.213], for the purpose of determining the time offset between the reception of the DL DCI and the corresponding PDSCH, the PDCCH candidate that ends later in time is used. When the PDCCH reception includes two PDCCH candidates from two respective search space sets, as described in clause 10.1 of [6, TS 38.213], for the configuration of tci-PresentInDCI or tci-PresentDCI-1-2, the UE expects the same configuration in the first and second CORESETs associated with the two PDCCH candidates; and if the PDSCH is scheduled by a DCI format not having the TCI field present and if the scheduling offset is equal to or larger than timeDurationFor [symbol] CL, if applicable, PDSCH QCL assumption is based on the CORESET with lower ID among the first and second CORESETs associated with the two PDCCH candidates.

For a periodic CSI-RS resource in an NZP-CSI-RS-ResourceSet configured with higher layer parameter trs-Info, the UE shall expect that a TCI-State indicates one of the following quasi co-location type(s): (1) ‘typeC’ with an SS/PBCH block and, when applicable, ‘typeD’ with the same SS/PBCH block, or (2) ‘typeC’ with an SS/PBCH block and, when applicable, ‘typeD’ with a CSI-RS resource in an NZP-CSI-RS-ResourceSet configured with higher layer parameter repetition.

For periodic/semi-persistent CSI-RS, the UE can assume that the indicated DLorJointTCIState is not applied.

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with an SS/PBCH block, (3) ‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or (4) ‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, (3) ‘typeC’ with an SS/PBCH block and, when applicable, ‘typeD’ with the same SS/PBCH block, the reference RS may additionally be an SS/PBCH block having a PCI different from the PCI of the serving cell. The UE can assume center frequency, SCS, SFN offset are the same for SS/PBCH block from the serving cell and SS/PBCH block having a PCI different from the serving cell.

For the DM-RS of PDCCH, the UE shall expect that a TCI-State or DLorJointTCIState except an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or (3) ‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

When a UE is configured with sfnSchemePdcch set to ‘sfnSchemeA’, and CORESET is activated with two TCI states, the UE shall assume that the DM-RS port(s) of the PDCCH in the CORESET is quasi co-located with the DL-RSs of the two TCI states. When a UE is configured with sfnSchemePdcch set to ‘sfnSchemeB’, and a CORESET is activated with two TCI states, the UE shall assume that the DM-RS port(s) of the PDCCH is quasi co-located with the DL-RSs of the two TCI states except for quasi co-location parameters {Doppler shift, Doppler spread} of the second indicated TCI state.

For the DM-RS of PDSCH, the UE shall expect that a TCI-State or DLorJointTCIState except an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or (3) ‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDCCH, the UE shall expect that an indicated DLorJointTCIState indicates one of the following quasi co-location type(s): (1) ‘typeA’ with a CSI-RS resource in a NZP-CSI-RS-ResourceSet configured with higher layer parameter trs-Info and, when applicable, ‘typeD’ with the same CSI-RS resource, or (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

For the DM-RS of PDSCH, the UE shall expect that an indicated DLorJointTCIState indicates one of the following quasi co-location type(s) if the UE is configured TCI-State(s) with tci-StateId_r17: (1) ‘typeA’ with a CSI-RS resource in a NZP-CSI-RS-ResourceSet configured with higher layer parameter trs-Info and, when applicable, ‘typeD’ with the same CSI-RS resource, or (2) ‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition.

When a UE is configured with sfnSchemePdsch set to ‘sfnSchemeA’, and the UE is indicated with two TCI states in a codepoint of the DCI field ‘Transmission Configuration Indication’ in a DCI scheduling a PDSCH, the UE shall assume that the DM-RS port(s) of the PDSCH is quasi co-located with the DL-RSs of the two TCI states. When a UE is configured with sfnSchemePdsch set to ‘sfnSchemeB’, and the UE is indicated with two TCI states in a codepoint of the DCI field ‘Transmission Configuration Indication’ in a DCI scheduling a PDSCH, the UE shall assume that the DM-RS port(s) of the PDSCH is quasi co-located with the DL-RSs of the two TCI states except for quasi co-location parameters {Doppler shift, Doppler spread} of the second indicated TCI state.

Throughout the present disclosure, the joint (e.g., provided by DLorJoint-TCIState), separate DL (e.g., provided by DLorJoint-TCIState) and/or separate UL (e.g., provided by UL-TCIState) TCI states described/discussed herein could also be referred to as unified TCI states, common TCI states, main TCI states and etc.

A UE can be provided, for each BWP of a serving cell, a set q̅₀ of periodic CSI-RS resource configuration indexes by failureDetectionResourcesToAddModList and a set q̅₁ of periodic CSI-RS resource configuration indexes and/or SS/PBCH block indexes by candidateBeamRSList or candidateBeamRSListExt or candidateBeamRSSCellList for radio link quality measurements on the BWP of the serving cell. In the present disclosure, in a single-TRP system or for single-TRP operation, a BFD RS (beam) set could correspond to the set q̅₀ described herein, and a NBI RS (beam) set could correspond to the set q̅₁ described herein.

Instead of the sets q̅₀ and q̅₁, for each BWP of a serving cell, the UE can be provided respective two sets q̅_{0,0} and q̅_{0,1} of periodic CSI-RS resource configuration indexes that can be activated by a MAC CE [11 TS 38.321] and corresponding two sets q̅_{1,0} and q̅_{1,1} of periodic CSI-RS resource configuration indexes and/or SS/PBCH block indexes by candidateBeamRSList1 and candidateBeamRSList2, respectively, for radio link quality measurements on the BWP of the serving cell. The set q̅_{0,0} is associated with the set q̅_{1,0} and the set q̅_{0,1} is associated with the set q̅_{1,1}. In the present disclosure, in a multi-TRP system or for multi-TRP operation, the UE can be provided a BFD RS (beam) set p, where p∈{1, 2, . . . , N} and N denotes the total number of BFD RS (beam) sets configured/provided to the UE. For this case, the first BFD RS set or BFD RS set 1 (e.g., p=1) could correspond to the set q̅_{0,0} described herein, and the second BFD RS set or BFD RS set 2 (e.g., p=2) could correspond to the set q̅_{0,1} described herein. In addition, the UE can be provided a NBI RS (beam) set p′, where p′∈{1, 2, . . . , M} and M denotes the total number of NBI RS (beam) sets configured/provided to the UE. For this case, the first NBI RS set or NBI RS set 1 (e.g., p′=1) could correspond to the set q̅_{1,0} described herein, and the second NBI RS set or NBI RS set 2 (e.g., p′=2) could correspond to the set q̅_{1,1} described herein.

If the UE is not provided q̅₀ by failureDetectionResourcesToAddModList for a BWP of the serving cell, the UE determines the set q̅₀ to include periodic CSI-RS resource configuration indexes with same values as the RS indexes in the RS sets indicated by TCI-State for respective CORESETs that the UE uses for monitoring PDCCH. If the UE is not provided q̅_{0,0} or q̅_{0,1} for a BWP of the serving cell, the UE determines the set q̅_{0,0} or q̅_{0,1} to include periodic CSI-RS resource configuration indexes with same values as the RS indexes in the RS sets indicated by TCI-State for first and second CORESETs that the UE uses for monitoring PDCCH, where the UE is provided two coresetPoolIndex values 0 and 1 for the first and second CORESETs, or is not provided coresetPoolIndex value for the first CORESETs and is provided coresetPoolIndex value of 1 for the second CORESETs, respectively. If there are two RS indexes in a TCI state, the set q̅₀ or q̅_{0,0}, or q̅_{0,1} includes RS indexes configured with qcl-Type set to ‘typeD’ for the corresponding TCI states. In the present disclosure, in a single-TRP system or for single-TRP operation, a BFD RS (beam) set could correspond to the set q̅₀ described herein, and a NBI RS (beam) set could correspond to the set q̅₁ described herein. In the present disclosure, in a multi-TRP system or for multi-TRP operation, the UE can be provided a BFD RS (beam) set p, where p∈{1, 2, . . . , N} and N denotes the total number of BFD RS (beam) sets configured/provided to the UE. For this case, the first BFD RS set or BFD RS set 1 (e.g., p=1) could correspond to the set q̅_{0,0} described herein, and the second BFD RS set or BFD RS set 2 (e.g., p=2) could correspond to the set q̅_{0,1} described herein. In addition, the UE can be provided a NBI RS (beam) set p′, where p′∈{1, 2, . . . , M} and M denotes the total number of NBI RS (beam) sets configured/provided to the UE. For this case, the first NBI RS set or NBI RS set 1 (e.g., p′=1) could correspond to the set q̅_{1,0} described herein, and the second NBI RS set or NBI RS set 2 (e.g., p′=2) could correspond to the set q̅_{1,1} described herein.

If a CORESET that the UE uses for monitoring PDCCH includes two TCI states and the UE is provided sfnSchemePdcch set to ‘sfnSchemeA’ or ‘sfnSchemeB’, the set q̅₀ includes RS indexes in the RS sets associated with the two TCI states. The UE expects the set q̅₀ to include up to two RS indexes. If the UE is provided q̅_{0,0} or q̅_{0,1}, the UE expects the set q̅_{0,0} or the set q̅_{0,1} to include up to a number of N_{BFD} RS indexes indicated by capabilityparametername. If the UE is not provided q̅_{0,0} or q̅_{0,1}, and if a number of active TCI states for PDCCH receptions in the first or second CORESETs is larger than N_{BFD}, the UE determines the set q̅_{0,0} or q̅_{0,1} to include periodic CSI-RS resource configuration indexes with same values as the RS indexes in the RS sets associated with the active TCI states for PDCCH receptions in the first or second CORESETs corresponding to search space sets according to an ascending order for monitoring periodicity. If more than one first or second CORESETs correspond to search space sets with same monitoring periodicity, the UE determines the order of the first or second CORESETs according to a descending order of a CORESET index.

If a UE is not provided coresetPoolIndex or is provided coresetPoolIndex with a value of 0 for first CORESETs on an active DL BWP of a serving cell, and/or the UE is provided coresetPoolIndex with a value of 1 for second CORESETs on the active DL BWP of the serving cells, and/or the UE is provided SSB-MTCAdditionalPCI, SS/PBCH block indexes associated with a physical cell identity other than the one provided by physCellId in ServingCellConfigCommon can be provided in either q̅_{1,0} or q̅_{1,1} set and the corresponding q̅_{0,0} or q̅_{0,1} set is associated with the physical cell identity.

The UE expects single port RS in the set q̅₀, or q̅_{0,0}, or q̅_{0,1}. The UE expects single-port or two-port CSI-RS with frequency density equal to 1 or 3 REs per RB in the set q̅₁, or q̅_{1,0}, or q̅_{1,1}. The thresholds Q_{out,LR} and Q_{in,LR} correspond to the default value of rlmInSyncOutOfSyncThreshold, as described in [10, TS 38.133] for Qₒᵤₜ, and to the value provided by rsrp-ThresholdSSB or rsrp-ThresholdBFR, respectively.

The physical layer in the UE assesses the radio link quality according to the set q̅₀, q̅_{0,0}, or q̅_{0,1}, of resource configurations against the threshold Q_{out,LR}. For the set q̅₀, the UE assesses the radio link quality only according to SS/PBCH blocks on the PCell or the PSCell or periodic CSI-RS resource configurations that are quasi co-located, as described in [6, TS 38.214], with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

In non-DRX mode operation, the physical layer in the UE provides an indication to higher layers when the radio link quality for all corresponding resource configurations in the set q̅₀, or in the set q̅_{0,0} or q̅_{0,1} that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀, q̅_{0,0}, or q̅_{0,1} that the UE uses to assess the radio link quality and 2 msec. In DRX mode operation, the physical layer provides an indication to higher layers when the radio link quality is worse than the threshold Q_{out,LR} with a periodicity determined as described in [10, TS 38.133].

For the PCell or the PSCell, upon request from higher layers, the UE provides to higher layers the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold.

For the SCell, upon request from higher layers, the UE indicates to higher layers whether there is at least one periodic CSI-RS configuration index or SS/PBCH block index from the set q̅₁, or q̅_{1,0}, or q̅_{1,1} with corresponding L1-RSRP measurements that is larger than or equal to the Q_{in,LR} threshold, and provides the periodic CSI-RS configuration indexes and/or SS/PBCH block indexes from the set q̅₁, or q̅_{1,0}, or q̅_{1,1} and the corresponding L1-RSRP measurements that are larger than or equal to the Q_{in,LR} threshold, if any.

For the PCell or the PSCell, a UE can be provided a CORESET through a link to a search space set provided by recoverySearchSpaceId, as described in clause 10.1, for monitoring PDCCH in the CORESET. If the UE is provided recoverySearchSpaceId, the UE does not expect to be provided another search space set for monitoring PDCCH in the CORESET associated with the search space set provided by recoverySearchSpaceId.

For the PCell or the PSCell, the UE can be provided, by PRACH-ResourceDedicatedBFR, a configuration for PRACH transmission as described in clause 8.1. For PRACH transmission in slot n and according to antenna port quasi co-location parameters associated with periodic CSI-RS resource configuration or with SS/PBCH block associated with index q_{new} provided by higher layers [11, TS 38.321], the UE monitors PDCCH in a search space set provided by recoverySearchSpaceId for detection of a DCI format with CRC scrambled by C-RNTI or MCS-C-RNTI starting from slot n+4+2^{μ}·k_{mac}, where μ is the SCS configuration for the PRACH transmission and k_{mac} is a number of slots provided by K-Mac [12, TS 38.331] or k_{mac}=0 if K-Mac is not provided, within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

In the present disclosure, various BFD RS configuration methods for both single-TRP (sTRP) and multi-TRP (mTRP) systems are considered. Specifically, a TRP can represent a collection of measurement antenna ports, measurement RS resources and/or control resource sets (CORESETs). For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and (5) a plurality of CORESETs associated with a TRP-specific index/indicator/identity.

Furthermore, different TRPs in a multi-TRP system could broadcast/be associated with different physical cell identities (PCIs) and one or more TRPs in the system could broadcast/be associated with different PCIs from that of serving cell/TRP.

Under the Rel. 15/16 TCI framework, the UE may expect to receive from the network a MAC CE to indicate the one or more TCI states—from a higher layer RRC configured pool of TCI states—for the one or more PDCCHs. Under the unified TCI framework, the UE may expect to receive from the network a MAC CE, or a DCI, or both MAC CE and DCI to indicate the one or more TCI states—from a higher layer RRC configured pool of TCI states—for the one or more PDCCHs. Furthermore, as mentioned herein, an indicated TCI state could be: (1) a DL TCI state and/or its corresponding/associated TCI state ID for both PDCCH and PDSCH, (2) an UL TCI state and/or its corresponding/associated TCI state ID for both PUCCH and PUSCH, (3) a joint DL and UL TCI state and/or its corresponding/associated TCI state ID for all DL and UL channels such as PDCCH, PDSCH, PUCCH and PUSCH, and (4) a separate DL TCI state for PDCCH and PDSCH and a separate UL TCI state for PUCCH and PUSCH and/or their corresponding/associated TCI state ID(s).

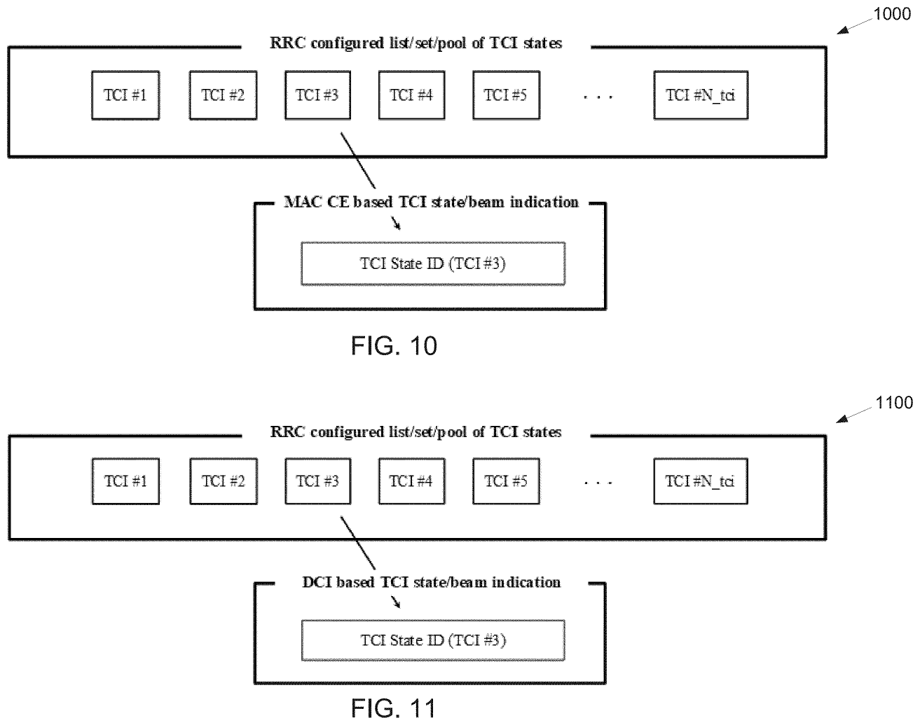

FIG. 10 illustrates an example of MAC CE based TCI state/beam activation/indication for the single-TRP operation 1000 according to embodiments of the present disclosure. An embodiment of the MAC CE based TCI state/beam activation/indication for the single-TRP operation 1000 shown in FIG. 10 is for illustration only.

In FIG. 10, an example of MAC CE based TCI state/beam indication is presented. As illustrated in FIG. 10, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE commands to indicate one or more beam(s) (i.e., the TCI state(s)) for the transmission/reception of the PDCCH(s), PDSCH(s), PUCCH(s), or PUSCH(s).

The MAC CE for a common TCI state/beam indication could include at least a TCI state ID. As discussed herein, the TCI state corresponding to the TCI state ID could be at least one of: (1) a DL TCI state; (2) an UL TCI state; (3) a joint DL and UL TCI state; or (4) separate DL TCI state and UL TCI state.

FIG. 11 illustrates an example of DCI based TCI state/beam indication for the single-TRP operation 1100 according to embodiments of the present disclosure. An embodiment of the DCI based TCI state/beam indication for the single-TRP operation 1100 shown in FIG. 11 is for illustration only.

In FIG. 11, an example of DCI based common TCI state/beam indication is presented. As illustrated in FIG. 11, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more DCIs to indicate one or more beam(s) (i.e., the TCI state(s)) for the transmission/reception of the PDCCH(s), PDSCH(s), PUSCH(s), or PUCCH(s).

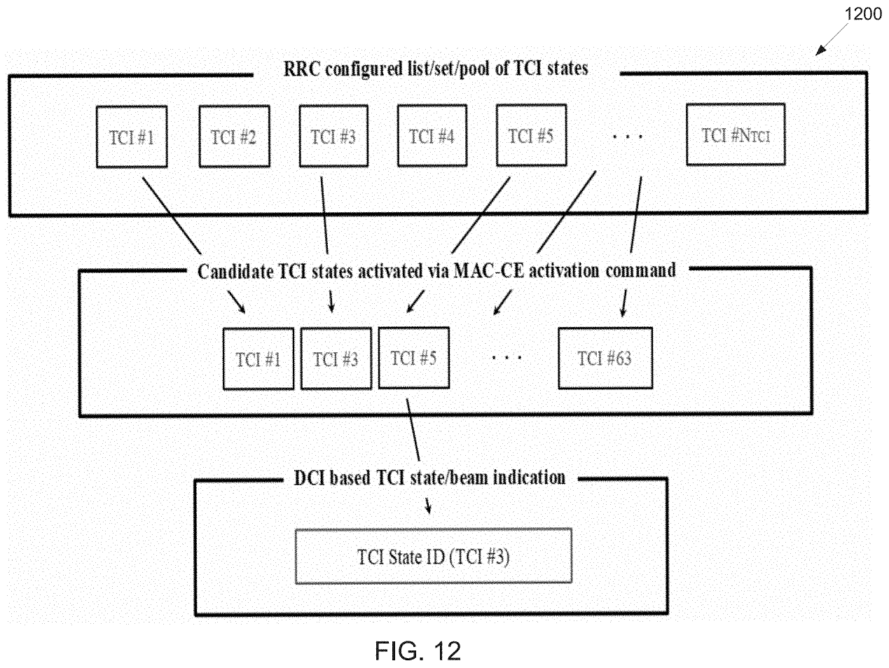

FIG. 12 illustrates an example of DCI based TCI state/beam indication with MAC CE activated TCI states for the single-TRP operation 1200 according to embodiments of the present disclosure. An embodiment of the DCI based TCI state/beam indication with MAC CE activated TCI states for the multi-TRP operation 1200 shown in FIG. 12 is for illustration only.

In FIG. 12, an example of DCI based common TCI state/beam indication (with MAC CE activated TCI states) is presented. As illustrated in FIG. 12, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE activation commands activating one or more TCI states from the higher layer configured list/pool of TCI states, e.g., up to eight TCI states could be activated by a MAC CE activation command. The UE could receive from the network one or more DCIs for beam indication to indicate one or more beam(s) (i.e., the TCI state(s)) from the MAC CE activated TCI state(s)/beam(s) for the transmission/reception of the PDCCH(s), PDSCH(s), PUCCH(s), or PUSCH(s).

As mentioned herein, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; or (3) yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for beam indication could be at least one of: (1) a DL TCI state; (2) an UL TCI state; (3) a joint DL and UL TCI state; or (4) separate DL TCI state and UL TCI state.

As mentioned herein, the UE could implicitly determine/configure the BFD RS(s), which could correspond to 1-port CSI-RS resource configuration index(es) or SSB index(es) indicated/configured as the QCL-typeD source RS(s) in one or more active TCI states indicated for receiving DL channels/signals such as PDCCH, PDSCH and CSI-RS and/or transmitting UL channels/signals such as PUCCH, PUSCH and SRS. Various means of implicitly configuring the BFD RS under the unified TCI framework are presented as follows.

In one example, the UE could implicitly determine/configure a BFD RS, which could correspond to a 1-port CSI-RS resource configuration index or SSB index indicated/configured as the QCL source RS in a common DL TCI state for both PDCCH and PDSCH receptions under the Rel. 17 TCI framework, in a BFD RS set q0. The UE could be indicated by the network the common DL TCI state for both PDCCH and PDSCH receptions via the MAC CE based or DCI based (with or without MAC CE activation) common beam indication strategy discussed herein—for DCI based beam indication, the TCI state(s) could be indicated by one or more TCI codepoints in one or more TCI fields in the beam indication DCI (format 1_1 or 1_2 with or without DL assignment).

In another example, the UE could implicitly determine/configure a BFD RS, which could correspond to a 1-port CSI-RS resource configuration index or SSB index indicated/configured as the QCL source RS in a common joint DL and UL TCI state for all DL and UL channels such as PDCCH, PDSCH, PUCCH and PUSCH under the Rel. 17 TCI framework, in a BFD RS set q0. The UE could be indicated by the network the common joint DL and UL TCI state for all DL and UL channels via the MAC CE based or DCI based (with or without MAC CE activation) common beam indication strategy discussed herein.

That is, the UE could implicitly determine/configure one or more BFD RSs in the set q0 as periodic CSI-RS resource configuration indexes or SSB indexes with the same values as RS indexes in the RS sets indicated by the common/unified joint/DL TCI state (e.g., a joint TCI state provided by DLorJointTCIState or a separate DL TCI state provided by DLorJointTCIState). The UE could be indicated by the network the common/unified joint/DL TCI state for both PDCCH and PDSCH receptions via the MAC CE based or DCI based (with or without MAC CE activation) common beam indication strategy discussed herein—for DCI based beam indication, the common/unified joint/DL TCI state(s) could be indicated by one or more TCI codepoints in one or more TCI fields in the beam indication DCI (format 1_1 or 1_2 with or without DL assignment).

In yet another example, the UE could be indicated by the network a separate DL TCI state for PDCCH and PDCCH and a separate UL TCI state for PUCCH and PUSCH via the MAC CE based or DCI based (with or without MAC CE activation) common beam indication strategy discussed herein. The UE could implicitly determine/configure a BFD RS, which could correspond to a 1-port CSI-RS resource configuration index or SSB index indicated/configured as the QCL source RS in a separate DL TCI state for PDCCH and PDSCH receptions indicated via the common beam indication under the unified TCI framework, in a BFD RS set q0. Optionally,

In one example, the UE could implicitly determine/configure a BFD RS, which could correspond to a 1-port CSI-RS resource configuration index or SSB index indicated/configured as the QCL source RS in the separate UL TCI state for PUCCH and PUSCH transmissions indicated via the common beam indication under the unified TCI framework, in a BFD RS set q0.

In another example, the UE is not expected to determine/configure a BFD RS corresponding to a 1-port CSI-RS resource configuration index or SSB index indicated/configured as the QCL source RS in the separate UL TCI state for PUCCH and PUSCH indicated via the common beam indication under the unified TCI framework.

The UE could be indicated/configured by the network, e.g., via higher layer RRC signaling and/or MAC CE command and/or dynamic DCI based L1 signaling, to follow the examples discussed herein.

In yet another example, the UE could be indicated by the network a common UL TCI state for both PUCCH and PUSCH via the MAC CE based or DCI based (with or without MAC CE activation) common beam indication strategy discussed herein.

In one example, the UE could implicitly determine/configure a BFD RS, which could correspond to a 1-port CSI-RS resource configuration index or SSB index indicated/configured as the QCL source RS in the common UL TCI state for PUCCH and PUSCH transmissions under the unified TCI framework, in a BFD RS set q0.

In another example, the UE is not expected to determine/configure a BFD RS corresponding to a 1-port CSI-RS resource configuration index or SSB index indicated/configured as the QCL source RS in the common UL TCI state for PUCCH and PUSCH under the unified TCI framework.

The UE could be indicated/configured by the network, e.g., via higher layer RRC signaling and/or MAC CE command and/or dynamic DCI based L1 signaling, to follow the examples described/specified herein.

That is, the UE could implicitly determine/configure one or more BFD RSs in the set q0 as periodic CSI-RS resource configuration indexes or SSB indexes with the same values as RS indexes in the RS sets indicated by the common/unified joint/DL/UL TCI state (e.g., a joint TCI state provided by DLorJointTCIState, a separate DL TCI state provided by DLorJointTCIState or a separate UL TCI state provided by UL-TCIState). Optionally, the UE may not determine periodic CSI-RS resource configuration indexes or SSB indexes that have the same values as RS indexes in the RS sets indicated by a separate UL TCI state provided by UL-TCIState as BFD RS(s) in the set q0. For DCI based beam indication, the common/unified joint/DL/UL TCI state(s) could be indicated by one or more TCI codepoints in one or more TCI fields in the beam indication DCI (format 1_1 or 1_2 with or without DL assignment).

The UE could be higher layer RRC configured by the network (e.g., provided by the higher layer parameter Beam-Failure-Detection-RS-ResourceConfig/failureDetectionResourcesToAddModList) a set of Ntot≥1 BFD RS resources (e.g., a set of periodic CSI-RS resource configuration indexes or SSB indexes provided by Beam-Failure-Detection-RS-ResourceConfig/failureDetectionResourcesToAddModList).

In one example, for a RRC configured set of BFD RS resources and one or more CORESETs that the UE is configured for monitoring PDCCH(s), the UE could only measure/monitor the BFD RS resource(s) in the RRC configured set of BFD RS resources that is the same as the QCL source RS(s) indicated in the TCI state(s) for the CORESET(s)/PDCCH(s). Under the unified TCI framework, the TCI state(s) for the CORESET(s)/PDCCH(s) could be indicated via the MAC CE based or DCI based (with or without MAC CE activation) common beam indication strategy discussed herein.

Furthermore, the indicated TCI state(s) for the CORESET(s)/PDCCH(s) could be: (1) a DL TCI state and/or its corresponding/associated TCI state ID for both PDCCH and PDSCH, (2) an UL TCI state and/or its corresponding/associated TCI state ID for both PUCCH and PUSCH, (3) a joint DL and UL TCI state and/or its corresponding/associated TCI state ID for all DL and UL channels such as PDCCH, PDSCH, PUCCH and PUSCH, and (4) a separate DL TCI state for PDCCH and PDSCH and a separate UL TCI state for PUCCH and PUSCH and/or their corresponding/associated TCI state ID(s).

That is, when/if the UE is provided by the network, e.g., via higher layer RRC signaling, the set q0 of BFD RSs (e.g., a set of periodic CSI-RS resource configuration indexes or SSB indexes provided by failureDetectionResourcesToAddModList), the UE could assess the radio link quality according to the set q0, of resource configurations, against the BFD threshold Qout. Specifically, as described herein, for the set q0, the UE could assess the radio link quality only according to SSB(s) or periodic CSI-RS resource configuration(s) indicated by one or more common/unified joint TCI states (provided by DLorJointTCIState), separate DL TCI states (provided by DLorJointTCIState) or separate UL TCI states (provided by UL-TCIState) that are quasi co-located with the DM-RS of PDCCH receptions. Or equivalently, the UE could assess the radio link quality of one or more of the BFD RSs or BFD RS resource configuration indexes in the set q0 that have the same values as the RS indexes in the RS sets indicated by one or more common/unified joint TCI states (provided by DLorJointTCIState), separate DL TCI states (provided by DLorJointTCIState) or separate UL TCI states (provided by UL-TCIState). For DCI based beam indication, the common/unified joint/DL/UL TCI state(s) could be indicated by one or more TCI codepoints in one or more TCI fields in the beam indication DCI (format 1_1 or 1_2 with or without DL assignment).

In another example, the UE could receive from the network a MAC CE command/bitmap, e.g., a BFD-RS indication MAC CE, to activate/update/indicate N_bfd≥1 (e.g., N_bfd=1 or N_bfd=2) BFD RSs or BFD RS resource configurations in the BFD RS set q0 from the higher layer RRC configured Ntot≥1 (e.g., Ntot=64) BFD RSs or BFD RS resource configurations; for this case, the UE could assess the radio link quality of the BFD RS set q0 according to one or more of the N_bfd BFD RSs in the set q0. For example, the MAC CE command/bitmap could contain/comprise/include/provide/configure/indicate Ntot entries/bit positions with each entry/bit position in the bitmap corresponding to an entry in the RRC configured set of Ntot candidate BFD RS resources. If an entry/bit position in the bitmap is enabled, e.g., set to ‘1’, the corresponding entry in the RRC configured set of Ntot candidate BFD RS resources is activated as a BFD RS resource in the set q0 for monitoring the link quality or detecting potential beam failure of the corresponding CORESET(s)/PDCCH(s).

For another example, the MAC CE command could include/contain/comprise/provide/configure/indicate at least N_bfd entries/fields with each entry/field indicating/providing a BFD RS or BFD RS resource configuration index/ID in the set q0; the indicated/provided BFD RS(s) or BFD RS resource configuration index(es)/ID(s)—by the MAC CE command—could be from the higher layer RRC configured set of Ntot BFD RSs or BFD RS resource configurations. One or more of the N_bfd entries/fields in the MAC CE command could be enabled/present or disabled/absent via a one-bit flag indicator/field. The UE could assess the radio link quality according to the set q0, of resource configurations, against the BFD threshold Qout.

Specifically, for the set q0, the UE could assess the radio link quality only according to SSB(s) or periodic CSI-RS resource configuration(s) indicated by one or more common/unified joint TCI states (provided by DLorJointTCIState), separate DL TCI states (provided by DLorJointTCIState) or separate UL TCI states (provided by UL-TCIState) that are quasi co-located with the DM-RS of PDCCH receptions. Or equivalently, the UE could assess the radio link quality of one or more of the BFD RSs or BFD RS resource configuration indexes in the set q0 that have the same values as the RS indexes in the RS sets indicated by one or more common/unified joint TCI states (provided by DLorJointTCIState), separate DL TCI states (provided by DLorJointTCIState) or separate UL TCI states (provided by UL-TCIState). For DCI based beam indication, the common/unified joint/DL/UL TCI state(s) could be indicated by one or more TCI codepoints in one or more TCI fields in the beam indication DCI (format 1_1 or 1_2 with or without DL assignment).

In yet another example, for the MAC CE based common beam indication strategy as illustrated in FIG. 10, one or more BFD RS resource indexes, e.g., in/from the higher layer RRC configured set of Ntot BFD RS resources, could be included/indicated/comprised in the MAC CE for common beam indication. In this case, the UE is expected to only measure one or more BFD RSs to monitor the link quality or detect potential beam failure for one or more CORESETs/PDCCHs if the one or more BFD RS resources and the TCI state(s) for the one or more CORESETs/PDCCHs are indicated in the same MAC CE for common beam indication.

As mentioned herein, the indicated TCI state(s) for the CORESET(s)/PDCCH(s) could be: (1) a DL TCI state and/or its corresponding/associated TCI state ID for both PDCCH and PDSCH, (2) an UL TCI state and/or its corresponding/associated TCI state ID for both PUCCH and PUSCH, (3) a joint DL and UL TCI state and/or its corresponding/associated TCI state ID for all DL and UL channels such as PDCCH, PDSCH, PUCCH and PUSCH, and (4) a separate DL TCI state for PDCCH and PDSCH and a separate UL TCI state for PUCCH and PUSCH and/or their corresponding/associated TCI state ID(s).

That is, the beam indication/activation MAC CE, e.g., unified TCI states activation/deactivation MAC CE, could indicate/provide/configure/contain/include/comprise one or more BFD RSs or BFD RS resource configuration indexes/IDs in the set q0, wherein each BFD RS resource configuration index could correspond a SSB index or a periodic CSI-RS resource configuration index, e.g., determined/selected from the higher layer RRC configured set of Ntot BFD RSs or BFD RS resource configuration indexes. Alternatively, the beam indication/activation MAC CE, e.g., unified TCI states activation/deactivation MAC CE, could indicate/provide/configure/contain/include/comprise a bitmap with each bit position in the bitmap corresponding/associated to a BFD RS resource configuration index in the set of Ntot BFD RS resource configuration indexes; for this case, when/if a bit position is set to ‘1’, the BFD RS resource configuration index in the set of Ntot BFD RS resource configuration indexes corresponding/associated to the bit position could be determined as a BFD RS/BFD RS resource configuration in the set q0.

The UE could assess the radio link quality according to the set q0, of resource configurations, against the BFD threshold Qout. Specifically, for the set q0, the UE could assess the radio link quality only according to SSB(s) or periodic CSI-RS resource configuration(s) indicated by one or more common/unified joint TCI states (provided by DLorJointTCIState), separate DL TCI states (provided by DLorJointTCIState) or separate UL TCI states (provided by UL-TCIState) that are quasi co-located with the DM-RS of PDCCH receptions, wherein the one or more joint/DL/UL unified TCI states could be indicated in the (same) beam indication/activation MAC CE as described/specified herein. Or equivalently, the UE could assess the radio link quality of one or more of the BFD RSs or BFD RS resource configuration indexes in the set q0 that have the same values as the RS indexes in the RS sets indicated by one or more common/unified joint TCI states (provided by DLorJointTCIState), separate DL TCI states (provided by DLorJointTCIState) or separate UL TCI states (provided by UL-TCIState), wherein the one or more joint/DL/UL unified TCI states could be indicated in the (same) beam indication/activation MAC CE as described/specified herein.

In yet another example, for the DCI based common beam indication strategy as illustrated in FIG. 11 (without MAC CE activation) and FIG. 12 (with MAC CE activation), one or more BFD RS indexes, e.g., in/from the higher layer RRC configured set of Ntot BFD RS resources, could be included/indicated/comprised in the DCI for common beam indication.

That is, the beam indication DCI, e.g., DCI format 1_1 or 1_2 with or without DL PDSCH assignment/scheduling, that indicates one or more joint/DL/UL TCI states via one or more TCI codepoints in one or more TCI fields, could indicate/provide/configure/contain/include/comprise one or more BFD RSs or BFD RS resource configuration indexes/IDs, wherein the one or more BFD RSs/BFD RS resource configuration indexes could be included in the set q0, and each BFD RS resource configuration index could correspond to a SSB index or a periodic CSI-RS resource configuration index, e.g., determined/selected from the higher layer RRC configured set of Ntot BFD RSs or BFD RS resource configuration indexes.

For example, one or more new/dedicated DCI fields could be introduced in a DCI format, e.g., the beam indication DCI 1_1/1_2 with or without DL assignment or DCI format 0_1/0_2, to indicate/provide the one or more BFD RS resource configuration indexes, wherein the one or more BFD RSs/BFD RS resource configuration indexes could be included in the set q0, and the one or more BFD RS resource configuration indexes could correspond to SSB index(es) or periodic CSI-RS resource configuration index(es), e.g., determined/selected from the higher layer RRC configured set of Ntot BFD RSs or BFD RS resource configuration indexes.

For another example, one or more field bits/codepoints of one or more reserved/existing DCI fields in a DCI format, e.g., the beam indication DCI 1_1/1_2 with or without DL assignment or DCI format 0_1/0_2, could be used/repurposed to indicate/provide the one or more BFD RS resource configuration indexes, wherein the one or more BFD RSs/BFD RS resource configuration indexes could be included in the set q0, and the one or more BFD RS resource configuration indexes could correspond to SSB index(es) or periodic CSI-RS resource configuration index(es), e.g., determined/selected from the higher layer RRC configured set of Ntot BFD RSs or BFD RS resource configuration indexes. In this case, the UE is expected to only measure one or more BFD RSs to monitor the link quality or detect potential beam failure for one or more CORESETs/PDCCHs if the one or more BFD RS resources and the TCI state(s) for the one or more CORESETs/PDCCHs are indicated in the same DCI for common beam indication (with or without MAC CE activation).

Yet for another example, one or more BFD RS resource indexes, e.g., in/from the higher layer RRC configured set of Ntot BFD RS resources, could be indicated/included/comprised in the common TCI state, e.g., in the higher layer parameter TCI-State, DLorJointTCIState, ULTCI-State or QCL-Info. That is, the higher layer parameter TCI-State, DLorJointTCIState, ULTCI-State or QCL-Info could indicate/provide the one or more BFD RS resource configuration indexes, wherein the one or more BFD RSs/BFD RS resource configuration indexes could be included in the set q0, and the one or more BFD RS resource configuration indexes could correspond to SSB index(es) or periodic CSI-RS resource configuration index(es), e.g., determined/selected from the higher layer RRC configured set of Ntot BFD RSs or BFD RS resource configuration indexes.

In TABLE 1, an illustrative example of indicating the BFD RS resource configuration index(es) in the higher layer parameter TCI-State is presented. In TABLE 2, an illustrative example of indicating the BFD RS resource configuration index(es) in the higher layer parameter QCL-Info is presented. Note that indicating/providing the BFD RS resource configuration index(es) in DLorJointTCIState or ULTCI-State could have the same/similar signaling structure(s) as those specified in TABLE 1 or TABLE 2.

TABLE 1
BFD RS resource index(es)

| | |
|---|---|
| TCI-State ::= | SEQUENCE { |
| tci-StateId | TCI-StateId, |

radioLinkMonitoringRS-Id RadioLinkMonitoringRS-Id OPTIONAL, -- Need R

| qcl-Type1 | QCL-Info, | |
|---|---|---|
| qcl-Type2 | QCL-Info | OPTIONAL, -- Need R |
| ... | | |

}

TABLE 2
BFD RS resource index(es)

```
QCL-Info ::= SEQUENCE {
  cell ServCellIndex OPTIONAL, -- Need R
  radioLinkMonitoringRS-Id RadioLinkMonitoringRS-Id OPTIONAL, -- Need R
  bwp-Id BWP-Id OPTIONAL, -- Cond CSI-RS-Indicated
  referenceSignal CHOICE {
    csi-rs NZP-CSI-RS-ResourceId,
    ssb SSB-Index
  },
  qcl-Type ENUMERATED {typeA, typeB, typeC, typeD},
  ...
}
```

In this case, the UE is expected to only measure one or more BFD RSs to monitor the link quality or detect potential beam failure for one or more CORESETs/PDCCHs if the one or more BFD RS resources are indicated in the unified TCI state(s) for the one or more CORESETs/PDCCHs. As mentioned herein, the indicated TCI state(s) for the CORESET(s)/PDCCH(s) could be: (1) a DL TCI state and/or its corresponding/associated TCI state ID for both PDCCH and PDSCH, (2) an UL TCI state and/or its corresponding/associated TCI state ID for both PUCCH and PUSCH, (3) a joint DL and UL TCI state and/or its corresponding/associated TCI state ID for all DL and UL channels such as PDCCH, PDSCH, PUCCH and PUSCH, and (4) a separate DL TCI state for PDCCH and PDSCH and a separate UL TCI state for PUCCH and PUSCH and/or their corresponding/associated TCI state ID(s).

For one or more of the design examples described/specified herein, the UE could assess the radio link quality according to the set q0, of resource configurations, against the BFD threshold Qout. Specifically, for the set q0, the UE could assess the radio link quality only according to SSB(s) or periodic CSI-RS resource configuration(s) indicated by one or more common/unified joint TCI states (provided by DLorJointTCIState), separate DL TCI states (provided by DLorJointTCIState) or separate UL TCI states (provided by UL-TCIState) that are quasi co-located with the DM-RS of PDCCH receptions, wherein the one or more joint/DL/UL unified TCI states could be indicated in the (same) beam indication DCI (e.g., DCI format 1_1 or 1_2 with or without DL assignment as described/specified herein). Or equivalently, the UE could assess the radio link quality of one or more of the BFD RSs or BFD RS resource configuration indexes in the set q0 that have the same values as the RS indexes in the RS sets indicated by one or more common/unified joint TCI states (provided by DLorJointTCIState), separate DL TCI states (provided by DLorJointTCIState) or separate UL TCI states (provided by UL-TCIState), wherein the one or more joint/DL/UL unified TCI states could be indicated in the (same) beam indication DCI (e.g., DCI format 1_1 or 1_2 with or without DL assignment as described/specified herein).

In yet another example, the beam indication DCI, e.g., DCI format 1_1 or 1_2 with or without DL PDSCH assignment/scheduling, that indicates one or more joint/DL/UL TCI states via one or more TCI codepoints in one or more TCI fields, could indicate/provide/configure/contain/include/comprise a bitmap with each bit position in the bitmap corresponding/associated to a BFD RS resource configuration index in the set of Ntot BFD RS resource configuration indexes; for this case, when/if a bit position is set to ‘1’, the BFD RS resource configuration index in the set of Ntot BFD RS resource configuration indexes corresponding/associated to the bit position could be determined as a BFD RS/BFD RS resource configuration in the set q0.

For example, one or more new/dedicated DCI fields could be introduced in a DCI format, e.g., the beam indication DCI 1_1/1_2 with or without DL assignment or DCI format 0_1/0_2, to indicate/provide the bitmap.

For another example, one or more field bits/codepoints of one or more reserved/existing DCI fields in a DCI format, e.g., the beam indication DCI 1_1/1_2 with or without DL assignment or DCI format 0_1/0_2, could be used/repurposed to indicate/provide the bitmap.

Yet for another example, the higher layer parameter TCI-State, DLorJointTCIState, ULTCI-State or QCL-Info could indicate/provide the bitmap. Indicating/providing the bitmap in TCI-State, DLorJointTCIState, ULTCI-State or QCL-Info could have the same/similar signaling structure(s) as those specified in TABLE 1 or TABLE 2.

For one or more of the design examples described/specified herein, the UE could assess the radio link quality according to the set q0, of resource configurations, against the BFD threshold Qout. Specifically, for the set q0, the UE could assess the radio link quality only according to SSB(s) or periodic CSI-RS resource configuration(s) indicated by one or more common/unified joint TCI states (provided by DLorJointTCIState), separate DL TCI states (provided by DLorJointTCIState) or separate UL TCI states (provided by UL-TCIState) that are quasi co-located with the DM-RS of PDCCH receptions, wherein the one or more joint/DL/UL unified TCI states could be indicated in the (same) beam indication DCI (e.g., DCI format 1_1 or 1_2 with or without DL assignment as described/specified herein). Or equivalently, the UE could assess the radio link quality of one or more of the BFD RSs or BFD RS resource configuration indexes in the set q0 that have the same values as the RS indexes in the RS sets indicated by one or more common/unified joint TCI states (provided by DLorJointTCIState), separate DL TCI states (provided by DLorJointTCIState) or separate UL TCI states (provided by UL-TCIState), wherein the one or more joint/DL/UL unified TCI states could be indicated in the (same) beam indication DCI (e.g., DCI format 1_1 or 1_2 with or without DL assignment as described/specified herein).

In yet another example, a UE could be indicated/provided/configured by the network, e.g., in beam indication/activation MAC CE or beam indication DCI (e.g., DCI format 1_1/1_2 with or without DL assignment) as described/specified herein, one or more common/unified joint/DL/UL TCI states/beams for UE-dedicated PDCCH/PDSCH, dynamic-grant/configured-grant based PUSCH and all of dedicated PUCCH resources, one or more SRSs, or one or more CSI-RSs—corresponding to periodic/semi-persistent/aperiodic CSI-RS(s) in a resource set. Or equivalently, the reception(s) of one or more CSI-RSs such as periodic/semi-persistent/aperiodic CSI-RS(s) in a resource set could follow (or could be higher layer configured by the network to follow) the QCL assumption(s)/parameter(s) indicated/provided in a common/unified joint/DL/UL TCI state/beam indicated for UE-dedicated PDCCH/PDSCH or dynamic-grant/configured-grant based PUSCH and all of dedicated PUCCH resources.

The UE could use/configure/determine the one or more CSI-RSs or CSI-RS resource configuration indexes as the BFD RS(s)/BFD RS resource configuration index(es) in the BFD RS set q0 for potential beam failure detection. In this case, a BFD RS or BFD RS resource configuration in the set q0 could share the same common/unified TCI state/beam indicated for UE-dedicated PDCCH/PDSCH or dynamic-grant/configured-grant based PUSCH and all of dedicated PUCCH resources.

In one example, if the UE is not provided/indicated/configured by the network any BFD RS resource(s) or BFD RS resource configuration index(es) in the set q0 following the design examples herein, the UE could implicitly determine/configure the BFD RS resource(s) or BFD RS resource configuration index(es) in the set q0 following the design examples herein under the unified TCI framework. Alternatively, the UE could be indicated by the network to implicitly determine/configure the BFD RS resource(s) or BFD RS resource configuration index(es) in the set q0 following the design examples described/specified in the present disclosure regardless whether the UE is configured/indicated/provided by the network BFD RS resource(s)/BFD RS resource configuration index(es) in the set q0 or not; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. Optionally, when/if the QCL source RS(s) or RS resource configuration(s) indicated in the common/unified joint/DL/UL TCI state is aperiodic CSI-RS(s) or aperiodic CSI-RS resource configuration(s), the UE could implicitly determine/configure the BFD RS resource(s) or BFD RS resource configuration index(es) in the set q0 following the design examples herein under the unified TCI framework.

In another example, the UE is configured by the network (e.g., via the higher layer parameter Beam-Failure-Detection-RS-ResourceConfig) one or more BFD RS resources to monitor the link quality or detect potential beam failure for one or more CORESETs/PDCCHs.

The UE could follow the design examples herein if at least one of the following is met/achieved/satisfied: (1) the UE could be indicated by the network to determine/configure the BFD RS resource(s) following the design examples herein; this indication could be via higher layer (RRC) or/and MAC CE or/and DCI based signaling or/and any combination of at least two of RRC, MAC CE and DCI based signaling; this indication could be via a separate (dedicated) parameter or joint with another parameter; or (2) the QCL source RS(s) indicated in the common/unified TCI state (for at least PDCCH) is aperiodic CSI-RS.

In yet another example, the UE could first use the higher layer RRC configured (e.g., via the higher layer parameter Beam-Failure-Detection-RS-ResourceConfig) one or more BFD RSs to monitor the link quality or detect potential beam failure for one or more CORESETs/PDCCHs.

If the UE receives from the network a DCI for common beam indication (with or without MAC CE activation as illustrated in FIG. 11 or FIG. 12) to indicate the TCI state/beam update for the CORESET(s)/PDCCH(s), the UE could follow at least one of the following to determine/configure the BFD RS resource(s): (1) the UE could follow the design examples herein to implicitly determine/configure the BFD RS(s) as the QCL source RS(s) indicated in the common/unified TCI state (for at least PDCCH); here, the common/unified TCI state is indicated via the DCI for common beam indication; (2) the UE could follow the design examples discussed herein to determine/configure the BFD RS(s) for the corresponding CORESET(s)/PDCCH(s); or (3) the UE could follow the design examples discussed herein to determine/configure the BFD RS(s) for the corresponding CORESET(s)/PDCCH(s).

In yet another example, if the UE receives from the network a MAC CE for common beam indication (as illustrated in FIG. 10), the UE could follow at least one of the following to determine/configure the BFD RS resource(s): (1) the UE could use the higher layer RRC configured (e.g., via the higher layer parameter Beam-Failure-Detection-RS-ResourceConfig) one or more BFD RSs to monitor the link quality or detect potential beam failure for one or more CORESETs/PDCCHs; (2) the UE could follow the design examples herein implicitly determine/configure the BFD RS(s) as the QCL source RS(s) indicated in the common/unified TCI state (for at least PDCCH); here, the common/unified TCI state is indicated via the MAC CE for common beam indication; or (3) the UE could follow the design examples discussed herein to determine/configure the BFD RS(s) for the corresponding CORESET(s)/PDCCH(s).

In yet another example, the UE could be configured/indicated/provided by the network, e.g., in higher layer RRC signaling/parameter (e.g., provided by failureDetectionResourcesToAddModList) and/or MAC CE command (e.g., a BFD-RS indication MAC CE), one or more BFD RSs or BFD RS resource configuration indexes in the set q0, wherein each BFD RS resource configuration index could correspond to a SSB index or a CSI-RS resource configuration index. Furthermore, the UE could assess the radio link quality of one or more of the RRC/MAC CE indicated/configured/provided BFD RSs in the set q0 following those specified in the design examples herein.

When/if the UE is indicated by the network, e.g., in a beam indication/activation MAC CE or beam indication DCI (e.g., DCI format 1_1/1_2 with or without DL assignment), one or more unified/common joint/DL/UL TCI states different from previously indicated ones, the UE could determine the BFD RS(s) in the set q0 and assess the radio link quality of q0 according to one or more of the followings: (1) the UE could follow those specified in the design examples in the present disclosure to determine the BFD RS(s) in the set q0 and assess the radio link quality of q0; or (2) the UE could follow those specified in the design examples specified/described in the present disclosure to determine the BFD RS(s) in the set q0 and assess the radio link quality of q0.

In yet another example, the physical layer of the UE could assess the radio link quality of all the BFD RS(s) in the BFD RS set q0 and inform higher layers when the radio link quality is worse than a BFD threshold Qout. As discussed herein, the configuration/determination of the BFD RS(s) in the BFD RS set q0 could follow those specified in the design examples in the present disclosure. The higher layers of the UE could maintain a beam failure instance (BFI) counter. If the higher layers in the UE are informed that the radio link quality for the BFD RS set q0 is worse than the BFD threshold Qout, the higher layers in the UE could increment the BFI count for the BFD RS set q0 (e.g., provided by the higher layer parameter BFI_COUNTER) by one. The UE could declare a beam failure for the BFD RS set q0 if the BFI count for the BFD RS set q0 reaches the maximum number of BFI counts (e.g., provided by the higher layer parameter maxBFIcount) before a BFD timer expires.

The higher layers in the UE may reset the BFI count to zero if at least one of the following occurs: (1) the BFD timer expires before the BFI count reaches the maximum number of BFI counts; or (2) the UE receives from the network a common/unified joint/DL/UL TCI state/beam update for UE-dedicated PDCCH/PDSCH or dynamic-grant/configured-grant based PUSCH and all of dedicated PUCCH resources. The common/unified joint/DL/UL TCI state/beam update can be indicated via beam indication/activation MAC CE or beam indication DCI (with or without downlink assignment and with or without MAC CE activation) as specified/described herein, and different from the previously indicated common/unified joint/DL/UL TCI state/beam.

Under the Rel. 15/16 TCI framework, the UE may expect to receive from the network a MAC CE to indicate the one or more TCI states—from a higher layer RRC configured pool of TCI states—for the one or more PDCCHs transmitted from at least one TRP in a multi-TRP system. Under the unified TCI framework, the UE may expect to receive from the network a MAC CE, or a DCI, or both MAC CE and DCI to indicate the one or more TCI states—from a higher layer RRC configured pool of TCI states—for the one or more PDCCHs transmitted from at least one TRP in a multi-TRP system.

Furthermore, as mentioned herein, the MAC CE/DCI for common TCI state/beam indication could indicate/include N≥1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s).

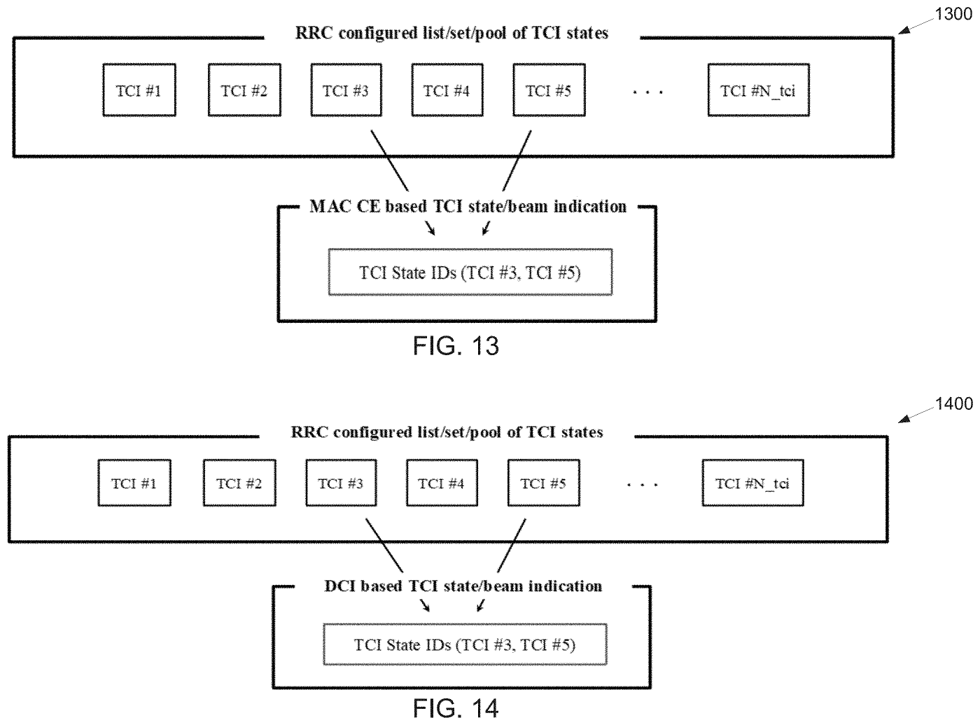

FIG. 13 illustrates an example of MAC CE based TCI state/beam activation/indication for the multi-TRP operation 1300 according to embodiments of the present disclosure. An embodiment of the MAC CE based TCI state/beam activation/indication for the multi-TRP operation 1300 shown in FIG. 13 is for illustration only.

In FIG. 13, an example of MAC CE based TCI state/beam indication for the multi-TRP operation is presented. As illustrated in FIG. 13, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE commands to indicate one or more TCI states/beams for the transmission/reception of the PDCCH(s), PDSCH(s), PUCCH(s), or PUSCH(s).

The MAC CE for common TCI state/beam indication could indicate/include N≥1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s).

FIG. 14 illustrates an example of DCI based TCI state/beam indication for the multi-TRP operation 1400 according to embodiments of the present disclosure. An embodiment of the DCI based TCI state/beam indication for the multi-TRP operation 1400 shown in FIG. 14 is for illustration only.

In FIG. 14, an example of DCI based common TCI state/beam indication for the multi-TRP operation is presented. As illustrated in FIG. 11, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more DCIs to indicate one or more TCI states/beams for the transmission/reception of the PDCCH(s), PDSCH(s), PUSCH(s), or PUCCH(s).

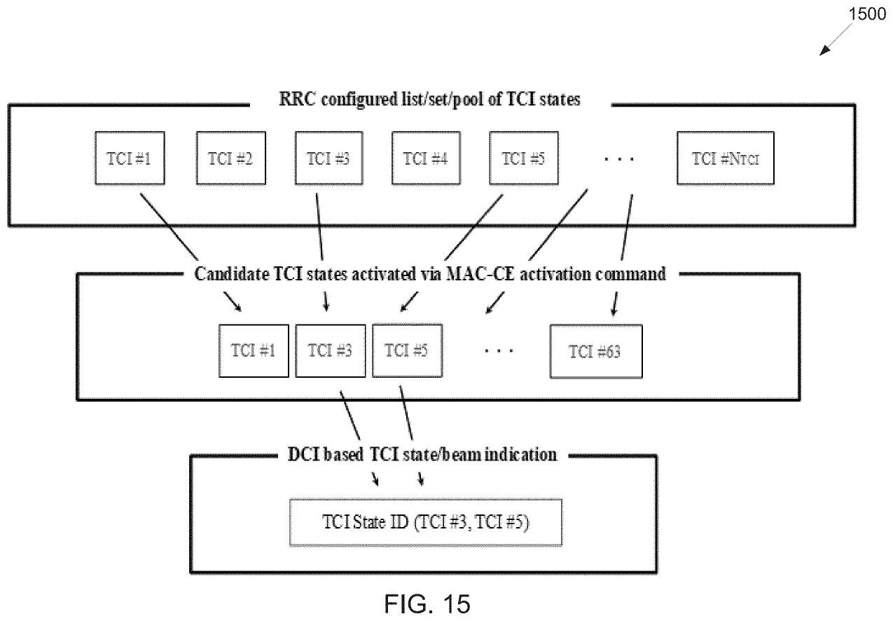

FIG. 15 illustrates another example of DCI based TCI state/beam indication with MAC CE activated TCI states for the multi-TRP operation 1500 according to embodiments of the present disclosure. An embodiment of the DCI based TCI state/beam indication with MAC CE activated TCI states for the multi-TRP operation 1500 shown in FIG. 15 is for illustration only.

In FIG. 15, an example of DCI based common TCI state/beam indication (with MAC CE activated TCI states) for the multi-TRP operation is presented. As illustrated in FIG. 13, the UE could be first higher layer configured by the network, e.g., via the higher layer RRC signaling, a list/pool of N_tci TCI states. Each TCI state contains at least a QCL source RS with a QCL type, e.g., QCL-typeA/B/C/D. The UE could then receive from the network one or more MAC CE activation commands activating one or more TCI states from the higher layer configured list/pool of TCI states, e.g., up to eight TCI states could be activated by a MAC CE activation command. The UE could receive from the network one or more DCIs for beam indication to indicate one or more TCI states/beams from the MAC CE activated TCI state(s)/beam(s) for the transmission/reception of the PDCCH(s), PDSCH(s), PUCCH(s), or PUSCH(s).

As discussed herein, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; or (3) yet in another example, a custom/purpose designed DCI format could be used to indicate to the UE a beam (i.e., a TCI state and/or a TCI state ID) for the transmission/reception of a PDCCH or a PDSCH.

Furthermore, the DCI for common TCI state/beam indication could indicate/include N≥1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; or (4) separate DL TCI state and UL TCI state and/or their corresponding/associated TCI state ID(s).

As discussed herein in the present disclosure, the UE could receive a MAC CE activation command, e.g., Unified TCI states activation/deactivation MAC CE command, used to map up to Ncp≥1 (e.g., Ncp=8 or Ncp=16) TCI codepoints of a TCI field in a beam indication DCI (e.g., DCI format 1_1/1_2 with or without DL assignment), wherein a TCI codepoint could contain/comprise/include one or more, e.g., N≥1 or M≥1 (e.g., N=2 or M=2), TCI states or pairs of TCI states, and a TCI state could correspond to a joint TCI state provided by DLorJointTCIState, a separate DL TCI state provided by DLorJointTCIState, or a separate UL TCI state provided by UL-TCIState.

As discussed herein, N≥1 DL TCI states and/or M≥1 UL TCI states could be indicated in the MAC CE or DCI based common TCI state/beam indication for the multi-TRP operation. Furthermore, the UE could be configured/indicated by the network a list/set/pool of TRP-specific index/ID values such as CORESETPoolIndex values, PCIs or other TRP-specific higher layer signaling index/ID values to represent the TRPs in the multi-TRP system.

In addition, as described in the U.S. patent application Ser. No. 17/449,602 and the U.S. patent application Ser. No. 17/451,611, as incorporated by reference herein in their entirety, more than one BFD RS sets each comprising/including at least one BFD RS beam/resource could be configured for the multi-TRP BFR. If only N≥1 DL TCI states and/or their corresponding/associated TCI state IDs are indicated in the MAC CE or DCI based common TCI state/beam indication, following examples may be provided.

In one example, among the N≥1 DL TCI states, the first DL TCI state (or DL TCI state 1) could correspond to/be associated with the first TRP-specific index/ID value in the list/set/pool of TRP-specific index/ID values such as CORESETPoolIndex values, PCIs or other TRP-specific higher layer signaling index/ID values, the second DL TCI state (or DL TCI state 2) could correspond to/be associated with the second TRP-specific index/ID value in the list/set/pool of TRP-specific index/ID values such as CORESETPoolIndex values, PCIs or other TRP-specific higher layer signaling index/ID values, and so on, and the N-th DL TCI state (or DL TCI state N) could correspond to/be associated with the N-th TRP-specific index/ID value in the list/set/pool of TRP-specific index/ID values such as CORESETPoolIndex values, PCIs or other TRP-specific higher layer signaling index/ID values. That is, the n-th DL TCI state (or DL TCI state n) could correspond to/be associated with the n-th TRP-specific index/ID value in the list/set/pool of TRP-specific index/ID values such as CORESETPoolIndex values, PCIs or other TRP-specific higher layer signaling index/ID values, where n=1, 2, . . . , N.

For example, the n-th DL TCI state (or DL TCI state n) could correspond to/be associated with the n-th PCI value in the list/set/pool of PCIs, where n=1, 2. For another example, for N=2, the n-th DL TCI state (or DL TCI state n) could correspond to/be associated with the n-th CORESETPoolIndex value in the list/set/pool of CORESETPoolIndex values, where n=1, 2.

In another example, among the N≥1 DL TCI states, the DL TCI state with the lowest (or the highest) TCI state ID value could correspond to/be associated with the first TRP-specific index/ID value in the list/set/pool of TRP-specific index/ID values such as CORESETPoolIndex values, PCIs or other TRP-specific higher layer signaling index/ID values, the DL TCI state with the second lowest (or the second highest) TCI state ID value could correspond to/be associated with the second TRP-specific index/ID value in the list/set/pool of TRP-specific index/ID values such as CORESETPoolIndex values, PCIs or other TRP-specific higher layer signaling index/ID values, and so on, and the DL TCI state with the highest (or the lowest) TCI state ID value could correspond to/be associated with the N-th TRP-specific index/ID value in the list/set/pool of TRP-specific index/ID values such as CORESETPoolIndex values, PCIs or other TRP-specific higher layer signaling index/ID values. That is, the DL TCI state with the n-th lowest (or highest) TCI state ID value could correspond to/be associated with the n-th TRP-specific index/ID value in the list/set/pool of TRP-specific index/ID values such as CORESETPoolIndex values, PCIs or other TRP-specific higher layer signaling index/ID values, where n=1, 2, . . . , N.

For example, the DL TCI state with the n-th lowest (or highest) TCI state ID value could correspond to/be associated with the n-th PCI value in the list/set/pool of PCIs, where n=1, 2. For another example, for N=2, the DL TCI state with the n-th lowest (or highest) TCI state ID value could correspond to/be associated with the n-th CORESETPoolIndex value in the list/set/pool of CORESETPoolIndex values, where n=1, 2.

In yet another example, among the N≥1 DL TCI states, the first DL TCI state (or DL TCI state 1) could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the second DL TCI state (or DL TCI state 2) could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the N-th DL TCI state (or DL TCI state N) could correspond to/be associated with the N-th lowest (or the N-th highest) TRP-specific index/ID value in the list/set/pool of TRP-specific index/ID values such as CORESETPoolIndex values, PCIs or other TRP-specific higher layer signaling index/ID values. That is, the n-th DL TCI state (or DL TCI state n) could correspond to/be associated with the n-th lowest (or highest) TRP-specific index/ID value in the list/set/pool of TRP-specific index/ID values such as CORESETPoolIndex values, PCIs or other TRP-specific higher layer signaling index/ID values, where n=1, 2, . . . , N.

For example, the n-th DL TCI state (or DL TCI state n) could correspond to/be associated with the n-th lowest (or highest) PCI value in the list/set/pool of PCIs, where n=1, 2. For another example, for N=2, the n-th DL TCI state (or DL TCI state n) could correspond to/be associated with CORESETPoolIndex value n−1, where n=1, 2.

In yet another example, among the N≥1 DL TCI states, the DL TCI state with the lowest (or the highest) TCI state ID value could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the DL TCI state with the second lowest (or the second highest) TCI state ID value could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the DL TCI state with the highest (or the lowest) TCI state ID value could correspond to/be associated with the N-th lowest (or highest) TRP-specific index/ID value in the list/set/pool of TRP-specific index/ID values such as CORESETPoolIndex values, PCIs or other TRP-specific higher layer signaling index/ID values. That is, the DL TCI state with the n-th lowest (or highest) TCI state ID value could correspond to/be associated with the n-th lowest (or highest) TRP-specific index/ID value in the list/set/pool of TRP-specific index/ID values such as CORESETPoolIndex values, PCIs or other TRP-specific higher layer signaling index/ID values, where n=1, 2, . . . , N.

For example, the DL TCI state with the n-th lowest (or highest) TCI state ID value could correspond to/be associated with the n-th lowest (or highest) PCI value in the list/set/pool of PCIs, where n=1, 2. For another example, for N=2, the DL TCI state with the n-th lowest (or highest) TCI state ID value could correspond to/be associated with CORESETPoolIndex value n−1, where n=1, 2.

In yet another example, among the N≥1 DL TCI states, the first DL TCI state (or DL TCI state 1) could correspond to/be associated with the first BFD RS set (or BFD RS set 1), the second DL TCI state (or DL TCI state 2) could correspond to/be associated with the second BFD RS set (or BFD RS set 2), and so on, and the N-th DL TCI state (or DL TCI state N) could correspond to/be associated the N-th BFD RS set (or BFD RS set N). That is, the n-th DL TCI state (or DL TCI state n) could correspond to/be associated with the n-th BFD RS set (or BFD RS set n), where n=1, 2, . . . , N.

In yet another example, among the N≥1 DL TCI states, the DL TCI state with the lowest (or the highest) TCI state ID value could correspond to/be associated with the first BFD RS set (or BFD RS set 1), the DL TCI state with the second lowest (or the second highest) TCI state ID value could correspond to/be associated with the second BFD RS set (or BFD RS set 2), and so on, and the DL TCI state with the highest (or the lowest) TCI state ID value could correspond to/be associated with the N-th BFD RS set (or BFD RS set N). That is, the DL TCI state with the n-th lowest (or highest) TCI state ID value could correspond to/be associated with the n-th BFD RS set (or BFD RS set n), where n=1, 2, . . . , N.

In yet another example, among the N≥1 DL TCI states, the first DL TCI state (or DL TCI state 1) could correspond to/be associated with the BFD RS set with the lowest (or the highest) BFD RS set ID value, the second DL TCI state (or DL TCI state 2) could correspond to/be associated with the BFD RS set with the second lowest (or the second highest) BFD RS set ID value, and so on, and the N-th DL TCI state (or DL TCI state N) could correspond to/be associated with the BFD RS set with the N-th lowest (or the N-th highest) BFD RS set ID value. That is, the n-th DL TCI state (or DL TCI state n) could correspond to/be associated with the BFD RS set with the n-th lowest (or highest) BFD RS set ID value, where n=1, 2, . . . , N.

In yet another example, among the N≥1 DL TCI states, the DL TCI state with the lowest (or the highest) TCI state ID value could correspond to/be associated with the BFD RS set with the lowest (or the highest) BFD RS set ID, the DL TCI state with the second lowest (or the second highest) TCI state ID value could correspond to/be associated with the BFD RS set with the second lowest (or the second highest) BFD RS set ID value, and so on, and the DL TCI state with the highest (or the lowest) TCI state ID value could correspond to/be associated with the BFD RS set with the N-th lowest (or highest) BFD RS set ID value. That is, the DL TCI state with the n-th lowest (or highest) TCI state ID value could correspond to/be associated with the BFD RS set with the n-th lowest (or highest) BFD RS set ID value, where n=1, 2, . . . , N.

In yet another example, the UE could be explicitly indicated by the network the association between the N≥1 DL TCI states and the TRPs in the multi-TRP system or the N≥1 DL TCI states and the configured BFD RS sets; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

If only M≥1 UL TCI states and/or their corresponding/associated TCI state IDs are indicated in the MAC CE or DCI based common TCI state/beam indication, following examples may be provided.

In one example, among the M≥1 UL TCI states, the first UL TCI state (or UL TCI state 1) could correspond to/be associated with the first TRP-specific index/ID value in the list/set/pool of TRP-specific index/ID values such as CORESETPoolIndex values, PCIs or other TRP-specific higher layer signaling index/ID values, the second UL TCI state (or UL TCI state 2) could correspond to/be associated with the second TRP-specific index/ID value in the list/set/pool of TRP-specific index/ID values such as CORESETPoolIndex values, PCIs or other TRP-specific higher layer signaling index/ID values, and so on, and the M-th UL TCI state (or UL TCI state M) could correspond to/be associated with the M-th TRP-specific index/ID value in the list/set/pool of TRP-specific index/ID values such as CORESETPoolIndex values, PCIs or other TRP-specific higher layer signaling index/ID values. That is, the m-th UL TCI state (or UL TCI state m) could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2, . . . , M.

For example, the m-th UL TCI state (or UL TCI state m) could correspond to/be associated with the m-th PCI value in the list/set/pool of PCIs, where m=1, 2. For another example, for M=2, the m-th UL TCI state (or UL TCI state m) could correspond to/be associated with the m-th CORESETPoolIndex value in the list/set/pool of CORESETPoolIndex values, where m=1, 2.

In another example, among the M≥1 UL TCI states, the UL TCI state with the lowest (or the highest) TCI state ID value could correspond to/be associated with the first TRP-specific index/ID value in the list/set/pool of TRP-specific index/ID values such as CORESETPoolIndex values, PCIs or other TRP-specific higher layer signaling index/ID values, the UL TCI state with the second lowest (or the second highest) TCI state ID value could correspond to/be associated with the second TRP-specific index/ID value in the list/set/pool of TRP-specific index/ID values such as CORESETPoolIndex values, PCIs or other TRP-specific higher layer signaling index/ID values, and so on, and the UL TCI state with the highest (or the lowest) TCI state ID value could correspond to/be associated with the M-th TRP-specific index/ID value in the list/set/pool of TRP-specific index/ID values such as CORESETPoolIndex values, PCIs or other TRP-specific higher layer signaling index/ID values. That is, the UL TCI state with the m-th lowest (or highest) TCI state ID value could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2, . . . , M.

For example, the UL TCI state with the m-th lowest (or highest) TCI state ID value could correspond to/be associated with the m-th PCI value in the list/set/pool of PCIs, where m=1, 2. For another example, for M=2, the UL TCI state with the m-th lowest (or highest) TCI state ID value could correspond to/be associated with the m-th CORESETPoolIndex value in the list/set/pool of CORESETPoolIndex values, where m=1, 2.

In yet another example, among the M≥1 UL TCI states, the first UL TCI state (or UL TCI state 1) could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the second UL TCI state (or UL TCI state 2) could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the M-th UL TCI state (or UL TCI state M) could correspond to/be associated with the M-th lowest (or the M-th highest) TRP-specific index/ID value in the list/set/pool of TRP-specific index/ID values such as CORESETPoolIndex values, PCIs or other TRP-specific higher layer signaling index/ID values. That is, the m-th UL TCI state (or UL TCI state m) could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2, . . . , M.

For example, the m-th UL TCI state (or UL TCI state m) could correspond to/be associated with the m-th lowest (or highest) PCI value in the list/set/pool of PCIs, where m=1, 2. For another example, for M=2, the m-th UL TCI state (or UL TCI state m) could correspond to/be associated with CORESETPoolIndex value m−1, where m=1, 2.

In yet another example, among the M≥1 UL TCI states, the UL TCI state with the lowest (or the highest) TCI state ID value could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the UL TCI state with the second lowest (or the second highest) TCI state ID value could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the UL TCI state with the highest (or the lowest) TCI state ID value could correspond to/be associated with the M-th lowest (or highest) TRP-specific index/ID value in the list/set/pool of TRP-specific index/ID values such as CORESETPoolIndex values, PCIs or other TRP-specific higher layer signaling index/ID values. That is, the UL TCI state with the m-th lowest (or highest) TCI state ID value could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2, . . . , M.

For example, the UL TCI state with the m-th lowest (or highest) TCI state ID value could correspond to/be associated with the m-th lowest (or highest) PCI value in the list/set/pool of PCIs, where m=1, 2. For another example, for M=2, the UL TCI state with the m-th lowest (or highest) TCI state ID value could correspond to/be associated with CORESETPoolIndex value m−1, where m=1, 2.

In yet another example, among the M≥1 UL TCI states, the first UL TCI state (or UL TCI state 1) could correspond to/be associated with the first BFD RS set (or BFD RS set 1), the second UL TCI state (or UL TCI state 2) could correspond to/be associated with the second BFD RS set (or BFD RS set 2), and so on, and the M-th UL TCI state (or UL TCI state M) could correspond to/be associated the M-th BFD RS set (or BFD RS set M). That is, the m-th UL TCI state (or UL TCI state m) could correspond to/be associated with the m-th BFD RS set (or BFD RS set m), where m=1, 2, . . . , M.

In yet another example, among the M≥1 UL TCI states, the UL TCI state with the lowest (or the highest) TCI state ID value could correspond to/be associated with the first BFD RS set (or BFD RS set 1), the UL TCI state with the second lowest (or the second highest) TCI state ID value could correspond to/be associated with the second BFD RS set (or BFD RS set 2), and so on, and the UL TCI state with the highest (or the lowest) TCI state ID value could correspond to/be associated with the M-th BFD RS set (or BFD RS set M). That is, the UL TCI state with the m-th lowest (or highest) TCI state ID value could correspond to/be associated with the m-th BFD RS set (or BFD RS set m), where m=1, 2, . . . , M.

In yet another example, among the M≥1 UL TCI states, the first UL TCI state (or UL TCI state 1) could correspond to/be associated with the BFD RS set with the lowest (or the highest) BFD RS set ID value, the second UL TCI state (or UL TCI state 2) could correspond to/be associated with the BFD RS set with the second lowest (or the second highest) BFD RS set ID value, and so on, and the M-th UL TCI state (or UL TCI state M) could correspond to/be associated with the BFD RS set with the M-th lowest (or the M-th highest) BFD RS set ID value. That is, the m-th UL TCI state (or UL TCI state m) could correspond to/be associated with the BFD RS set with the m-th lowest (or highest) BFD RS set ID value, where m=1, 2, . . . , M.

In yet another example, among the M≥1 UL TCI states, the UL TCI state with the lowest (or the highest) TCI state ID value could correspond to/be associated with the BFD RS set with the lowest (or the highest) BFD RS set ID, the UL TCI state with the second lowest (or the second highest) TCI state ID value could correspond to/be associated with the BFD RS set with the second lowest (or the second highest) BFD RS set ID value, and so on, and the UL TCI state with the highest (or the lowest) TCI state ID value could correspond to/be associated with the BFD RS set with the M-th lowest (or highest) BFD RS set ID value. That is, the UL TCI state with the m-th lowest (or highest) TCI state ID value could correspond to/be associated with the BFD RS set with the m-th lowest (or highest) BFD RS set ID value, where m=1, 2, . . . , M.

In yet another example, the UE could be explicitly indicated by the network the association between the M≥1 UL TCI states and the TRPs in the multi-TRP system or the M≥1 UL TCI states and the configured BFD RS sets; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

If N=M≥1 joint DL and UL TCI states and/or their corresponding/associated TCI state IDs are indicated in the MAC CE or DCI based common TCI state/beam indication, following examples may be provided.

In one example, among the M≥1 joint DL and UL TCI states, the first joint DL and UL TCI state (or joint DL and UL TCI state 1) could correspond to/be associated with the first TRP-specific index/ID value in the list/set/pool of TRP-specific index/ID values such as CORESETPoolIndex values, PCIs or other TRP-specific higher layer signaling index/ID values, the second joint DL and UL TCI state (or joint DL and UL TCI state 2) could correspond to/be associated with the second TRP-specific index/ID value in the list/set/pool of TRP-specific index/ID values such as CORESETPoolIndex values, PCIs or other TRP-specific higher layer signaling index/ID values, and so on, and the M-th joint DL and UL TCI state (or joint DL and UL TCI state M) could correspond to/be associated with the M-th TRP-specific index/ID value in the list/set/pool of TRP-specific index/ID values such as CORESETPoolIndex values, PCIs or other TRP-specific higher layer signaling index/ID values. That is, the m-th joint DL and UL TCI state (or joint DL and UL TCI state m) could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2, . . . , M.

For example, the m-th joint DL and UL TCI state (or joint DL and UL TCI state m) could correspond to/be associated with the m-th PCI value in the list/set/pool of PCIs, where m=1, 2. For another example, for M=2, the m-th joint DL and UL TCI state (or joint DL and UL TCI state m) could correspond to/be associated with the m-th CORESETPoolIndex value in the list/set/pool of CORESETPoolIndex values, where m=1, 2.

In another example, among the M≥1 joint DL and UL TCI states, the joint DL and UL TCI state with the lowest (or the highest) TCI state ID value could correspond to/be associated with the first TRP-specific index/ID value in the list/set/pool of TRP-specific index/ID values such as CORESETPoolIndex values, PCIs or other TRP-specific higher layer signaling index/ID values, the joint DL and UL TCI state with the second lowest (or the second highest) TCI state ID value could correspond to/be associated with the second TRP-specific index/ID value in the list/set/pool of TRP-specific index/ID values such as CORESETPoolIndex values, PCIs or other TRP-specific higher layer signaling index/ID values, and so on, and the joint DL and UL TCI state with the highest (or the lowest) TCI state ID value could correspond to/be associated with the M-th TRP-specific index/ID value in the list/set/pool of TRP-specific index/ID values such as CORESETPoolIndex values, PCIs or other TRP-specific higher layer signaling index/ID values. That is, the joint DL and UL TCI state with the m-th lowest (or highest) TCI state ID value could correspond to/be associated with the m-th TRP-specific index/ID value in the list/set/pool of TRP-specific index/ID values such as CORESETPoolIndex values, PCIs or other TRP-specific higher layer signaling index/ID values, where m=1, 2, . . . , M.

For example, the joint DL and UL TCI state with the m-th lowest (or highest) TCI state ID value could correspond to/be associated with the m-th PCI value in the list/set/pool of PCIs, where m=1, 2. For another example, for M=2, the joint DL and UL TCI state with the m-th lowest (or highest) TCI state ID value could correspond to/be associated with the m-th CORESETPoolIndex value in the list/set/pool of CORESETPoolIndex values, where m=1, 2.

In yet another example, among the M≥1 joint DL and UL TCI states, the first joint DL and UL TCI state (or joint DL and UL TCI state 1) could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the second joint DL and UL TCI state (or joint DL and UL TCI state 2) could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the M-th joint DL and UL TCI state (or joint DL and UL TCI state M) could correspond to/be associated with the M-th lowest (or the M-th highest) TRP-specific index/ID value in the list/set/pool of TRP-specific index/ID values such as CORESETPoolIndex values, PCIs or other TRP-specific higher layer signaling index/ID values. That is, the m-th joint DL and UL TCI state (or joint DL and UL TCI state m) could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2, . . . , M.

For example, the m-th joint DL and UL TCI state (or joint DL and UL TCI state m) could correspond to/be associated with the m-th lowest (or highest) PCI value in the list/set/pool of PCIs, where m=1, 2. For another example, for M=2, the m-th joint DL and UL TCI state (or joint DL and UL TCI state m) could correspond to/be associated with CORESETPoolIndex value m−1, where m=1, 2.

In yet another example, among the M≥1 joint DL and UL TCI states, the joint DL and UL TCI state with the lowest (or the highest) TCI state ID value could correspond to/be associated with the lowest (or the highest) TRP-specific index/ID value in the list/set/pool of TRP-specific index/ID values such as CORESETPoolIndex values, PCIs or other TRP-specific higher layer signaling index/ID values, the joint DL and UL TCI state with the second lowest (or the second highest) TCI state ID value could correspond to/be associated with the second lowest (or the second highest) TRP-specific index/ID value in the list/set/pool of TRP-specific index/ID values such as CORESETPoolIndex values, PCIs or other TRP-specific higher layer signaling index/ID values, and so on, and the joint DL and UL TCI state with the highest (or the lowest) TCI state ID value could correspond to/be associated with the M-th lowest (or highest) TRP-specific index/ID value in the list/set/pool of TRP-specific index/ID values such as CORESETPoolIndex values, PCIs or other TRP-specific higher layer signaling index/ID values. That is, the joint DL and UL TCI state with the m-th lowest (or highest) TCI state ID value could correspond to/be associated with the m-th lowest (or highest) TRP-specific index/ID value in the list/set/pool of TRP-specific index/ID values such as CORESETPoolIndex values, PCIs or other TRP-specific higher layer signaling index/ID values, where m=1, 2, . . . , M.

For example, the joint DL and UL TCI state with the m-th lowest (or highest) TCI state ID value could correspond to/be associated with the m-th lowest (or highest) PCI value in the list/set/pool of PCIs, where m=1, 2. For another example, for M=2, the joint DL and UL TCI state with the m-th lowest (or highest) TCI state ID value could correspond to/be associated with CORESETPoolIndex value m−1, where m=1, 2.

In yet another example, among the M≥1 joint DL and UL TCI states, the first joint DL and UL TCI state (or joint DL and UL TCI state 1) could correspond to/be associated with the first BFD RS set (or BFD RS set 1), the second joint DL and UL TCI state (or joint DL and UL TCI state 2) could correspond to/be associated with the second BFD RS set (or BFD RS set 2), and so on, and the M-th joint DL and UL TCI state (or joint DL and UL TCI state M) could correspond to/be associated the M-th BFD RS set (or BFD RS set M). That is, the m-th joint DL and UL TCI state (or UL TCI state m) could correspond to/be associated with the m-th BFD RS set (or BFD RS set m), where m=1, 2, . . . , M.

In yet another example, among the M≥1 joint DL and UL TCI states, the joint DL and UL TCI state with the lowest (or the highest) TCI state ID value could correspond to/be associated with the first BFD RS set (or BFD RS set 1), the joint DL and UL TCI state with the second lowest (or the second highest) TCI state ID value could correspond to/be associated with the second BFD RS set (or BFD RS set 2), and so on, and the joint DL and UL TCI state with the highest (or the lowest) TCI state ID value could correspond to/be associated with the M-th BFD RS set (or BFD RS set M). That is, the joint DL and UL TCI state with the m-th lowest (or highest) TCI state ID value could correspond to/be associated with the m-th BFD RS set (or BFD RS set m), where m=1, 2, . . . , M.

In yet another example, among the M≥1 joint DL and UL TCI states, the first joint DL and UL TCI state (or joint DL and UL TCI state 1) could correspond to/be associated with the BFD RS set with the lowest (or the highest) BFD RS set ID value, the second joint DL and UL TCI state (or joint DL and UL TCI state 2) could correspond to/be associated with the BFD RS set with the second lowest (or the second highest) BFD RS set ID value, and so on, and the M-th joint DL and UL TCI state (or joint DL and UL TCI state M) could correspond to/be associated with the BFD RS set with the M-th lowest (or the M-th highest) BFD RS set ID value. That is, the m-th joint DL and UL TCI state (or joint DL and UL TCI state m) could correspond to/be associated with the BFD RS set with the m-th lowest (or highest) BFD RS set ID value, where m=1, 2, . . . , M.

In yet another example, among the M≥1 joint DL and UL TCI states, the joint DL and UL TCI state with the lowest (or the highest) TCI state ID value could correspond to/be associated with the BFD RS set with the lowest (or the highest) BFD RS set ID, the joint DL and UL TCI state with the second lowest (or the second highest) TCI state ID value could correspond to/be associated with the BFD RS set with the second lowest (or the second highest) BFD RS set ID value, and so on, and the joint DL and UL TCI state with the highest (or the lowest) TCI state ID value could correspond to/be associated with the BFD RS set with the M-th lowest (or highest) BFD RS set ID value. That is, the joint DL and UL TCI state with the m-th lowest (or highest) TCI state ID value could correspond to/be associated with the BFD RS set with the m-th lowest (or highest) BFD RS set ID value, where m=1, 2, . . . , M.

In yet another example, the UE could be explicitly indicated by the network the association between the M≥1 joint DL and UL TCI states and the TRPs in the multi-TRP system or the M≥1 joint DL and UL TCI states and the configured BFD RS sets; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

If separate N≥1 DL TCI states and M≥1 separate UL TCI states and/or their corresponding/associated TCI state IDs are indicated in the MAC CE or DCI based common TCI state/beam indication: (1) the association between the separate N≥1 DL TCI states and the TRPs in the multi-TRP system and the association between the separate N≥1 DL TCI states and the BFD RS sets could follow those specified in the examples herein; and (2) the association between the separate M≥1 UL TCI states and the TRPs in the multi-TRP system and the association between the separate M≥1 UL TCI states and the BFD RS sets could follow those specified in the examples herein.

Among the TCI state(s) or pair(s) of TCI states indicated in the beam indication/activation MAC CE (with a single TCI codepoint activated, i.e., Ncp=1) or the beam indication DCI (e.g., by one or more TCI codepoints in one or more TCI fields in DCI format 1_1/1_2 with or without DL assignment), a first indicated TCI state/pair of TCI states could be associated to a first TRP-specific index/ID value (and therefore, the corresponding DL/UL channels/signals that are associated to the first TRP-specific index/ID value), a second indicated TCI state/pair of TCI states could be associated to a second TRP-specific index/ID value (and therefore, the corresponding DL/UL channels/signals that are associated to the second TRP-specific index/ID value), and so on, and a N-th (or M-th) TCI state/pair of TCI states could be associated to a N-th (or M-th) TRP-specific index/ID value (and therefore, the corresponding DL/UL channels/signals that are associated to the N-th (or M-th) TRP-specific index/ID value).

In the examples described/specified herein, a m-th (or n-th) indicated TCI state/pair of TCI states could correspond to the m-th (or the n-th) indicated TCI state/pair of TCI states among all the TCI states/pairs of TCI states indicated in the beam indication MAC CE/DCI, or the indicated TCI state/pair of TCI states having the m-th (or the n-th) lowest (or highest) TCI state ID/index among all the TCI states/pairs of TCI states indicated in the beam indication MAC CE/DCI, where m∈{1, 2, . . . , M} and n∈{1, 2, . . . , N}. In the present disclosure, a TCI state could correspond to a joint TCI state provided by DLorJointTCIState, a separate DL TCI state provided by DLorJointTCIState, or a separate UL TCI state provided by UL-TCIState.

Furthermore, a m-th (or n-th) TRP-specific index/ID value could correspond to the m-th (or the n-th) TRP-specific index/ID value among all the TRP-specific index/ID values such as PCIs, PCI indexes each pointing to an entry/PCI in a list of PCIs higher layer provided/configured to the UE, CORESET pool indexes, CORESET group indexes, RS resource set indexes, and etc. provided/configured to the UE, or the m-th (or the n-th) lowest (or highest) TRP-specific index/ID value among all the TRP-specific index/ID values such as PCIs, PCI indexes each pointing to an entry/PCI in a list of PCIs higher layer provided/configured to the UE, CORESET pool indexes, CORESET group indexes, RS resource set indexes, and etc. provided/configured to the UE, where m∈{1, 2, . . . , M} and n∈{1, 2, . . . , N}. For M=2 (or M=2), m=1 or 2 and n=1 or 2.

For example, for M=2 (or N=2), the first (or the second) indicated TCI state/pair of TCI states or the indicated TCI state/pair of TCI states with the lowest (or highest) TCI state ID could be associated to the first TRP-specific index/ID value such as the first PCI among a list of PCIs, the first PCI index pointing to an entry of a list of PCIs, the first CORESETPoolIndex value, the first CORESETGroupIndex value, the first RS resource set index, and etc. (and therefore, the corresponding DL/UL channels/signals associated to the first TRP-specific index/ID value), and the second (or the first) indicated TCI state/pair of TCI states or the indicated TCI state/pair of TCI states with the highest (or lowest) TCI state ID could be associated to the second TRP-specific index/ID value such as the second PCI among a list of PCIs, the second PCI index pointing to an entry of a list of PCIs, the second CORESETPoolIndex value, the second CORESETGroupIndex value, the second RS resource set index, and etc. (and therefore, the corresponding DL/UL channels/signals associated to the second TRP-specific index/ID value).

For another example, for N=2 (or M=2), the first (or the second) indicated TCI state/pair of TCI states or the indicated TCI state/pair of TCI states with the lowest (or highest) TCI state ID could be associated to the lowest TRP-specific index/ID value such as the lowest PCI among a list of PCIs, the lowest PCI index pointing to an entry of a list of PCIs, the lowest CORESETPoolIndex value (e.g., 0), the lowest CORESETGroupIndex value (e.g., 0), the lowest RS resource set index, and etc. (and therefore, the corresponding DL/UL channels/signals associated to the lowest TRP-specific index/ID value), and the second (or the first) indicated TCI state/pair of TCI states or the indicated TCI state/pair of TCI states with the highest (or lowest) TCI state ID could be associated to the highest TRP-specific index/ID value such as the highest PCI among a list of PCIs, the highest PCI index pointing to an entry of a list of PCIs, the highest CORESETPoolIndex value (e.g., 1), the highest CORESETGroupIndex value (e.g., 1), the highest RS resource set index, and etc. (and therefore, the corresponding DL/UL channels/signals associated to the highest TRP-specific index/ID value).

Alternatively, the UE could be indicated/configured/provided by the network, e.g., via higher layer RRC signaling and/or MAC CE command and/or dynamic DCI based signaling, the association/mapping between the indicated TCI states/pairs of TCI states and the TRP-specific index/ID values.

Among the TCI state(s) or pair(s) of TCI states indicated in the beam indication/activation MAC CE (with a single TCI codepoint activated, i.e., Ncp=1) or the beam indication DCI (e.g., by one or more TCI codepoints in one or more TCI fields in DCI format 1_1/1_2 with or without DL assignment), a first indicated TCI state/pair of TCI states could be associated to a first BFD RS set comprising one or more BFD RS resource configuration indexes corresponding to one or more SSB indexes or periodic CSI-RS resource configuration indexes, a second indicated TCI state/pair of TCI states could be associated to a second BFD RS set comprising one or more BFD RS resource configuration indexes corresponding to one or more SSB indexes or periodic CSI-RS resource configuration indexes, and so on, and a N-th (or M-th) TCI state/pair of TCI states could be associated to a N-th (or M-th) BFD RS set comprising one or more BFD RS resource configuration indexes corresponding to one or more SSB indexes or periodic CSI-RS resource configuration indexes.

In the examples described/specified herein, a m-th (or n-th) indicated TCI state/pair of TCI states could correspond to the m-th (or the n-th) indicated TCI state/pair of TCI states among all the TCI states/pairs of TCI states indicated in the beam indication MAC CE/DCI, or the indicated TCI state/pair of TCI states having the m-th (or the n-th) lowest (or highest) TCI state ID/index among all the TCI states/pairs of TCI states indicated in the beam indication MAC CE/DCI, where m∈{1, 2, . . . , M} and n∈{1, 2, . . . , N}. In the present disclosure, a TCI state could correspond to a joint TCI state provided by DLorJointTCIState, a separate DL TCI state provided by DLorJointTCIState, or a separate UL TCI state provided by UL-TCIState. Furthermore, a m-th (or n-th) BFD RS set could correspond to the m-th (or the n-th) BFD RS set among all the BFD RS sets, or the BFD RS set with the m-th (or the n-th) lowest (or highest) set ID/index among all BFD RS sets, where m∈{1, 2, . . . , M} and n∈{1, 2, . . . , N}. For M=2 (or N=2), m=1 or 2 and n=1 or 2.

For example, for M=2 (or N=2), the first (or the second) indicated TCI state/pair of TCI states or the indicated TCI state/pair of TCI states with the lowest (or highest) TCI state ID could be associated to the first BFD RS set comprising one or more BFD RS resource configuration indexes corresponding to one or more SSB indexes or periodic CSI-RS resource configuration indexes, and the second (or the first) indicated TCI state/pair of TCI states or the indicated TCI state/pair of TCI states with the highest (or lowest) TCI state ID could be associated to the second BFD RS set comprising one or more BFD RS resource configuration indexes corresponding to one or more SSB indexes or periodic CSI-RS resource configuration indexes.

For another example, for M=2 (or N=2), the first (or the second) indicated TCI state/pair of TCI states or the indicated TCI state/pair of TCI states with the lowest (or highest) TCI state ID could be associated to the BFD RS set with the lowest set ID/index comprising one or more BFD RS resource configuration indexes corresponding to one or more SSB indexes or periodic CSI-RS resource configuration indexes, and the second (or the first) indicated TCI state/pair of TCI states or the indicated TCI state/pair of TCI states with the highest (or lowest) TCI state ID could be associated to the BFD RS set with the highest set ID/index comprising one or more BFD RS resource configuration indexes corresponding to one or more SSB indexes or periodic CSI-RS resource configuration indexes.

Alternatively, the UE could be indicated/configured/provided by the network, e.g., via higher layer RRC signaling and/or MAC CE command and/or dynamic DCI based signaling, the association/mapping between the indicated TCI states/pairs of TCI states and the BFD RS sets.

The UE could implicitly determine/configure the BFD RS(s) in a BFD RS set associated to a TRP as the QCL-typeD source RSs in one or more active TCI states indicated for one or more DL/UL channels/signals such as PDCCH, PDSCH, PUCCH, PUSCH, SRS, CSI-RS associated to the TRP (and therefore, the corresponding BFD RS set). Various means of implicitly configuring the BFD RS under the unified TCI framework are presented for the multi-TRP operation as follows.

In one example, the UE could implicitly determine/configure a BFD RS in the BFD RS set n as the QCL source RS indicated in the common DL TCI state n for both PDCCH and PDSCH under the Rel. 17 TCI framework. The UE could be indicated by the network the common DL TCI state n for both PDCCH and PDSCH via the MAC CE based or DCI based (with or without MAC CE activation) common beam indication strategy discussed herein. Here, n∈{1, . . . , N}.

In another example, the UE could implicitly determine/configure a BFD RS in the BFD RS set n as the QCL source RS indicated in the common joint DL and UL TCI state n for all DL and UL channels such as PDCCH, PDSCH, PUCCH and PUSCH under the Rel. 17 TCI framework. The UE could be indicated by the network the common joint DL and UL TCI state n for all DL and UL channels via the MAC CE based or DCI based (with or without MAC CE activation) common beam indication strategy discussed herein. Here, n∈{1, . . . , N}.

That is, for N=2, the UE could implicitly determine/configure one or more BFD RSs in a first BFD RS set q00 as periodic CSI-RS resource configuration indexes or SSB indexes with the same values as RS indexes in the RS sets indicated by a first indicated common/unified joint/DL TCI state (e.g., a first indicated joint TCI state provided by DLorJointTCIState or a first indicated separate DL TCI state provided by DLorJointTCIState), and one or more BFD RSs in a second BFD RS set q01 as periodic CSI-RS resource configuration indexes or SSB indexes with the same values as RS indexes in the RS sets indicated by a second indicated common/unified joint/DL TCI state (e.g., a second indicated joint TCI state provided by DLorJointTCIState or a second indicated separate DL TCI state provided by DLorJointTCIState).

The UE could be indicated by the network the first and/or second common/unified joint/DL TCI states via the MAC CE based or DCI based (with or without MAC CE activation) common beam indication strategy discussed herein—for DCI based beam indication, the first and/or second common/unified joint/DL TCI states could be indicated by one or more TCI codepoints in one or more TCI fields in the beam indication DCI (format 1_1 or 1_2 with or without DL assignment). The first BFD RS set, the second BFD RS set, the first indicated TCI state, and/or the second indicated TCI state could be defined/specified following those described herein. Furthermore, the design examples described herein can be extended/applied to cases with N≥2.

In yet another example, the UE could be indicated by the network N≥1 separate DL TCI states for PDCCH and PDCCH and M≥1 separate UL TCI states for PUCCH and PUSCH via the MAC CE based or DCI based (with or without MAC CE activation) common beam indication strategy discussed herein. The UE could implicitly determine/configure a BFD RS in the BFD RS set n as the QCL source RS in the separate DL TCI state n for PDCCH and PDSCH indicated via the common beam indication under the unified TCI framework. Here, n∈{1, . . . , N}.

In one example, the UE could implicitly determine/configure a BFD RS in the BFD RS set m as the QCL source RS in the separate UL TCI state m for PUCCH and PUSCH indicated via the common beam indication under the unified TCI framework. Here, me{1, . . . , M}.

In one example, the UE is not expected to determine/configure a BFD RS as the QCL source RS in any of the separate UL TCI states for PUCCH and PUSCH indicated via the common beam indication under the unified TCI framework.

The UE could be indicated/configured by the network, e.g., via higher layer RRC signaling and/or MAC CE command and/or dynamic DCI based L1 signaling, to follow the examples discussed herein.

In yet another example, the UE could be indicated by the network M≥1 common UL TCI states for both PUCCH and PUSCH via the MAC CE based or DCI based (with or without MAC CE activation) common beam indication strategy discussed herein for the multi-TRP operation.

In this case, in one example, the UE could implicitly determine/configure a BFD RS in the BFD RS set m as the QCL source RS in the common UL TCI state m for PUCCH and PUSCH under the unified TCI framework, where m∈{1, . . . , M}. In another example, the UE is not expected to determine/configure a BFD RS as the QCL source RS in any of the common UL TCI states for PUCCH and PUSCH under the unified TCI framework.

The UE could be indicated/configured by the network, e.g., via higher layer RRC signaling and/or MAC CE command and/or dynamic DCI based L1 signaling, to follow the examples discussed herein.

That is, for N=2, the UE could implicitly determine/configure one or more BFD RSs in a first BFD RS set q00 as periodic CSI-RS resource configuration indexes or SSB indexes with the same values as RS indexes in the RS sets indicated by a first indicated common/unified joint/DL/UL TCI state (e.g., a first indicated joint TCI state provided by DLorJointTCIState, a first indicated separate DL TCI state provided by DLorJointTCIState or a first indicated separate UL TCI state provided by UL-TCIState), and one or more BFD RSs in a second BFD RS set q01 as periodic CSI-RS resource configuration indexes or SSB indexes with the same values as RS indexes in the RS sets indicated by a second indicated common/unified joint/DL/UL TCI state (e.g., a second indicated joint TCI state provided by DLorJointTCIState, a second indicated separate DL TCI state provided by DLorJointTCIState or a second indicated separate UL TCI state provided by UL-TCIState).

Optionally, the UE may not determine periodic CSI-RS resource configuration indexes or SSB indexes that have the same values as RS indexes in the RS sets indicated by the first indicated separate UL TCI state provided by UL-TCIState as BFD RS(s) in the first set q00, and/or the UE may not determine periodic CSI-RS resource configuration indexes or SSB indexes that have the same values as RS indexes in the RS sets indicated by the second indicated separate UL TCI state provided by UL-TCIState as BFD RS(s) in the second set q01. The UE could be indicated by the network the first and/or second common/unified joint/DL/UL TCI states via the MAC CE based or DCI based (with or without MAC CE activation) common beam indication strategy discussed herein—for DCI based beam indication, the first and/or second common/unified joint/DL/UL TCI states could be indicated by one or more TCI codepoints in one or more TCI fields in the beam indication DCI (format 1_1 or 1_2 with or without DL assignment). The first BFD RS set, the second BFD RS set, the first indicated TCI state, and/or the second indicated TCI state could be defined/specified following those described herein. Furthermore, the design examples described herein can be extended/applied to cases with N≥2.

The UE could be explicitly higher layer configured by the network (e.g., via higher layer RRC signaling) N≥1 BFD RS sets each comprising at least one BFD RS resource for the multi-TRP operation. For instance, the UE could be provided by the network two BFD RS sets q00 and q01 via higher layer parameters failureDetectionSet1 and failureDetectionSet2, respectively, each comprising one or more BFD RS resource configuration indexes corresponding to one or more SSB indexes or periodic CSI-RS resource configuration indexes. Various explicit BFD RS configuration methods for the multi-TRP operation are presented as follows.

In one example, for the higher layer RRC configured N≥1 BFD RS sets (and therefore, the BFD RS resources configured therein) and one or more CORESETs that the UE is configured for monitoring PDCCH(s), the UE could only measure/monitor the BFD RS resource(s) in the BFD RS set n that is the same as the QCL source RS(s) indicated in the TCI state n for the CORESET(s)/PDCCH(s), where n∈{1, . . . , N}. Under the unified TCI framework, the TCI state n for the CORESET(s)/PDCCH(s) could be indicated via the MAC CE based or DCI based (with or without MAC CE activation) common beam indication strategy discussed herein. Furthermore, the indicated TCI state n (n∈{1, . . . , N}) for the CORESET(s)/PDCCH(s) could be: (1) a DL TCI state and/or its corresponding/associated TCI state ID for both PDCCH and PDSCH, (2) an UL TCI state and/or its corresponding/associated TCI state ID for both PUCCH and PUSCH, (3) a joint DL and UL TCI state and/or its corresponding/associated TCI state ID for all DL and UL channels such as PDCCH, PDSCH, PUCCH and PUSCH, and (4) a separate DL TCI state for PDCCH and PDSCH or a separate UL TCI state for PUCCH and PUSCH and/or their corresponding/associated TCI state ID(s).

That is, for N=2, when/if the UE is provided by the network, e.g., via higher layer RRC signaling, the set q00 of BFD RSs (e.g., a set of periodic CSI-RS resource configuration indexes or SSB indexes provided by failureDetectionSet1) and the set q01 of BFD RSs (e.g., a set of periodic CSI-RS resource configuration indexes or SSB indexes provided by failureDetectionSet2), the UE could assess the radio link quality according to the set q00, of resource configurations, against the BFD threshold Qout, and the radio link quality according to the set q01, of resource configurations, against the BFD threshold Qout.

Specifically, as described herein, for the set q00, the UE could assess the radio link quality only according to SSB(s) or periodic CSI-RS resource configuration(s) indicated by the first indicated common/unified joint TCI state (provided by DLorJointTCIState), the first indicated separate DL TCI state (provided by DLorJointTCIState) or the first indicated separate UL TCI state (provided by UL-TCIState) that are quasi co-located with the DM-RS of PDCCH receptions associated with the set q00. Or equivalently, the UE could assess the radio link quality of one or more of the BFD RSs or BFD RS resource configuration indexes in the set q00 that have the same values as the RS indexes in the RS sets indicated by the first indicated common/unified joint TCI state (provided by DLorJointTCIState), the first indicated separate DL TCI state (provided by DLorJointTCIState) or the first indicated separate UL TCI state (provided by UL-TCIState).

Furthermore, for the set q01, the UE could assess the radio link quality only according to SSB(s) or periodic CSI-RS resource configuration(s) indicated by the second indicated common/unified joint TCI state (provided by DLorJointTCIState), the second indicated separate DL TCI state (provided by DLorJointTCIState) or the second indicated separate UL TCI state (provided by UL-TCIState) that are quasi co-located with the DM-RS of PDCCH receptions associated with the set q01. Or equivalently, the UE could assess the radio link quality of one or more of the BFD RSs or BFD RS resource configuration indexes in the set q01 that have the same values as the RS indexes in the RS sets indicated by the second indicated common/unified joint TCI state (provided by DLorJointTCIState), the second indicated separate DL TCI state (provided by DLorJointTCIState) or the second indicated separate UL TCI state (provided by UL-TCIState).

For DCI based beam indication, the first and/or second indicate common/unified joint/DL/UL TCI states could be indicated by one or more TCI codepoints in one or more TCI fields in the beam indication DCI (format 1_1 or 1_2 with or without DL assignment). The first BFD RS set, the second BFD RS set, the first indicated TCI state, and/or the second indicated TCI state could be defined/specified following those described herein. Furthermore, the design examples described herein can be extended/applied to cases with N≥2.

In another example, the UE could receive from the network a MAC CE activation command/bitmap to activate/update N_bfd≥1 BFD RS resources from the higher layer RRC configured Ntot BFD RS resources in the BFD RS set n to monitor the link quality or detect potential beam failure for the corresponding CORESET(s)/PDCCH(s). For instance, the MAC CE activation command/bitmap could contain/comprise Ntot entries/bit positions with each entry/bit position in the bitmap corresponding to an entry in the RRC configured BFD RS set n comprising Ntot BFD RS resources. If an entry/bit position in the bitmap is enabled, e.g., set to “1,” the corresponding entry in the RRC configured BFD RS set n is activated as a BFD RS resource for monitoring the link quality or detecting potential beam failure of the corresponding CORESET(s)/PDCCH(s). Here, n∈{1, . . . , N}.

For N=2, the UE could receive from the network a MAC CE command/bitmap, e.g., a BFD-RS indication MAC CE, to activate/update/indicate N_bfd≥1 (e.g., N_bfd=1 or N_bfd=2) BFD RSs or BFD RS resource configurations in the BFD RS set q00 from the higher layer RRC configured Ntot≥1 (e.g., Ntot=64) BFD RSs or BFD RS resource configurations, e.g., provided by failureDetectionSet1, and/or N_bfd≥1 (e.g., N_bfd=1 or N_bfd=2) BFD RSs or BFD RS resource configurations in the BFD RS set q01 from the higher layer RRC configured Ntot≥1 (e.g., Ntot=64) BFD RSs or BFD RS resource configurations, e.g., provided by failureDetectionSet2; for this case, the UE could assess the radio link quality of the BFD RS set q00 according to one or more of the N_bfd BFD RSs in the set q00, and/or the radio link quality of the BFD RS set q01 according to one or more of the N_bfd BFD RSs in the set q01.

For example, the MAC CE command/bitmap could contain/comprise/include/provide/configure/indicate Ntot entries/bit positions for q00 (q01) with each entry/bit position in the bitmap corresponding to an entry in the RRC configured set of Ntot candidate BFD RS resources for q00 (q01). If an entry/bit position in the bitmap for q00 (q01) is enabled, e.g., set to ‘1’, the corresponding entry in the RRC configured set of Ntot candidate BFD RS resources is activated as a BFD RS resource in the set q00 (q01) for monitoring the link quality or detecting potential beam failure of the corresponding CORESET(s)/PDCCH(s) associated to q00 (q01). For another example, the MAC CE command could include/contain/comprise/provide/configure/indicate at least N_bfd entries/fields for q00 (q01) with each entry/field indicating/providing a BFD RS or BFD RS resource configuration index/ID in the set q00 (q01); the indicated/provided BFD RS(s) or BFD RS resource configuration index(es)/ID(s)—by the MAC CE command—could be from the higher layer RRC configured set of Ntot BFD RSs or BFD RS resource configurations for the set q00 (q01).

One or more of the N_bfd entries/fields in the MAC CE command for q00 (or q01) could be enabled/present or disabled/absent via a one-bit flag indicator/field. The UE could assess the radio link quality according to the set q00 (or q01), of resource configurations, against the BFD threshold Qout. Specifically, for the set q00, the UE could assess the radio link quality only according to SSB(s) or periodic CSI-RS resource configuration(s) indicated by the first indicated common/unified joint TCI state (provided by DLorJointTCIState), the first indicated separate DL TCI state (provided by DLorJointTCIState) or the first indicated separate UL TCI state (provided by UL-TCIState) that are quasi co-located with the DM-RS of PDCCH receptions associated with the set q00. Or equivalently, the UE could assess the radio link quality of one or more of the BFD RSs or BFD RS resource configuration indexes in the set q00 that have the same values as the RS indexes in the RS sets indicated by the first indicated common/unified joint TCI state (provided by DLorJointTCIState), the first indicated separate DL TCI state (provided by DLorJointTCIState) or the first indicated separate UL TCI state (provided by UL-TCIState).

Furthermore, for the set q01, the UE could assess the radio link quality only according to SSB(s) or periodic CSI-RS resource configuration(s) indicated by the second indicated common/unified joint TCI state (provided by DLorJointTCIState), the second indicated separate DL TCI state (provided by DLorJointTCIState) or the second indicated separate UL TCI state (provided by UL-TCIState) that are quasi co-located with the DM-RS of PDCCH receptions associated with the set q01. Or equivalently, the UE could assess the radio link quality of one or more of the BFD RSs or BFD RS resource configuration indexes in the set q01 that have the same values as the RS indexes in the RS sets indicated by the second indicated common/unified joint TCI state (provided by DLorJointTCIState), the second indicated separate DL TCI state (provided by DLorJointTCIState) or the second indicated separate UL TCI state (provided by UL-TCIState). For DCI based beam indication, the first and/or second indicate common/unified joint/DL/UL TCI states could be indicated by one or more TCI codepoints in one or more TCI fields in the beam indication DCI (format 1_1 or 1_2 with or without DL assignment). The first BFD RS set, the second BFD RS set, the first indicated TCI state, and/or the second indicated TCI state could be defined/specified following those described herein. Furthermore, the design examples described herein can be extended/applied to cases with N≥2.

In yet another example, for the MAC CE based common beam indication strategy as illustrated in FIG. 11, one or more BFD RS resource indexes, e.g., in/from the higher layer RRC configured BFD RS set n comprising Ntot BFD RS resources, could be included/indicated/comprised in the MAC CE for common beam indication. In this case, the UE is expected to only measure one or more BFD RSs in the BFD RS set n to monitor the link quality or detect potential beam failure for one or more CORESETs/PDCCHs if the one or more BFD RS resources in the BFD RS set n and the TCI state n for the one or more CORESETs/PDCCHs are indicated in the same MAC CE for common beam indication. As mentioned herein, the indicated TCI state n for the CORESET(s)/PDCCH(s) could be: (1) a DL TCI state and/or its corresponding/associated TCI state ID for both PDCCH and PDSCH, (2) an UL TCI state and/or its corresponding/associated TCI state ID for both PUCCH and PUSCH, (3) a joint DL and UL TCI state and/or its corresponding/associated TCI state ID for all DL and UL channels such as PDCCH, PDSCH, PUCCH and PUSCH, and (4) a separate DL TCI state for PDCCH and PDSCH or a separate UL TCI state for PUCCH and PUSCH and/or their corresponding/associated TCI state ID(s). Here, n∈{1, . . . , N}.

For N=2, the beam indication/activation MAC CE, e.g., unified TCI states activation/deactivation MAC CE, could indicate/provide/configure/contain/include/comprise one or more BFD RSs or BFD RS resource configuration indexes/IDs in the set q00, wherein each BFD RS resource configuration index could correspond a SSB index or a periodic CSI-RS resource configuration index, e.g., determined/selected from the higher layer RRC configured set of Ntot BFD RSs or BFD RS resource configuration indexes provided by failureDetectionSet1, and one or more BFD RSs or BFD RS resource configuration indexes/IDs in the set q01, wherein each BFD RS resource configuration index could correspond a SSB index or a periodic CSI-RS resource configuration index, e.g., determined/selected from the higher layer RRC configured set of Ntot BFD RSs or BFD RS resource configuration indexes provided by failureDetectionSet2.

Alternatively, the beam indication/activation MAC CE, e.g., unified TCI states activation/deactivation MAC CE, could indicate/provide/configure/contain/include/comprise a first bitmap for q00 with each bit position in the first bitmap corresponding/associated to a BFD RS resource configuration index in the set of Ntot BFD RS resource configuration indexes for q00; for this case, when/if a bit position is set to ‘1’, the BFD RS resource configuration index in the set of Ntot BFD RS resource configuration indexes corresponding/associated to the bit position in the first bitmap could be determined as a BFD RS/BFD RS resource configuration in the set q00.

The beam indication/activation MAC CE, e.g., unified TCI states activation/deactivation MAC CE, could also indicate/provide/configure/contain/include/comprise a second bitmap for q01 with each bit position in the second bitmap corresponding/associated to a BFD RS resource configuration index in the set of Ntot BFD RS resource configuration indexes for q01; for this case, when/if a bit position is set to ‘1’, the BFD RS resource configuration index in the set of Ntot BFD RS resource configuration indexes corresponding/associated to the bit position in the second bitmap could be determined as a BFD RS/BFD RS resource configuration in the set q01. The UE could assess the radio link quality according to the set q00, of resource configurations, against the BFD threshold Qout. Specifically, for the set q00, the UE could assess the radio link quality only according to SSB(s) or periodic CSI-RS resource configuration(s) indicated by the first indicated common/unified joint TCI state (provided by DLorJointTCIState), the first indicated separate DL TCI state (provided by DLorJointTCIState) or the first indicated separate UL TCI state (provided by UL-TCIState) that are quasi co-located with the DM-RS of PDCCH receptions associated to the first BFD RS set q00, and for the set q01, the UE could assess the radio link quality only according to SSB(s) or periodic CSI-RS resource configuration(s) indicated by the second indicated common/unified joint TCI state (provided by DLorJointTCIState), the second indicated separate DL TCI state (provided by DLorJointTCIState) or the second indicated separate UL TCI state (provided by UL-TCIState) that are quasi co-located with the DM-RS of PDCCH receptions associated to the second BFD RS set q01, wherein the first and/or second joint/DL/UL unified TCI states could be indicated in the (same) beam indication/activation MAC CE as described/specified herein.

Or equivalently, the UE could assess the radio link quality of one or more of the BFD RSs or BFD RS resource configuration indexes in the set q00 that have the same values as the RS indexes in the RS sets indicated by the first indicated common/unified joint TCI state (provided by DLorJointTCIState), the first indicated separate DL TCI state (provided by DLorJointTCIState) or the first indicated separate UL TCI state (provided by UL-TCIState), and the UE could assess the radio link quality of one or more of the BFD RSs or BFD RS resource configuration indexes in the set q01 that have the same values as the RS indexes in the RS sets indicated by the second indicated common/unified joint TCI state (provided by DLorJointTCIState), the second indicated separate DL TCI state (provided by DLorJointTCIState) or the second indicated separate UL TCI state (provided by UL-TCIState), wherein the first and/or second indicated joint/DL/UL unified TCI states could be indicated in the (same) beam indication/activation MAC CE as described/specified herein. The first BFD RS set, the second BFD RS set, the first indicated TCI state, and/or the second indicated TCI state could be defined/specified following those described herein. Furthermore, the design examples described herein can be extended/applied to cases with N≥2.

In yet another example, for the DCI based common beam indication strategy as illustrated in FIG. 14 (without MAC CE activation) and FIG. 15 (with MAC CE activation), one or more BFD RS indexes, e.g., in/from the higher layer RRC configured BFD RS set n comprising Ntot BFD RS resources, could be included/indicated/comprised in the DCI for common beam indication. That is, the beam indication DCI, e.g., DCI format 1_1 or 1_2 with or without DL PDSCH assignment/scheduling, that indicates one or more, e.g., N≥1 or M≥1 (e.g., N=2 or M=2), TCI states or pairs of TCI states via one or more TCI codepoints in one or more TCI fields, could indicate/provide/configure/contain/include/comprise the BFD RS set q00 of one or more BFD RSs or BFD RS resource configuration indexes/IDs, and/or the BFD RS set q01 of one or more BFD RSs or BFD RS resource configuration indexes/IDs, wherein each BFD RS resource configuration index could correspond to a SSB index or a periodic CSI-RS resource configuration index, e.g., determined/selected from the higher layer RRC configured set(s) of Ntot BFD RSs or BFD RS resource configuration indexes provided by failureDetectionSet1 and/or failureDetectionSet2.

For example, one or more new/dedicated DCI fields could be introduced in a DCI format, e.g., the beam indication DCI 1_1/1_2 with or without DL assignment or DCI format 0_1/0_2, to indicate/provide the set q00 of one or more BFD RS resource configuration indexes and/or the set q01 of one or more BFD RS resource configuration indexes, wherein the one or more BFD RS resource configuration indexes in each BFD RS set (q00 and/or q01) could correspond to SSB index(es) or periodic CSI-RS resource configuration index(es), e.g., determined/selected from the higher layer RRC configured set(s) of Ntot BFD RSs or BFD RS resource configuration indexes provided by respective higher layer parameter(s) failureDetectionSet1 and/or failureDetectionSet2.

For another example, one or more field bits/codepoints of one or more reserved/existing DCI fields in a DCI format, e.g., the beam indication DCI 1_1/1_2 with or without DL assignment or DCI format 0_1/0_2, could be used/repurposed to indicate/provide the set q00 of one or more BFD RS resource configuration indexes and/or the set q01 of one or more BFD RS resource configuration indexes, wherein the one or more BFD RS resource configuration indexes in each BFD RS set (q00 and/or q01) could correspond to SSB index(es) or periodic CSI-RS resource configuration index(es), e.g., determined/selected from the higher layer RRC configured set(s) of Ntot BFD RSs or BFD RS resource configuration indexes provided by respective higher layer parameter(s) failureDetectionSet1 and/or failureDetectionSet2. In this case, the UE is expected to only measure one or more BFD RSs configured in the BFD RS set n to monitor the link quality or detect potential beam failure for one or more CORESETs/PDCCHs associated to the BFD RS set n if the one or more BFD RS resources in the BFD RS set n and the TCI state n for the one or more CORESETs/PDCCHs are indicated in the same DCI for common beam indication (with or without MAC CE activation), where n∈{1, . . . , N}.

Yet for another example, one or more BFD RS resource indexes, e.g., in/from the higher layer RRC configured BFD RS set n comprising Ntot BFD RS resources, could be indicated/included/comprised in the common TCI state n, e.g., in the corresponding higher layer parameter TCI-State, DLorJointTCIState, ULTCI-State or QCL-Info. That is, the higher layer parameter TCI-State, DLorJointTCIState, ULTCI-State or QCL-Info could indicate/provide one or more BFD RS resource configuration indexes, wherein the one or more BFD RSs/BFD RS resource configuration indexes could be included in the set q00 and/or q01, and the one or more BFD RS resource configuration indexes could correspond to SSB index(es) or periodic CSI-RS resource configuration index(es), e.g., determined/selected from the higher layer RRC configured set(s) of Ntot BFD RSs or BFD RS resource configuration indexes provided by failureDetectionSet1 and/or failureDetectionSet2.

The illustrative example of indicating the BFD RS resource index(es) in the higher layer parameter TCI-State is presented in TABLE 1, and an illustrative example of indicating the BFD RS resource index(es) in the higher layer parameter QCL-Info is presented in TABLE 2 in this disclosure. Note that indicating/providing the BFD RS resource configuration index(es) of the set q00 and/or q01 in DLorJointTCIState or ULTCI-State could have the same/similar signaling structure(s) as those specified in TABLE 1 or TABLE 2. In this case, the UE is expected to only measure one or more BFD RSs in the BFD RS set n to monitor the link quality or detect potential beam failure for one or more CORESETs/PDCCHs if the one or more BFD RS resources configured in the BFD RS set n are indicated in the unified TCI state n for the one or more CORESETs/PDCCHs, where n∈{1, . . . , N}.

As discussed/described herein, the indicated TCI state n (n E {1, . . . , N}) for the CORESET(s)/PDCCH(s) could be: (1) a DL TCI state and/or its corresponding/associated TCI state ID for both PDCCH and PDSCH, (2) an UL TCI state and/or its corresponding/associated TCI state ID for both PUCCH and PUSCH, (3) a joint DL and UL TCI state and/or its corresponding/associated TCI state ID for all DL and UL channels such as PDCCH, PDSCH, PUCCH and PUSCH, and (4) a separate DL TCI state for PDCCH and PDSCH or a separate UL TCI state for PUCCH and PUSCH and/or their corresponding/associated TCI state ID(s).

For one or more of the design examples described/specified herein, the UE could assess the radio link quality according to the set q00 and/or q01, of resource configurations, against the BFD threshold Qout. Specifically, for the set q00, the UE could assess the radio link quality only according to SSB(s) or periodic CSI-RS resource configuration(s) indicated by the first indicated common/unified joint TCI state (provided by DLorJointTCIState), the first indicated separate DL TCI state (provided by DLorJointTCIState) or the first indicated separate UL TCI state (provided by UL-TCIState) that are quasi co-located with the DM-RS of PDCCH receptions associated to the BFD RS set q00, wherein the first joint/DL/UL unified TCI state could be indicated in the (same) beam indication DCI (e.g., DCI format 1_1 or 1_2 with or without DL assignment as described/specified herein). Or equivalently, the UE could assess the radio link quality of one or more of the BFD RSs or BFD RS resource configuration indexes in the set q00 that have the same values as the RS indexes in the RS sets indicated by the first indicated common/unified joint TCI state (provided by DLorJointTCIState), the first indicated separate DL TCI state (provided by DLorJointTCIState) or the first indicated separate UL TCI state (provided by UL-TCIState), wherein the first joint/DL/UL unified TCI state could be indicated in the (same) beam indication DCI (e.g., DCI format 1_1 or 1_2 with or without DL assignment as described/specified herein).

For the set q01, the UE could assess the radio link quality only according to SSB(s) or periodic CSI-RS resource configuration(s) indicated by the second indicated common/unified joint TCI state (provided by DLorJointTCIState), the second indicated separate DL TCI state (provided by DLorJointTCIState) or the second indicated separate UL TCI state (provided by UL-TCIState) that are quasi co-located with the DM-RS of PDCCH receptions associated to the BFD RS set q01, wherein the second joint/DL/UL unified TCI state could be indicated in the (same) beam indication DCI (e.g., DCI format 1_1 or 1_2 with or without DL assignment as described/specified herein).

Or equivalently, the UE could assess the radio link quality of one or more of the BFD RSs or BFD RS resource configuration indexes in the set q01 that have the same values as the RS indexes in the RS sets indicated by the second indicated common/unified joint TCI state (provided by DLorJointTCIState), the second indicated separate DL TCI state (provided by DLorJointTCIState) or the second indicated separate UL TCI state (provided by UL-TCIState), wherein the second joint/DL/UL unified TCI state could be indicated in the (same) beam indication DCI (e.g., DCI format 1_1 or 1_2 with or without DL assignment as described/specified herein).

In yet another example, the beam indication DCI, e.g., DCI format 1_1 or 1_2 with or without DL PDSCH assignment/scheduling, that indicates one or more, e.g., N≥1 or M≥1 (e.g., N=2 or M=2), TCI states or pairs of TCI states via one or more TCI codepoints in one or more TCI fields, could indicate/provide/configure/contain/include/comprise one or more, e.g., N≥1 or M≥1 (e.g., N=2 or M=2), bitmaps each associated to an indicated TCI state/pair of TCI states, and therefore, a BFD RS set. For N=2 (M=2), each bit position in a first bitmap associated to the set q00 could be associated to a BFD RS resource configuration index in the set of Ntot BFD RS resource configuration indexes for the set q00 (e.g., provided by failureDetectionSet1); for this case, when/if a bit position in the first bitmap is set to ‘1’, the BFD RS resource configuration index in the set of Ntot BFD RS resource configuration indexes associated with q00 corresponding/associated to the bit position could be determined as a BFD RS/BFD RS resource configuration in the set q00.

Furthermore, each bit position in a second bitmap associated to the set q01 could be associated to a BFD RS resource configuration index in the set of Ntot BFD RS resource configuration indexes for the set q01 (e.g., provided by failureDetectionSet2); for this case, when/if a bit position in the second bitmap is set to ‘1’, the BFD RS resource configuration index in the set of Ntot BFD RS resource configuration indexes associated with q01 corresponding/associated to the bit position could be determined as a BFD RS/BFD RS resource configuration in the set q01.

For example, one or more new/dedicated DCI fields could be introduced in a DCI format, e.g., the beam indication DCI 1_1/1_2 with or without DL assignment or DCI format 0_1/0_2, to indicate/provide the one or more, e.g., the first and second, bitmaps.

For another example, one or more field bits/codepoints of one or more reserved/existing DCI fields in a DCI format, e.g., the beam indication DCI 1_1/1_2 with or without DL assignment or DCI format 0_1/0_2, could be used/repurposed to indicate/provide the one or more, e.g., the first and second, bitmaps.

Yet for another example, the higher layer parameter TCI-State, DLorJointTCIState, ULTCI-State or QCL-Info could indicate/provide the one or more, e.g., the first and second, bitmaps. Indicating/providing the one or more, e.g., the first and second, bitmaps in TCI-State, DLorJointTCIState, ULTCI-State or QCL-Info could have the same/similar signaling structure(s) as those specified in TABLE 1 or TABLE 2.

For one or more of the design examples described/specified therein, the UE could assess the radio link quality according to the set q00 and/or q01, of resource configurations, against the BFD threshold Qout. Specifically, for the set q00, the UE could assess the radio link quality only according to SSB(s) or periodic CSI-RS resource configuration(s) indicated by the first indicated common/unified joint TCI state (provided by DLorJointTCIState), the first indicated separate DL TCI state (provided by DLorJointTCIState) or the first indicated separate UL TCI state (provided by UL-TCIState) that are quasi co-located with the DM-RS of PDCCH receptions associated to the BFD RS set q00, wherein the first joint/DL/UL unified TCI state could be indicated in the (same) beam indication DCI (e.g., DCI format 1_1 or 1_2 with or without DL assignment as described/specified herein).

Or equivalently, the UE could assess the radio link quality of one or more of the BFD RSs or BFD RS resource configuration indexes in the set q00 that have the same values as the RS indexes in the RS sets indicated by the first indicated common/unified joint TCI state (provided by DLorJointTCIState), the first indicated separate DL TCI state (provided by DLorJointTCIState) or the first indicated separate UL TCI state (provided by UL-TCIState), wherein the first joint/DL/UL unified TCI state could be indicated in the (same) beam indication DCI (e.g., DCI format 1_1 or 1_2 with or without DL assignment as described/specified herein). For the set q01, the UE could assess the radio link quality only according to SSB(s) or periodic CSI-RS resource configuration(s) indicated by the second indicated common/unified joint TCI state (provided by DLorJointTCIState), the second indicated separate DL TCI state (provided by DLorJointTCIState) or the second indicated separate UL TCI state (provided by UL-TCIState) that are quasi co-located with the DM-RS of PDCCH receptions associated to the BFD RS set q01, wherein the second joint/DL/UL unified TCI state could be indicated in the (same) beam indication DCI (e.g., DCI format 1_1 or 1_2 with or without DL assignment as described/specified herein).

Or equivalently, the UE could assess the radio link quality of one or more of the BFD RSs or BFD RS resource configuration indexes in the set q01 that have the same values as the RS indexes in the RS sets indicated by the second indicated common/unified joint TCI state (provided by DLorJointTCIState), the second indicated separate DL TCI state (provided by DLorJointTCIState) or the second indicated separate UL TCI state (provided by UL-TCIState), wherein the second joint/DL/UL unified TCI state could be indicated in the (same) beam indication DCI (e.g., DCI format 1_1 or 1_2 with or without DL assignment as described/specified herein).

In yet another example, a UE could be indicated/provided/configured by the network, e.g., in beam indication/activation MAC CE or beam indication DCI (e.g., DCI format 1_1/1_2 with or without DL assignment) as described/specified herein, one or more, e.g., N≥1 or M≥1 (e.g., N=2 or M=2), TCI states or pairs of TCI states. Each indicated TCI state/pair of TCI states could be for UE-dedicated PDCCH/PDSCH, dynamic-grant/configured-grant based PUSCH and all of dedicated PUCCH resources, one or more SRSs, or one or more CSI-RSs—corresponding to periodic/semi-persistent/aperiodic CSI-RS(s) in a resource set, that are associated to the corresponding TRP (e.g., via the association between the indicated TCI states/pairs of TCI states and the TRP-specific index/ID values described/specified herein, or via the association between the indicated TCI states/pairs of TCI states and the BFD RS sets described/specified herein).

Or equivalently, the reception(s) of one or more CSI-RSs such as periodic/semi-persistent/aperiodic CSI-RS(s) in a resource set associated to a TRP could follow (or could be higher layer configured by the network to follow) the QCL assumption(s)/parameter(s) indicated/provided in a common/unified joint/DL/UL TCI state/beam indicated for UE-dedicated PDCCH/PDSCH or dynamic-grant/configured-grant based PUSCH and all of dedicated PUCCH resources associated to the same TRP. For N=2 (or M=2), the UE could use/configure/determine the one or more first CSI-RSs or first CSI-RS resource configuration indexes associated to a first TRP as the BFD RS(s)/BFD RS resource configuration index(es) in the first BFD RS set q00, and the one or more second CSI-RSs or second CSI-RS resource configuration indexes associated to a second TRP as the BFD RS(s)/BFD RS resource configuration index(es) in the second BFD RS set q01. In this case, a BFD RS or BFD RS resource configuration in the set q00 (or q01) could share the same common/unified TCI state/beam indicated for UE-dedicated PDCCH/PDSCH or dynamic-grant/configured-grant based PUSCH and all of dedicated PUCCH resources associated to the first (or second) TRP.

In one example, if the UE is not configured by the network any BFD RS sets, the UE could implicitly determine/configure the BFD RS resource(s) following the design examples herein discussed herein under the unified TCI framework. Alternatively, the UE could be indicated by the network to implicitly determine/configure the BFD RS resource(s) following the design examples herein regardless whether the UE is configured by the network N≥1 BFD RS sets or not; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

That is, if the UE is not provided/indicated/configured by the network any BFD RS resource(s) or BFD RS resource configuration index(es) in the set q00 and/or q01 following the design examples specified/described in the present disclosure, the UE could implicitly determine/configure the BFD RS resource(s) or BFD RS resource configuration index(es) in the set q00 and/or q01 following the design examples provided herein under the unified TCI framework. Alternatively, the UE could be indicated by the network to implicitly determine/configure the BFD RS resource(s) or BFD RS resource configuration index(es) in the set q00 and/or q01 following the design examples specified/discussed in the present disclosure regardless whether or not the UE is configured/indicated/provided by the network BFD RS resource(s)/BFD RS resource configuration index(es) in the set q00 and/or q01; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

Optionally, when/if the QCL source RS(s) or RS resource configuration(s) indicated in the first and/or second indicated common/unified joint/DL/UL TCI state is aperiodic CSI-RS(s) or aperiodic CSI-RS resource configuration(s), the UE could implicitly determine/configure the BFD RS resource(s) or BFD RS resource configuration index(es) in the set q00 and/or q01 following the design examples provided herein under the unified TCI framework.

In another example, the UE is configured by the network N≥1 BFD RS sets each comprising at least one BFD RS resource to monitor the link quality or detect potential beam failure for one or more CORESETs/PDCCHs. The UE could follow the design examples herein to determine/configure the BFD RS resource(s) in the BFD RS set n (n∈{1, . . . , N}) if at least one of the following is met/achieved/satisfied: (1) the UE could be indicated by the network to determine/configure the BFD RS resource(s) in the BFD RS set n following the design examples herein; this indication could be via higher layer (RRC) or/and MAC CE or/and DCI based signaling or/and any combination of at least two of RRC, MAC CE and DCI based signaling; this indication could be via a separate (dedicated) parameter or joint with another parameter; or (2) the QCL source RS(s) indicated in the common/unified TCI state n (for at least PDCCH) is aperiodic CSI-RS.

In yet another example, the UE could first use the BFD RSs higher layer configured in the N≥1 BFD RS sets to monitor the link quality or detect potential beam failure for one or more CORESETs/PDCCHs. If the UE receives from the network a DCI for common beam indication (with or without MAC CE activation as illustrated in FIG. 14 or FIG. 15) to indicate/update the TCI state n for the CORESET(s)/PDCCH(s), the UE could follow at least one of the following to determine/configure the BFD RS resource(s) in the BFD RS set n, where n∈{1, . . . , N}: (1) the UE could follow the design examples herein to implicitly determine/configure the BFD RS(s) in the BFD RS set n as the QCL source RS(s) indicated in the common/unified TCI state n (for at least PDCCH); here, the common/unified TCI state is indicated via the DCI for common beam indication, and n∈{1, . . . , N}; (2) the UE could follow the design examples discussed herein to determine/configure the BFD RS(s) in the BFD RS set n for the corresponding CORESET(s)/PDCCH(s) associated with the BFD RS set n, where n∈{1, . . . , N}; or (3) the UE could follow the design examples discussed herein to determine/configure the BFD RS(s) in the BFD RS set n for the corresponding CORESET(s)/PDCCH(s) associated with the BFD RS set n, where n∈{1, . . . , N}.

In yet another example, the UE could be configured/indicated/provided by the network, e.g., in higher layer RRC signaling/parameter (e.g., provided by failureDetectionSet and/or failureDetectionSet2) and/or MAC CE command (e.g., a BFD-RS indication MAC CE), one or more BFD RSs or BFD RS resource configuration indexes in the set q00 and/or q01, wherein each BFD RS resource configuration index could correspond to a SSB index or a CSI-RS resource configuration index. Furthermore, the UE could assess the radio link quality of one or more of the RRC/MAC CE indicated/configured/provided BFD RSs in the set q00 and/or q01 following those specified in design examples provided herein.

When/if the UE is indicated by the network, e.g., in a beam indication/activation MAC CE or beam indication DCI (e.g., DCI format 1_1/1_2 with or without DL assignment), one or more unified/common joint/DL/UL TCI states different from previously indicated ones, the UE could determine the BFD RS(s) in the set q00 and/or q01 and assess the radio link quality of q00 and/or q01 according to one or more of the followings: (1) the UE could follow those specified in the design examples provided in the present disclosure to determine the BFD RS(s) in the set q00 and/or q01 and assess the radio link quality of q00 and/or q01; or (2) the UE could follow those specified in the design examples provided in the present disclosure to determine the BFD RS(s) in the set q00 and/or q01 and assess the radio link quality of q00 and/or q01.

In yet another example, if the UE receives from the network a MAC CE for common beam indication (as illustrated in FIG. 11), the UE could follow at least one of the following to determine/configure the BFD RS resource(s) in the BFD RS set n (n∈{1, . . . , N}): (1) the UE could use the one or more BFD RSs higher layer configured in the BFD RS set n to monitor the link quality or detect potential beam failure for one or more CORESETs/PDCCHs associated with the BFD RS set n, where n∈{1, . . . , N}; (2) the UE could follow the design examples herein to implicitly determine/configure the BFD RS(s) in the BFD RS set n as the QCL source RS(s) indicated in the common/unified TCI state n (for at least PDCCH); here, the common/unified TCI state n is indicated via the MAC CE for common beam indication, and n∈{1, . . . , N}; or (3) the UE could follow the design examples discussed herein to determine/configure the BFD RS(s) in the BFD RS set n for the corresponding CORESET(s)/PDCCH(s) associated with the BFD RS set n, where n∈{1, . . . , N}.

In yet another example, the physical layer of the UE could assess the radio link quality of one or more of the BFD RS(s) in the BFD RS set q00 and/or q01, and inform higher layers when the radio link quality is worse than a BFD threshold Qout. As discussed herein, the configuration/determination of the BFD RS(s) in the BFD RS set q00 and/or q01 could follow those specified in the design examples provided in the present disclosure. The higher layers of the UE could maintain a first and a second beam failure instance (BFI) counters. If the higher layers in the UE are informed that the radio link quality for the BFD RS set q00 and/or q01 is worse than the BFD threshold Qout, the higher layers in the UE could increment the BFI count for the BFD RS set q00 (e.g., provided by the higher layer parameter BFI_COUNTER_0) by one and/or the BFI count for the BFD RS set q00 (e.g., provided by the higher layer parameter BFI_COUNTER_1) by one. The UE could declare a beam failure for the BFD RS set q00 and/or q01 if the BFI count for the BFD RS set q00 and/or q01 reaches the maximum number of BFI counts (e.g., provided by the higher layer parameter maxBFIcount) before a first and/or a second BFD timer associated to q00 and/or q01 expires.

The higher layers in the UE would reset the BFI count for q00 and/or q01 to zero if at least one of the following occurs: (1) the BFD timer for q00 and/or q01 expires before the BFI count for q00 and/or q01 reaches the maximum number of BFI counts; or (2) the UE receives from the network one or more common/unified joint/DL/UL TCI states/beams update for UE-dedicated PDCCH/PDSCH or dynamic-grant/configured-grant based PUSCH and all of dedicated PUCCH resources. The common/unified joint/DL/UL TCI states/beams update can be indicated via beam indication/activation MAC CE or beam indication DCI (with or without downlink assignment and with or without MAC CE activation) as specified/described above, and different from the previously indicated common/unified joint/DL/UL TCI states/beams.

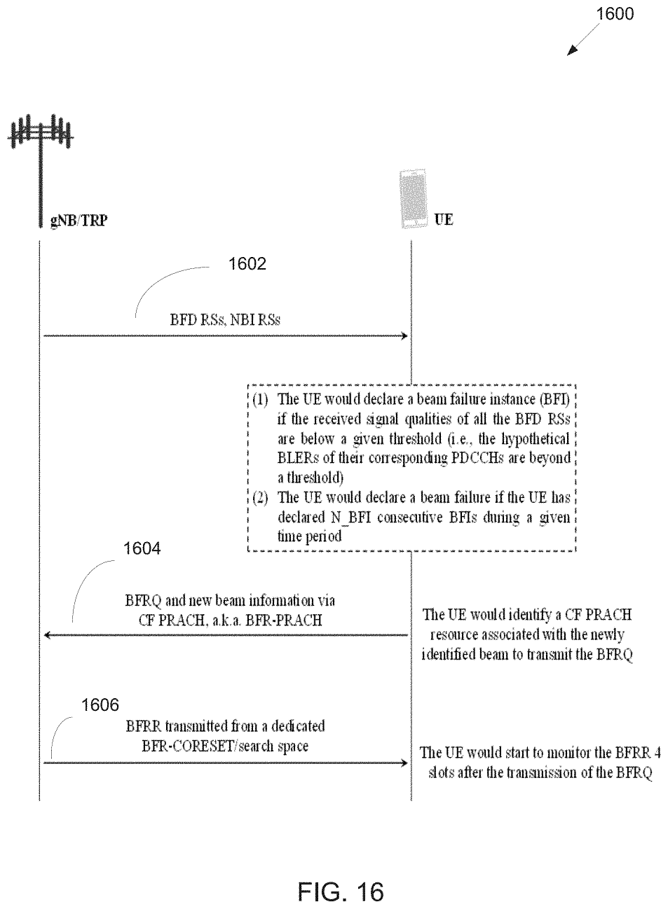

FIG. 16 illustrates a signaling flow of beam failure recovery procedures 1600 according to embodiments of the present disclosure. The beam failure recovery procedures 1600 as may be performed by a UE (e.g., 111-116 as illustrated in FIG. 1) and a BS (e.g., 101-103 as illustrated in FIG. 1). An embodiment of the beam failure recovery procedures 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As shown in FIG. 16, at step 1602, the gNB/TRP sends BFD RSs and NBI RSs to the UE. After receiving the BFD RSs and NBI RSs from the gNB, the UE may declare a BFI if the received signal qualities of all the BFD RSs are below a given threshold. The UE may further declare a beam failure if the UE has declared N_BFI consecutive BFIs during a given time period.

As step 1604, the UE sends the BFRQ and new beam information via CF PRACH (e.g., BFR-PRACH) to the gNB. When the UE sends the BFRQ, the UE may identify a CF PRACH resource associated with the newly identified beam to transmit the BFRQ.

At step 1606, the gNB/TRP sends the BFRR transmitted from a dedicated BFR-CORESET/search space. When the UE receives the BFRR, the UE may start to monitor the BFRR 4 slots after the transmission of the BFRQ.

As can be seen from FIG. 16, the UE is first configured by the gNB with a set of BFD RS resources to monitor the link qualities between the gNB and the UE. One BFD RS resource could correspond to one (periodic) CSI-RS/SSB resource configured as a QCL-typeD (spatial quasi-co-location) RS in a TCI state of a CORESET. If the received signal qualities of all the BFD RS resources are below a given threshold (implying that the hypothetical BLERs of the corresponding CORESETs/PDCCHs are above a given threshold), the UE could declare a beam failure instance (BFI). Further, if the UE has declared a predefined number of consecutive BFIs within a given time period, the UE may declare a beam failure.

After declaring/detecting the beam failure, the UE may transmit the BFRQ to the gNB via a contention-free (CF) PRACH (CF BFR-PRACH) resource, whose index is associated with a new beam identified by the UE. Specifically, to determine a potential new beam, the UE could be first configured by the network with a set of SSB and/or CSI-RS resources (NBI RS resources), e.g., through the higher layer parameter candidateBeamRSList. The UE may then measure the NBI RSs and calculate their corresponding beam metrics such as L1-RSRPs. If at least one of the measured L1-RSRPs of the NBI RSs is beyond a given threshold, the UE may select the beam that corresponds to the NBI RS with the highest L1-RSRP as the new beam. To determine a CF BFR-PRACH resource to carry the BFRQ, the UE could be first configured by the network with a set of PRACH resources, each associated with a NBI RS resource. The UE could then select the PRACH resource that has the one-to-one correspondence to the selected NBI RS resource (the new beam) to send the BFRQ to the gNB. From the index of the selected CF PRACH resource, the gNB could know which beam is selected by the UE as the new beam.

Four slots after the UE has transmitted the BFRQ, the UE could start to monitor a dedicated CORESET/search space for BFRQ response. The dedicated CORESET is addressed to the UE-specific C-RNTI and may be transmitted by the gNB with the newly identified beam. If the UE detects a valid UE-specific DCI in the dedicated CORESET for BFRR, the UE may assume that the beam failure recovery request has been successfully received by the network, and the UE may complete the BFR process. Otherwise, if the UE does not receive the BFRR within a configured time window, the UE may initiate a contention-based random access (CBRA) process to reconnect to the network.

In the 3GPP Rel. 16, the BFR procedures were customized for the secondary cell (SCell) under the CA framework, in which the BPL(s) between the PCell and the UE is assumed to be always working. An illustrative example of the SCell beam failure is given in FIG. 9.

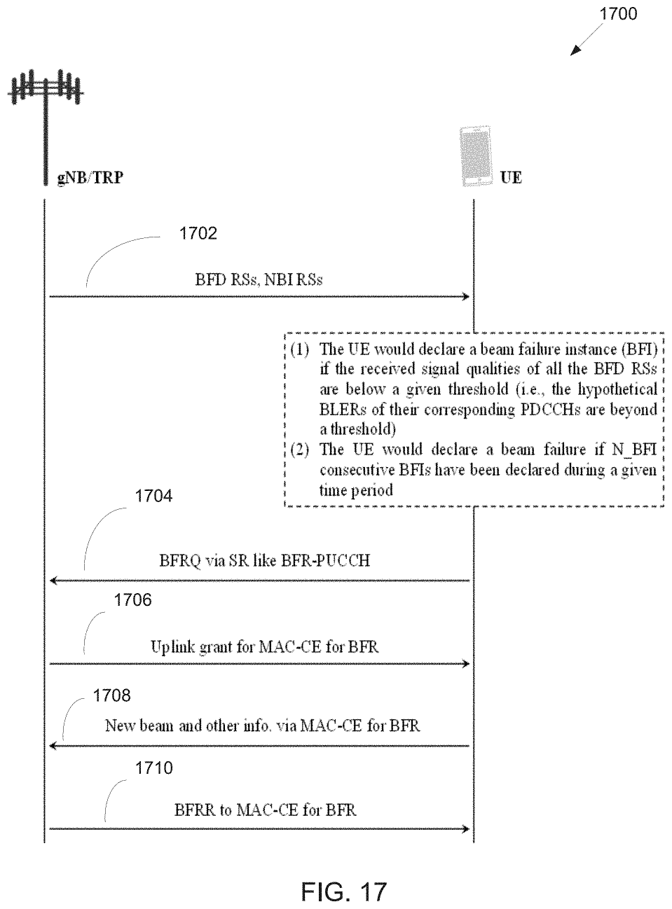

FIG. 17 illustrates a signaling flow of SCell beam failure recovery procedures 1700 according to embodiments of the present disclosure. The SCell beam failure recovery procedures 1700 as may be performed by a UE (e.g., 111-116 as illustrated in FIG. 1) and a BS (e.g., 101-103 as illustrated in FIG. 1). An embodiment of the SCell beam failure recovery procedures 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As shown in FIG. 17, the gNB/TRP sends the BFD RSs and NBI RSs to the UE. When the UE receives the BFD RSs and NBI RSs, the UE may declare a BFI if the received signal qualities of all the BFD RSs are below a given threshold (e.g., the hypothetical BLERs of their corresponding PDCCHs are beyond a threshold). The UE may further declare a beam failure if N_BFI consecutive BFIs have been declared during a given time period.

At step 1704, the UE sends the BFRQ via SR like BFR-PUCCH to the gNB/TRP. At step 1706, the gNB/TRP sends an uplink grant for MAC-CE for BFR. At step 1708, the UE sends beam and other information via the MAC-CE for BFR to the gNB/TRP. At step 1710, the gNB/TRP sends the BFRR to MAC-CE for BFR to the UE.

In FIG. 17, the key components of the Rel. 16 SCell BFR are presented. It is evident from FIG. 17 that prior to sending the BFRQ, the Rel. 15 and Rel. 16 BFR procedures have similar BFD settings/configurations.

After declaring/detecting the beam failure for the SCell, the UE may transmit the BFRQ as a scheduling request (SR) over the PUCCH (or PUCCH-SR) for the working PCell. Further, the UE may only transmit the BFRQ at this stage without any new beam index, failed SCell index or other information. This is different from the Rel. 15 procedure, in which the UE may indicate to the network both the BFRQ and the new beam index at the same time. Allowing the gNB to quickly know the beam failure status of the SCell without waiting for the UE to identify a new beam could be beneficial. For instance, the gNB could deactivate the failed SCell and allocate the resources to other working SCells.

The UE could be indicated by the network uplink grant in response to the BFRQ PUCCH-SR, which may allocate necessary resources for the MAC CE to carry new beam information (if identified), failed SCell index and etc. over the PUSCH for the working PCell. After transmitting the MAC CE for BFR to the working PCell, the UE may start to monitor the BFRR. The BFRR could be a TCI state indication for a CORESET from/associated with the corresponding SCell. The BFRR to the MAC CE for BFR could also be a normal uplink grant for scheduling a new transmission for the same HARQ process (with the same HARQ process ID) as the PUSCH carrying the MAC CE for BFR. If the UE could not receive the BFRR within a preconfigured time window, the UE could transmit the BFRQ PUCCH-SR again, or fall back to CBRA process.

The described BFR procedures herein for PCell and SCell may not be suited for a multi-TRP system, in which multiple TRPs could be geographically non-co-located, and one or more BFLs between the UE and the TRP(s) could fail. In this disclosure, a TRP can represent a collection of measurement antenna ports, measurement RS resources and/or control resource sets (CORESETs).

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; or (5) a plurality of CORESETs associated with a TRP-specific index/indicator/identity.

Furthermore, different TRPs could broadcast/be associated with different physical cell identities (PCIs) and one or more TRPs in the system could broadcast/be associated with different PCIs from that of serving cell/TRP.

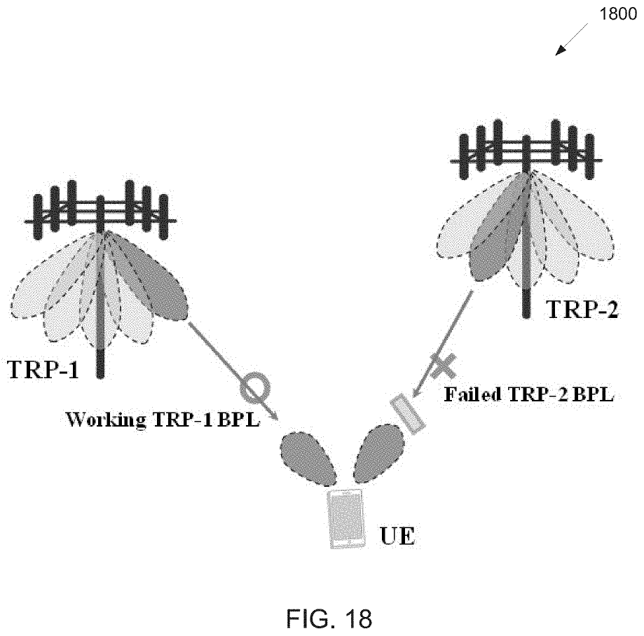

FIG. 18 illustrates an example of beam failure in a multi-TRP system 1800 according to embodiments of the present disclosure. An embodiment of the beam failure in the multi-TRP system 1800 shown in FIG. 18 is for illustration only.

In FIG. 18, a conceptual example of BPL failure in a multi-TRP system is presented. As can be seen from FIG. 18, two TRPs, TRP-1 and TRP-2, are simultaneously/jointly performing DL transmissions to the UE in either a coherent or a non-coherent fashion. As the two TRPs are not physically co-located, their channel conditions between the UE could be largely different from each other.

For instance, the BPL between one coordinating TRP (TRP-2 in FIG. 18) and the UE could fail due to blockage, while the BPL between the other coordinating TRP (TRP-1 in FIG. 18) and the UE could still work. According to the BFR procedures defined in the 3GPP Rel. 15 and Rel. 16, however, the UE may trigger or initiate the BFR only when the received signal qualities of all the configured BFD RSs fall below a threshold for a certain period of time. Hence, there is a need to customize the BFR procedures for the multi-TRP system (referred to as multi-TRP BFR and/or TRP-specific BFR and/or partial BFR in the present disclosure). For instance, the UE could initiate or trigger the BFR when the received signal qualities of the BFD RSs for at least one TRP fall below the threshold for a given period of time.

Furthermore, the UE could be configured by the network more than one sets of RSs (referred to as NBI RS sets in the present disclosure) to identify/determine candidate new beam(s) to recover the failed BPL(s) between the UE and the TRPs in the multi-TRP system. In this case, for CFRA based BFRQ transmission and CBRA based transmission/fall back, the association between one or more PRACH preambles or PRACH occasions and the NBI RS resources configured in the NBI RS sets needs to be specified for the multi-TRP BFR. In addition, UE's behavior(s) after receiving the BFRR needs to be specified as well for the multi-TRP BFR.

In the present disclosure, various design aspects related to NBI RSs/NBI RS sets configuration, PRACH preamble/occasion configuration/selection for CFRA based BFRQ transmission, PRACH preamble/occasion configuration/selection for CBRA based transmission/fall back, and UE's behavior(s) upon receiving the BFRR are specified for the multi-TRP BFR.

The UE could be configured/indicated by the network (e.g., via RRC or/and MAC CE or/and DCI based signaling) at least two BFD RS beam sets (S_q0≥2) each containing at least one (N_q0≥1) BFD RS. For instance, the UE could be configured by the network two BFD RS beam sets (S_q0=2) q0-0 and q0-1, e.g., via higher layer parameters failureDetectionResourcesToAddModList1 and failureDetectionResourcesToAddModList2, respectively. Each BFD RS beam set, i.e., q0-0 or q0-1 for S_q0=2, could contain/comprise/include one or more BFD RSs (N_q0≥1) corresponding to one or more periodic CSI-RS resource configuration indexes and/or SSB indexes configured via a higher layer parameter failureDetectionResources.

The UE could use/determine at least two BFD RS beam sets (G_q0≥2, q0-0 and q0-1 for G_q0=2) each containing/including at least one (M_q0≥1) BFD RS to monitor/detect potential beam failure(s). The BFD RS(s) included in the same BFD RS beam set could correspond to one or more periodic 1-port CSI-RS resource configuration indexes or SSB indexes indicated/configured as the QCL-typeD (i.e., spatial quasi-co-location) source RS(s) in the active TCI state(s) for PDCCH reception in one or more CORESETs.

The UE could measure one or more NBI RSs configured/included in one or more NBI RS beam sets. The physical layer in the UE could assess the radio link quality for one or more NBI RSs configured/included in one or more NBI RS beam sets against one or more BFR thresholds. A NBI RS resource could correspond to a SSB on the PCell or the PSCell or a periodic 1-port or 2-port CSI-RS resource configuration with frequency density equal to 1 or 3 REs per RB.

For the single-TRP operation, the UE could be explicitly configured by the network (e.g., via higher layer RRC signaling) a single list/set of NBI RSs, e.g., via higher layer parameter candidateBeamRSList or candidateBeamRSListExt or candidateBeamRSSCellList. In the present disclosure, the list/set of the NBI RSs can also be referred to as a NBI RS beam set denoted by q1. As mentioned herein, the NBI RSs in the NBI RS beam set q1 could correspond to periodic 1-port or 2-port CSI-RS resource configuration indexes (the corresponding resource configurations are with frequency density equal to 1 or 3 REs per RB) or SSB indexes or other types of SSBs/CSI-RSs. The UE may keep monitoring the radio link qualities of the NBI RSs in q1, and could identify at least one NBI RS (or equivalently, the corresponding CSI-RS resource configuration index or SSB index in q1) with corresponding L1-RSRP measurement(s) that is larger than or equal to a BFR threshold.

For the multi-TRP system, the UE could also be explicitly configured by the network (e.g., via higher layer RRC signaling) S_q1 (1<S_q1≤maxS_q1) NBI RS beam sets each containing N_q1 (1≤N_q1≤maxN_q1) NBI RS resources, where maxS_q1 is the maximum number of NBI RS beam sets (e.g., maxS_q1=2 per BWP), which could be indicated/configured by the network to the UE via RRC or/and MAC CE or/and DCI based signaling or autonomously determined by the UE and reported to the network as a UE capability/feature signaling or both, and maxN_q1 is the maximum number of NBI RS resources per NBI RS beam set (e.g., maxN_q1=2), which could be indicated/configured by the network to the UE via RRC or/and MAC CE or/and DCI based signaling or autonomously determined by the UE and reported to the network as a UE capability/feature signaling or both; the quantity N_q1 could be the same or different across the S_q1 NBI RS beam sets; each NBI RS resource index could correspond to a 1-port or 2-port CSI-RS resource configuration index or a SSB index or other types of SSB/CSI-RS. For instance, the UE could be configured/indicated by the network (e.g., via RRC or/and MAC CE or/and DCI based signaling) at least two NBI RS beam sets (S_q1≥2) each containing at least one (N_q1≥1) NBI RS resource.

Specifically, the UE could be configured by the network two NBI RS beam sets (S_q1=2) q1-0 and q1-1, e.g., provided by higher layer parameters candidateBeamRSList0 and candidateBeamRSList1, respectively. Each NBI RS beam set, i.e., q1-0 or q1-1 for S_q1=2, could contain/comprise/include one or more NBI RS resources (N_q1≥1) corresponding to one or more periodic CSI-RS resource configuration indexes and/or SSB indexes configured via a higher layer parameter candidateBeamResources.

In one example, a NBI RS resource index could correspond to a periodic CSI-RS resource configuration index or a SSB index configured/included in the corresponding NBI RS beam set. For instance, if a SSB index or a NZP CSI-RS resource index/ID configured/included in the NBI RS beam set k (e.g., k∈{1, . . . , S_q1}) is #A, the corresponding NBI RS resource index in set k is #A.

In another example, the index of a NBI RS resource in a NBI RS beam set k (e.g., k∈{1, . . . , S_q1}) comprising a total of N_q1 NBI RS resources corresponding to N_q1 periodic CSI-RS resource configuration indexes or SSB indexes could be any value in {0, 1, . . . , N_q1−1}. For another example, a NBI RS resource index is determined/counted based on/according to all the CSI-RS resource configuration indexes or SSB indexes configured/included in the corresponding NBI RS beam set. For instance, the index of the m-th NBI RS resource or NBI RS resource m in a NBI RS beam set k (e.g., k∈{1, . . . , S_q1}) comprising a total of N_q1 NBI RS resources corresponding to N_q1 periodic CSI-RS resource configuration indexes or SSB indexes is m∈{0, 1, . . . , N_q1−1}.

For S_q1=2, the index of a NBI RS resource configured/included in the NBI RS beam set q1-0 could be any value in {0, 1, . . . , N_q10−1}; alternatively, the m-th NBI RS resource or the NBI RS resource m configured/included in the NBI RS beam set q1-0 is m, where m∈{0,1, . . . , N_q10−1} and N_q10 is the total number of NBI RS resources (or equivalently, the total number of periodic CSI-RS resource configuration indexes or SSB indexes) configured/included in the NBI RS beam set q1-0. Furthermore, the index of a NBI RS resource configured/included in the NBI RS beam set q1-1 could be any value in {0, 1, . . . , N_q11−1}; alternatively, the n-th NBI RS resource or the NBI RS resource n configured/included in the NBI RS beam set q1-1 is n, where n∈{0,1, . . . , N_q11−1} and N_q11 is the total number of NBI RS resources (or equivalently, the total number of periodic CSI-RS resource configuration indexes or SSB indexes) configured/included in the NBI RS beam set q1-1.

In yet another example, a NBI RS resource index could correspond to a periodic CSI-RS resource configuration index or a SSB index configured/included in the corresponding NBI RS beam set plus an offset value. For instance, the offset value for or associated with the NBI RS beam set k (e.g., k∈{1, . . . , S_q1}) corresponds to the largest/highest NBI RS resource index in the NBI RS beam set k−1; for k=1, the offset value is zero; for k=2, the offset value corresponds to the largest/highest SSB index or periodic CSI-RS resource configuration index configured/included in the first NBI RS beam set or the NBI RS beam 1.

For instance, if a SSB index or a NZP CSI-RS resource index/ID configured/included in the NBI RS beam set k (e.g., k∈{1, . . . , S_q1}) is #A and the largest/highest NBI RS resource index in the NBI RS beam set k−1 is #a (the offset value for or associated with the set k), the corresponding NBI RS resource index in the NBI RS beam set k is #(A+a).

In yet another example, the UE could be first configured by the network a pool of consecutive RS resource indexes such as SSB indexes or periodic CSI-RS resource configuration indexes. The pool of RS resource indexes could be divided into S_q1 disjoint sets of RS resource indexes with set indexes 1, 2, . . . , S_q1. Alternatively, the UE could be configured by the network (e.g., via higher layer RRC signaling) S_q1 disjoint sets of RS resource indexes with set indexes 1, 2, . . . , S_q1. For example, in each set of RS resource indexes, the indexes of the RS resources such as SSBs or periodic CSI-RS resources configured therein are consecutive in increasing order, and across all S_q1 sets (e.g., from 1 to S_q1), the indexes of the RS resources configured therein are consecutive in increasing order. A NBI RS resource index configured/included in the k-th NBI RS beam set or the NBI RS beam set k could correspond to a RS resource index such as SSB index or periodic CSI-RS resource configuration index configured in the k-th RS resource set or the RS resource set k, where k∈{1, . . . , S_q1}.

In yet another example, a NBI RS resource index could be determined based on/according to all the NBI RS resources (and therefore, all the corresponding periodic CSI-RS resources or SSBs) configured/included in all S_q1 NBI RS beam sets each comprising a total of N_q1 NBI RS resources corresponding to N_q1 periodic CSI-RS resource configuration indexes or SSB indexes. For example, the index of a NBI RS resource in a NBI RS beam set k (e.g., k∈{1, . . . , S_q1}) comprising a total of N_q1 NBI RS resources corresponding to N_q1 periodic CSI-RS resource configuration indexes or SSB indexes could be any value in {0,1, . . . , S_q1·N_q1−1} or {(k−1)·N_q1, (k−1)·N_q1+1, . . . , k·N_q1-1}.

For another example, the index of the m-th NBI RS resource or NBI RS resource m in a NBI RS beam set k (e.g., k∈{1, . . . , S_q1}) comprising a total of N_q1 NBI RS resources corresponding to N_q1 periodic CSI-RS resource configuration indexes or SSB indexes is (k−1)·N_q1+m, where m∈{0,1, . . . , N_q1−1}. For S_q1=2, the index of a NBI RS resource configured/included in the NBI RS beam set q1-0 could be any value in {0, 1, . . . , N_q10+N_q11−1} or {0, 1, . . . , N_q10}; alternatively, the m-th NBI RS resource or the NBI RS resource m configured/included in the NBI RS beam set q1-0 is m, where m∈{0, 1, . . . , N_q10−1}, N_q10 is the total number of NBI RS resources (or equivalently, the total number of periodic CSI-RS resource configuration indexes or SSB indexes) configured/included in the NBI RS beam set q1-0 and N_q11 is the total number of NBI RS resources (or equivalently, the total number of periodic CSI-RS resource configuration indexes or SSB indexes) configured/included in the NBI RS beam set q1-1. Furthermore, the index of a NBI RS resource configured/included in the NBI RS beam set q1-1 could be any value in {0, 1, . . . , N_q10+N_q11−1} or {N_q10, N_q10+1, . . . , N_q10+N_q11−1}; alternatively, the n-th NBI RS resource or the NBI RS resource n configured/included in the NBI RS beam set q1-1 is n+N_q10, where n∈{0, 1, . . . , N_q11−1}.

The physical layer in the UE could evaluate/assess the radio link quality for one or more NBI RSs (or equivalently, one or more SSBs on the PCell or the PSCell or one or more periodic 1-port or 2-port CSI-RS resource configurations) configured/included in a NBI RS beam set (e.g., the NBI RS beam set k, k∈{1, . . . , S_q1}) against a BFR threshold. The value(s) of the BFR threshold(s) could be: (1) fixed in the system specifications, (2) based on network's configuration, e.g., the UE could be higher layer RRC configured by the network one or more TRP-specific/per TRP BFR thresholds, and (3) autonomously determined by the UE and reported to the network as a UE capability/feature signaling.

For instance, for S_q1=2, the physical layer in the UE could evaluate/assess the radio link quality for one or more of the NBI RSs (or equivalently, the corresponding SSBs on the PCell or the PSCell or the corresponding periodic 1-port or 2-port CSI-RS resource configurations) configured/included in the NBI RS beam set q1-0 against a BFD threshold Qin, or the radio link quality for one or more of the NBI RSs (or equivalently, the corresponding SSBs on the PCell or the PSCell or the corresponding periodic 1-port or 2-port CSI-RS resource configurations) configured/included in the NBI RS beam set q1-1 against the BFR threshold Qin.

In the present disclosure, the radio link quality for a NBI RS corresponding to a SSB could correspond to a L1 based beam metric/measurement such as a L1-RSRP measurement or a L1-SINR measurement. The radio link quality for a NBI RS corresponding to a periodic 1-port or 2-port CSI-RS resource configuration could correspond to a L1 based beam metric/measurement such as a L1-RSRP measurement or a L1-SINR measurement after scaling a respective CSI-RS reception power with a value provided by the higher layer parameter powerControlOffsetSS. A BFR threshold could correspond to the default value of rlmInSyncOutOfSyncThreshold for Qout, and/or to the value provided by the higher layer parameter rsrp-ThresholdBFR.

For a NBI RS beam set, the UE could identify one or more NBI RSs, and therefore, the corresponding NBI RS resource indexes from the NBI RS beam set, whose associated radio link qualities (such as L1-RSRP measurements) are larger than or equal to the BFR threshold. For instance, for S_q1=2, the UE could identify a first NBI RS, and therefore, the corresponding NBI RS resource index from the NBI RS beam set q1-0 such that the radio link quality of the first NBI RS is larger than the BFR threshold; or the UE could identify a second NBI RS, and therefore, the corresponding NBI RS resource index from the NBI RS beam set q1-1 such that the radio link quality of the second NBI RS is larger than the BFR threshold. For each NBI RS resource configured in a NBI RS beam set, the UE could be provided by the network an associated PRACH preamble dedicated for the BFRQ transmission, if CFRA is provided/configured.

Following the configuration method(s) specified in the present disclosure, a NBI RS resource index in a NBI RS beam set (e.g., q1-0 or q1-1 for S_q1=2) could correspond to a periodic CSI-RS resource configuration index or a SSB index configured/included in the corresponding NBI RS beam set.

In one example, for each configured NBI RS resource (and therefore, the corresponding periodic CSI-RS resource or SSB), the UE could be provided by the network a unique PRACH preamble (index) dedicated for the BFRQ transmission. For example, the UE could be first configured by the network (e.g., via higher layer RRC signaling) a pool of N_p PRACH preambles for the BFRQ transmission. The pool of N_p PRACH preambles could be further divided into S_q1 disjoint sets of PRACH preambles with set indexes 1, 2, . . . , S_q1, each comprising at least one PRACH preamble index.

In this case, the UE could be configured by the network, e.g., provided by the higher layer parameters PRACH-ResourceDedicatedBFR, BFR-SSB-Resource or BFR-CSIRS-Resource, an association between a NBI RS resource (and therefore, the corresponding SSB or CSI-RS resource) and a PRACH preamble for the BFRQ transmission, wherein different configured NBI RS resources are associated with different PRACH preambles, and the NBI RS resource(s) (and therefore, the corresponding SSB(s) or CSI-RS resource(s)) configured/included in the same NBI RS beam set may be associated with the PRACH preamble(s) in the same set of PRACH preamble(s).

For S_q1=2, the UE could be configured by the network, e.g., provided by the higher layer parameters PRACH-ResourceDedicatedBFR0 and PRACH-ResourceDedicatedBFR1 as illustrated in TABLE 3, the associations between the NBI RS resources (and therefore, the corresponding periodic CSI-RS resources and SSBs) configured/included in the NBI RS beam sets q1-0 and the PRACH preambles with indexes {0, 1, . . . , 31} in the first set of PRACH preamble indexes (e.g., provided by the higher layer parameters BFR-SSB-Resource0 or BFR-CSIRS-Resource0 as illustrated in TABLE 3), and the associations between the NBI RS resources (and therefore, the corresponding periodic CSI-RS resources and SSBs) configured/included in the NBI RS beam sets q1-1 and the PRACH preambles with indexes {32, 33, . . . , 63} in the second set of PRACH preamble indexes (e.g., provided by the higher layer parameters BFR-SSB-Resource1 or BFR-CSIRS-Resource1).

TABLE 3
Higher layer parameters

```
-- ASN1START
-- TAG-BEAMFAILURERECOVERYCONFIG-START
BeamFailureRecoveryConfig ::= SEQUENCE {
  ...,
  candidateBeamRSList0 SEQUENCE (SIZE(1..maxNrofCandidateBeamsPerList)) OF
PRACH-ResourceDedicatedBFR0 OPTIONAL, -- Need M
  candidateBeamRSList1 SEQUENCE (SIZE(1..maxNrofCandidateBeamsPerList)) OF
PRACH-ResourceDedicatedBFR1 OPTIONAL, -- Need M OPTIONAL, -- Need M
  ...
}
PRACH-ResourceDedicatedBFR0 ::= CHOICE {
  ssb BFR-SSB-Resource,
  csi-RS BFR-CSIRS-Resource
}
PRACH-ResourceDedicatedBFR1 ::= CHOICE {
  ssb BFR-SSB-Resource,
  csi-RS BFR-CSIRS-Resource
}
BFR-SSB-Resource0 ::= SEQUENCE {
  ssb SSB-Index,
  ra-PreambleIndex INTEGER (0..31),
  ...
}
BFR-SSB-Resource1 ::= SEQUENCE {
  ssb SSB-Index,
  ra-PreambleIndex INTEGER (32..63),
  ...
}
BFR-CSIRS-Resource0 ::= SEQUENCE {
  csi-RS NZP-CSI-RS-ResourceId,
  ra-OccasionList SEQUENCE (SIZE(1..maxRA-OccasionsPerCSIRS)) OF INTEGER
(0..maxRA-Occasions-1) OPTIONAL, -- Need R
```

| | |
|---|---|
| ra-PreambleIndex INTEGER (0..31) | OPTIONAL, -- Need R |

```
  ...
}
BFR-CSIRS-Resource1 ::= SEQUENCE {
  csi-RS NZP-CSI-RS-ResourceId,
  ra-OccasionList SEQUENCE (SIZE(1..maxRA-OccasionsPerCSIRS)) OF INTEGER
(0..maxRA-Occasions-1) OPTIONAL, -- Need R
```

| | |
|---|---|
| ra-PreambleIndex INTEGER (32..63) | OPTIONAL, -- Need R |

...
}
-- TAG-BEAMFAILURERECOVERYCONFIG-STOP
-- ASN1STOP

For this design example, after the UE has identified one or more new beams, i.e., one or more NBI RS resources, from the one or more NBI RS beam sets, the UE could send to the network their associated/corresponding PRACH preambles. From the index(es) of the preamble(s) reported from the UE, the network could first identify the set index(es) of the NBI RS beam set(s) associated with the reported preamble(s) as different NBI RS beam sets are associated with different sets of PRACH preambles. Furthermore, from the index(es) of the preamble(s) reported from the UE, the network could then identify the associated new beam(s), i.e., the associated NBI RS resource(s) (and therefore, the corresponding SSB(s) or CSI-RS resource(s)) in the corresponding NBI RS beam set(s) selected by the UE.

Four slots after the UE has transmitted the BFRQ, the UE could start to monitor a dedicated CORESET/search space for BFRR. The UE could assume the same QCL parameter(s) for receiving the identified NBI RS resource(s) (i.e., the new beam(s)) to receive a PDCCH in a search space set provided by recoverySearchSpaceId where a UE detects a DCI format with CRC scrambled by C-RNTI or MCS-C-RNTI.

As mentioned herein, the UE could identify more than one new beam, i.e., more than one NBI RS resources (and therefore, the corresponding SSBs or periodic CSI-RS resources), from more than one NBI RS beam sets. For instance, for S_q1=2, the UE could identify a first new beam, i.e., a first NBI RS resource (and therefore, the corresponding SSB or periodic CSI-RS resource), from the NBI RS beam set q1-0, and a second new beam, i.e., a second NBI RS resource (and therefore, the corresponding SSB or periodic CSI-RS resource), from the NBI RS beam set q1-1.

In one example, the UE could send to the network a single PRACH preamble associated with/corresponding to an identified NBI RS resource (and therefore, the corresponding SSB or periodic CSI-RS resource) from a NBI RS beam set. The identified NBI RS could have the largest measured radio link quality (e.g., measured L1-RSRP) among the measured radio link qualities (e.g., measured L1-RSRPs) from all the NBI RSs. Alternatively, the UE could be indicated by the network (e.g., via higher layer RRC signalling) the NBI RS beam set or the set index of the NBI RS beam set, with which the PRACH preamble to be reported (or the corresponding set of PRACH preambles) may be associated; this indication could be via higher layer (RRC) or/and MAC CE or/and DCI based signaling; this indication could be via a separate (dedicated) parameter or joint with another parameter.

Or the UE could autonomously determine the NBI RS beam set, with which the PRACH preamble to be reported (or the corresponding set of PRACH preambles) may be associated. For instance, for S_q1=2, the UE could send to the network the PRACH preamble associated with the first new beam, i.e., the first NBI RS resource (and therefore, the corresponding SSB or periodic CSI-RS resource) from q1-0, if the measured radio link quality (e.g., measured L1-RSRP) for the first NBI RS is greater than that for the second NBI RS. If the measured radio link quality (e.g., measured L1-RSRP) for the second NBI RS is greater than that for the first NBI RS, the UE could send to the network the PRACH preamble associated with the second new beam, i.e., the second NBI RS resource (and therefore, the corresponding SSB or periodic CSI-RS resource) from q1-1.

Four slots after the UE has transmitted the BFRQ, the UE could start to monitor a dedicated CORESET/search space for BFRR. The UE could assume the same QCL parameter(s) for receiving the identified NBI RS resource (e.g., the first NBI RS resource in q1-0 or the second NBI RS resource in q1-1) to receive a PDCCH in a search space set provided by recoverySearchSpaceId where a UE detects a DCI format with CRC scrambled by C-RNTI or MCS-C-RNTI.

In another example, the UE could send to the network multiple (more than one) PRACH preambles associated with/corresponding to more than one identified NBI RS resources (and therefore, the corresponding SSBs or periodic CSI-RS resources) from more than one NBI RS beam sets. The UE could be indicated by the network (e.g., via higher layer RRC signalling) the NBI RS beam sets or the set indexes of the NBI RS beam sets, with which the PRACH preambles to be reported (or the corresponding sets of PRACH preambles) may be associated; this indication could be via higher layer (RRC) or/and MAC CE or/and DCI based signaling; this indication could be via a separate (dedicated) parameter or joint with another parameter.

Alternatively, the UE could autonomously determine the NBI RS beam sets, with which the PRACH preambles to be reported (or the corresponding sets of PRACH preambles) may be associated. For instance, for S_q1=2, the UE could send to the network the PRACH preamble, from the first set of PRACH preambles associated with q1-0, associated with the first new beam, i.e., the first NBI RS resource (and therefore, the corresponding SSB or periodic CSI-RS resource) from q1-0, and the PRACH preamble, from the second set of PRACH preambles associated with q1-1, associated with the second new beam, i.e., the second NBI RS resource (and therefore, the corresponding SSB or periodic CSI-RS resource) from q1-1.

Four slots after the UE has transmitted the BFRQ, the UE could start to monitor a dedicated CORESET/search space for BFRR. The UE could assume the same QCL parameter(s) for receiving one or more of the identified NBI RS resources (e.g., the first NBI RS resource in q1-0 or the second NBI RS resource in q1-1 or both) to receive a PDCCH in a search space set provided by recoverySearchSpaceId where a UE detects a DCI format with CRC scrambled by C-RNTI or MCS-C-RNTI; the one or more of the identified NBI RS resources are from one or more of the NBI RS beam sets, with which the reported PRACH preambles are associated.

In another example, for each configured NBI RS resource (and therefore, the corresponding periodic CSI-RS resource or SSB), the UE could be provided by the network a PRACH preamble dedicated for the BFRQ transmission. For example, the UE could be first configured by the network (e.g., via higher layer RRC signaling) a first pool of N_p PRACH preambles for the BFRQ transmission. The UE could be configured by the network, e.g., provided by the higher layer parameters PRACH-ResourceDedicatedBFR, BFR-SSB-Resource or BFR-CSIRS-Resource, an association between a NBI RS resource (and therefore, the corresponding SSB or CSI-RS resource) and a PRACH preamble from the first pool of N_p PRACH preambles. In this case, different NBI RS resources in different NBI RS beam sets could be with a same resource index, and therefore associated with a same PRACH preamble index.

For S_q1=2, the UE could be configured by the network, e.g., provided by the higher layer parameters PRACH-ResourceDedicatedBFR0 and PRACH-ResourceDedicatedBFR1 as illustrated in TABLE 4, the associations between the NBI RS resources (and therefore, the corresponding periodic CSI-RS resources and SSBs) configured/included in both NBI RS beam sets q1-0 and q1-1 and the PRACH preambles with indexes {0, 1, . . . , 63} (e.g., provided by the higher layer parameters BFR-SSB-Resource or BFR-CSIRS-Resource as illustrated in TABLE 4) in the first pool of N_p PRACH preambles.

TABLE 4
Higher layer parameters

```
-- ASN1START
-- TAG-BEAMFAILURERECOVERYCONFIG-START
BeamFailureRecoveryConfig ::= SEQUENCE {
  ...,
  candidateBeamRSList0 SEQUENCE (SIZE(1..maxNrofCandidateBeamsPerList)) OF
PRACH-ResourceDedicatedBFR0 OPTIONAL, -- Need M
  candidateBeamRSList1 SEQUENCE (SIZE(1..maxNrofCandidateBeamsPerList)) OF
PRACH-ResourceDedicatedBFR1 OPTIONAL, -- Need M OPTIONAL, -- Need M
  ...
}
PRACH-ResourceDedicatedBFR0 ::= CHOICE {
  ssb BFR-SSB-Resource,
  csi-RS BFR-CSIRS-Resource
}
PRACH-ResourceDedicatedBFR1 ::= CHOICE {
  ssb BFR-SSB-Resource,
  csi-RS BFR-CSIRS-Resource
}
BFR-SSB-Resource ::= SEQUENCE {
  ssb SSB-Index,
  ra-PreambleIndex INTEGER (0..63),
  ...
}
BFR-CSIRS-Resource ::= SEQUENCE {
  csi-RS NZP-CSI-RS-ResourceId,
  ra-OccasionList SEQUENCE (SIZE(1..maxRA-OccasionsPerCSIRS)) OF INTEGER
(0..maxRA-Occasions-1) OPTIONAL, -- Need R
```

| | |
|---|---|
| ra-PreambleIndex INTEGER (0..63) | OPTIONAL, -- Need R |

...
}
-- TAG-BEAMFAILURERECOVERYCONFIG-STOP
-- ASN1STOP

For this design example, after the UE has identified one or more new beams, i.e., one or more NBI RS resources, from the one or more NBI RS beam sets, the UE could send to the network their associated/corresponding PRACH preambles. As mentioned herein, as different NBI RS resources (and therefore, the corresponding SSBs or periodic CSI-RS resources) in different NBI RS beam sets could have a same resource index, they could be associated with a same PRACH preamble.

In this case, from the index(es) of the preamble(s) reported from the UE, the network could not identify the corresponding NBI RS beam set(s) or the set index(es) of the corresponding NBI RS beam set(s). The UE could be configured by the network (e.g., via higher layer RRC signaling) a second pool of S_q1 PRACH preambles each associated with a NBI RS beam set. The UE could send to the network one or more PRACH preambles selected from the second pool of S_q1 PRACH preambles to indicate the set index(es) of the selected NBI RS beam set(s).

For instance, for S_q1=2, the UE could be configured by the network a second pool of a first PRACH preamble and a second PRACH preamble, respectively associated with the NBI RS beam sets q1-0 and q1-1. If the UE sends to the network the first (or the second) PRACH preamble, the UE actually indicates to the network that the selected new beam(s), i.e., the selected NBI RS resource(s), is from the NBI RS beam set q1-0 (or q1-1). From the index(es) of the reported PRACH preamble(s) selected from the first pool of N_p PRACH preambles and the index(es) of the reported PRACH preamble(s) selected from the second pool of S_q1 PRACH preambles, the network could then identify the new beam(s), i.e., the NBI RS resource(s) (and therefore, the corresponding SSB(s) or CSI-RS resource(s)) in the corresponding NBI RS beam set(s) selected/identified by the UE.

Four slots after the UE has transmitted the BFRQ, the UE could start to monitor a dedicated CORESET/search space for BFRR. The UE could assume the same QCL parameter(s) for receiving the identified NBI RS resource(s) (i.e., the new beam(s)) to receive a PDCCH in a search space set provided by recoverySearchSpaceId where a UE detects a DCI format with CRC scrambled by C-RNTI or MCS-C-RNTI.

As mentioned herein, the UE could identify more than one new beam, i.e., more than one NBI RS resources (and therefore, the corresponding SSBs or periodic CSI-RS resources), from more than one NBI RS beam sets. For instance, for S_q1=2, the UE could identify a first new beam, i.e., a first NBI RS resource (and therefore, the corresponding SSB or periodic CSI-RS resource), from the NBI RS beam set q1-0, and a second new beam, i.e., a second NBI RS resource (and therefore, the corresponding SSB or periodic CSI-RS resource), from the NBI RS beam set q1-1.

In one example, the UE could send to the network a single PRACH preamble, selected from the first pool of preambles, associated with/corresponding to an identified NBI RS resource (and therefore, the corresponding SSB or periodic CSI-RS resource) from a NBI RS beam set. The identified NBI RS could have the largest measured radio link quality (e.g., measured L1-RSRP) among the measured radio link qualities (e.g., measured L1-RSRPs) from all the NBI RSs. Or the UE could autonomously determine the NBI RS beam set, from which the NBI RS resource corresponding to the PRACH preamble, selected from the first pool of PRACH preambles, to be reported is selected.

In this case, the UE still needs to send to the network a preamble selected from the second pool of preambles to indicate the corresponding NBI RS beam set index. For instance, for S_q1=2, the UE could send to the network the PRACH preamble associated with the first new beam, i.e., the first NBI RS resource (and therefore, the corresponding SSB or periodic CSI-RS resource) from q1-0, if the measured radio link quality (e.g., measured L1-RSRP) for the first NBI RS is greater than that for the second NBI RS; furthermore, the UE may send to the network the first preamble from the second pool of preambles. If the measured radio link quality (e.g., measured L1-RSRP) for the second NBI RS is greater than that for the first NBI RS, the UE could send to the network the PRACH preamble associated with the second new beam, i.e., the second NBI RS resource (and therefore, the corresponding SSB or periodic CSI-RS resource) from q1-1; furthermore, the UE may send to the network the second preamble from the second pool of preambles.

Alternatively, the UE could be indicated by the network (e.g., via higher layer RRC signalling) the NBI RS beam set or the set index of the NBI RS beam set, from which the NBI RS resource corresponding to the PRACH preamble, selected from the first pool of PRACH preambles, to be reported is selected; this indication could be via higher layer (RRC) or/and MAC CE or/and DCI based signaling; this indication could be via a separate (dedicated) parameter or joint with another parameter. In this case, the UE may not need to send to the network any preamble from the second pool of preambles to indicate the corresponding NBI RS beam set index.

Four slots after the UE has transmitted the BFRQ, the UE could start to monitor a dedicated CORESET/search space for BFRR. The UE could assume the same QCL parameter(s) for receiving the identified NBI RS resource (e.g., the first NBI RS resource in q1-0 or the second NBI RS resource in q1-1) to receive a PDCCH in a search space set provided by recoverySearchSpaceId where a UE detects a DCI format with CRC scrambled by C-RNTI or MCS-C-RNTI.

In another example, the UE could send to the network multiple (more than one) PRACH preambles, selected from the first pool of PRACH preambles, associated with/corresponding to more than one identified NBI RS resources (and therefore, the corresponding SSBs or periodic CSI-RS resources) from more than one NBI RS beam sets. The UE could be indicated by the network (e.g., via higher layer RRC signalling) the NBI RS beam sets or the set indexes of the NBI RS beam sets, from which the NBI RS resources corresponding to the PRACH preambles, selected from the first pool of PRACH preambles, to be reported are selected; this indication could be via higher layer (RRC) or/and MAC CE or/and DCI based signaling; this indication could be via a separate (dedicated) parameter or joint with another parameter.

Or the UE may send to the network the PRACH preambles, selected from the first pool of PRACH preambles, associated with/corresponding to all identified NBI RS resources (and therefore, the corresponding SSBs or periodic CSI-RS resources) from all NBI RS beam sets. In these cases, the UE may not need to send to the network any preambles from the second pool of preambles to indicate the corresponding NBI RS beam set indexes. For instance, for S_q1=2, the UE could send to the network the PRACH preamble, from the first pool of PRACH preambles, associated with the first new beam, i.e., the first NBI RS resource (and therefore, the corresponding SSB or periodic CSI-RS resource) from q1-0, and the PRACH preamble, from the first pool of PRACH preambles, associated with the second new beam, i.e., the second NBI RS resource (and therefore, the corresponding SSB or periodic CSI-RS resource) from q1-1.

Alternatively, the UE could autonomously determine the NBI RS beam sets, from which the NBI RS resources corresponding to the PRACH preambles, selected from the first pool of PRACH preambles, to be reported are selected. In this case, the UE may need to send to the network multiple (more than one) preambles selected from the second pool of preambles to indicate the corresponding NBI RS beam set indexes.

Four slots after the UE has transmitted the BFRQ, the UE could start to monitor a dedicated CORESET/search space for BFRR. The UE could assume the same QCL parameter(s) for receiving one or more of the identified NBI RS resources (e.g., the first NBI RS resource in q1-0 or the second NBI RS resource in q1-1 or both) to receive a PDCCH in a search space set provided by recoverySearchSpaceId where a UE detects a DCI format with CRC scrambled by C-RNTI or MCS-C-RNTI; the one or more of the identified NBI RS resources are from one or more of the NBI RS beam sets, with which the reported PRACH preambles are associated.

The UE could be configured by the network (e.g., by higher layer RRC signaling) a pool of N_q1·S_q1 PRACH preambles for BFRQ transmission. The UE could be further configured by the network an association between a RS resource index and a PRACH preamble index selected from the pool of N_q1·S_q1 PRACH preambles, wherein different RS resource indexes are associated with different PRACH preamble indexes.

For example, the UE could first identity one or more new beams, i.e., one or more NBI RS resources, from one or more NBI RS beam sets, whose associated radio link quality is greater than or equal to the BFR threshold. The UE could identify the PRACH preamble index(es), from the pool of N_q1·S_q1 PRACH preambles, associated with the selected/identified NBI RS resource index(es). The UE could then send to the network the identified PRACH preamble(s). As different NBI RS resources configured/included in different NBI RS beam sets (which have different NBI RS resource indexes) are associated with different PRACH preamble indexes, upon receiving the preamble(s) reported from the UE, the network could first identify the selected NBI RS resource index(es) and the corresponding NBI RS beam set(s), from which the NBI RS resource(s) is selected/identified by the UE.

Based on the offset value(s) associated with the identified NBI RS beam set(s), the network could then identify the SSB index(es) or the periodic CSI-RS resource configuration index(es) corresponding to the identified NBI RS resource index(es).

For example, the UE could first identity one or more new beams, i.e., one or more NBI RS resources, from one or more NBI RS beam sets, whose associated radio link quality is greater than or equal to the BFR threshold. The UE could identify the PRACH preamble index(es), from the pool of N_q1 S_q1 PRACH preambles, associated with the selected/identified NBI RS resource index(es). The UE could then send to the network the identified PRACH preamble(s). As different NBI RS resources configured/included in different NBI RS beam sets (which have different NBI RS resource indexes) are associated with different PRACH preamble indexes, upon receiving the preamble(s) reported from the UE, the network could first identify the selected NBI RS resource index(es) and the corresponding NBI RS beam set(s), from which the NBI RS resource(s) is selected/identified by the UE. The network could then identify the SSB index(es) or the periodic CSI-RS resource configuration index(es) having the same value(s) as the identified NBI RS resource index(es).

Four slots after the UE has transmitted the BFRQ, the UE could start to monitor a dedicated CORESET/search space for BFRR. The UE could assume the same QCL parameter(s) for receiving the identified NBI RS resource(s) (i.e., the new beam(s)) to receive a PDCCH in a search space set provided by recoverySearchSpaceId where a UE detects a DCI format with CRC scrambled by C-RNTI or MCS-C-RNTI.

As mentioned herein, the UE could identify more than one new beam, i.e., more than one NBI RS resources (and therefore, the corresponding SSBs or periodic CSI-RS resources), from more than one NBI RS beam sets. For instance, for S_q1=2, the UE could identify a first new beam, i.e., a first NBI RS resource (and therefore, the corresponding SSB or periodic CSI-RS resource), from the NBI RS beam set q1-0, and a second new beam, i.e., a second NBI RS resource (and therefore, the corresponding SSB or periodic CSI-RS resource), from the NBI RS beam set q1-1.

In one example, the UE could send to the network a single PRACH preamble associated with/corresponding to an identified NBI RS resource (and therefore, the corresponding SSB or periodic CSI-RS resource) from a NBI RS beam set. The identified NBI RS could have the largest measured radio link quality (e.g., measured L1-RSRP) among the measured radio link qualities (e.g., measured L1-RSRPs) from all the NBI RSs. Alternatively, the UE could be indicated by the network (e.g., via higher layer RRC signalling) the NBI RS beam set or the set index of the NBI RS beam set, from which the NBI RS resource corresponding to the PRACH preamble to be reported is selected; this indication could be via higher layer (RRC) or/and MAC CE or/and DCI based signaling; this indication could be via a separate (dedicated) parameter or joint with another parameter.

Or the UE could autonomously determine the NBI RS beam set, from which the NBI RS resource corresponding to the PRACH preamble to be reported is selected. For instance, for S_q1=2, the UE could send to the network the PRACH preamble associated with the first new beam, i.e., the first NBI RS resource (and therefore, the corresponding SSB or periodic CSI-RS resource) from q1-0, if the measured radio link quality (e.g., measured L1-RSRP) for the first NBI RS is greater than that for the second NBI RS. If the measured radio link quality (e.g., measured L1-RSRP) for the second NBI RS is greater than that for the first NBI RS, the UE could send to the network the PRACH preamble associated with the second new beam, i.e., the second NBI RS resource (and therefore, the corresponding SSB or periodic CSI-RS resource) from q1-1.

Four slots after the UE has transmitted the BFRQ, the UE could start to monitor a dedicated CORESET/search space for BFRR. The UE could assume the same QCL parameter(s) for receiving the SSB or periodic CSI-RS resource derived from the identified NBI RS resource (e.g., the first NBI RS resource in q1-0 or the second NBI RS resource in q1-1) to receive a PDCCH in a search space set provided by recoverySearchSpaceId where a UE detects a DCI format with CRC scrambled by C-RNTI or MCS-C-RNTI.

In another example, the UE could send to the network multiple (more than one) PRACH preambles associated with/corresponding to more than one identified NBI RS resources (and therefore, the corresponding SSBs or periodic CSI-RS resources) from more than one NBI RS beam sets. The UE could be indicated by the network (e.g., via higher layer RRC signalling) the NBI RS beam sets or the set indexes of the NBI RS beam sets, from which the NBI RS resources corresponding to the PRACH preambles to be reported are selected; this indication could be via higher layer (RRC) or/and MAC CE or/and DCI based signaling; this indication could be via a separate (dedicated) parameter or joint with another parameter.

Alternatively, the UE could autonomously determine the NBI RS beam sets, from which the NBI RS resources corresponding to the PRACH preambles to be reported are selected. For instance, for S_q1=2, the UE could send to the network the PRACH preamble associated with the first new beam, i.e., the first NBI RS resource (and therefore, the corresponding SSB or periodic CSI-RS resource) from q1-0, and the PRACH preamble associated with the second new beam, i.e., the second NBI RS resource (and therefore, the corresponding SSB or periodic CSI-RS resource) from q1-1.

Four slots after the UE has transmitted the BFRQ, the UE could start to monitor a dedicated CORESET/search space for BFRR. The UE could assume the same QCL parameter(s) for receiving one or more SSBs or periodic CSI-RS resources derived from one or more of the identified NBI RS resources (e.g., the first NBI RS resource in q1-0 or the second NBI RS resource in q1-1 or both) to receive a PDCCH in a search space set provided by recoverySearchSpaceId where a UE detects a DCI format with CRC scrambled by C-RNTI or MCS-C-RNTI; the one or more of the identified NBI RS resources are from one or more of the NBI RS beam sets, with which the reported PRACH preambles are associated.

For a NBI RS beam set, the UE could identify one or more NBI RSs, and therefore, the corresponding NBI RS resource indexes from the NBI RS beam set, whose associated radio link qualities (such as L1-RSRP measurements) are larger than or equal to the BFR threshold. For instance, for S_q1=2, the UE could identify a first NBI RS, and therefore, the corresponding NBI RS resource index from the NBI RS beam set q1-0 such that the radio link quality of the first NBI RS is larger than the BFR threshold; or the UE could identify a second NBI RS, and therefore, the corresponding NBI RS resource index from the NBI RS beam set q1-1 such that the radio link quality of the second NBI RS is larger than the BFR threshold. For each NBI RS resource configured in a NBI RS beam set, the UE could be provided by the network one or more associated contention based PRACH preambles for CBRA based transmission/fall back.

Following the configuration method(s) specified in the present disclosure, a NBI RS resource index in a NBI RS beam set (e.g., q1-0 or q1-1 for S_q1=2) could correspond to a periodic CSI-RS resource configuration index or a SSB index configured/included in the corresponding NBI RS beam set.

In one example, the UE could be configured by the network (e.g., via higher layer RRC signaling) a pool of N_p consecutive PRACH preamble indexes in increasing order. The pool of N_p contention based PRACH preambles could be divided into S_q1 disjoint sets of PRACH preambles with set indexes 1, 2, . . . , S_q1. Alternatively, the UE could be configured by the network (e.g., via higher layer RRC signaling) S_q1 disjoint sets of contention based PRACH preambles with set indexes 1, 2, . . . , S_q1. For example, in each set of contention based PRACH preambles, the indexes of the PRACH preambles configured therein are consecutive in increasing order, and across all S_q1 disjoint sets of contention based PRACH preambles (e.g., from 1 to S_q1), the indexes of the PRACH preambles configured therein are consecutive in increasing order.

For instance, the indexes of the PRACH preambles configured in the k-th set of contention based PRACH preambles (k∈{1, . . . , S_q1}) are: (k−1)·M_p+1, (k−1)·M_p+2, . . . , k·M_p, where each set comprises a total of M_p contention based PRACH preambles. Each set of contention based PRACH preambles is associated with a NBI RS beam set. For example, the k-th set of contention based PRACH preambles is associated with/mapped to the k-th NBI RS beam set or the NBI RS beam set k, where k∈{1, . . . , S_q1}.

For another example, the UE could be explicitly indicated by the network the association/mapping between the S_q1 sets of contention based PRACH preambles and the S_q1 NBI RS beam sets; this indication could be via higher layer (RRC) or/and MAC CE or/and DCI based signaling; this indication could be via a separate (dedicated) parameter or joint with another parameter. For instance, the UE could be indicated/configured by the network a pair of two set indexes; the first (or the second) set index could correspond to that of a set of contention based PRACH preambles and the second (or the first) set index could correspond to that of a NBI RS beam set; the set of contention based PRACH preambles and the NBI RS beam set in the same pair are associated. For instance, for S_q1=2, the NBI RS beam set q1-0 could be associated with the first set of contention based PRACH preambles with indexes 0, 1, . . . , 31, and the NBI RS beam set q1-1 could be associated with the second set of contention based PRACH preambles with indexes 32, 33, . . . , 63.

For a given set of M_p contention based PRACH preambles, the UE could be indicated/configured by the network the association(s)/mapping(s) between one or more SSB indexes and one or more PRACH preambles configured in the set. For instance, a SSB index could be mapped to a total of Q consecutive PRACH preamble indexes configured in the k-th set of contention based PRACH preambles (k∈{1, . . . , S_q1}), wherein the configured PRACH preambles are consecutively indexed as (k−1)·M_p+1, (k−1)·M_p+2, . . . , k·M_p. If the SSB index is k_ssb (k_ssb∈{0, . . . , K_ssb−1}), the Q consecutive PRACH preamble indexes are (k−1)·M_p+(k_ssb−1)·Q+1, (k−1)·M_p+(k_ssb−1)·Q+2, . . . , (k−1)·M_p+k_ssb·Q, where K_ssb is the number of consecutive SSB indexes associated with a set of contention based PRACH preambles.

For this design example, the UE could first identity one or more new beams, i.e., one or more NBI RS resources corresponding to periodic CSI-RS resource configuration indexes or SSB indexes, from one or more NBI RS beam sets, whose associated radio link quality is greater than or equal to the BFR threshold. The UE could first identify the set(s) of contention based PRACH preambles associated with the corresponding NBI RS beam set(s), from which the NBI RS resource(s) is selected by the UE. From the identified set(s) of contention based PRACH preambles, the UE could further identify Q PRACH preambles with consecutive indexes in increasing order associated with a selected/identified NBI RS resource if the selected/identified NBI RS resource corresponds to an SSB. If the selected/identified NBI RS resource corresponds to a periodic CSI-RS resource, the UE could use the corresponding SSB having the same value as the QCL source RS for the periodic CSI-RS resource to determine the PRACH preamble. From the identified Q consecutive PRACH preamble indexes, the UE could randomly select one preamble to initiate/trigger the CBRA based transmission/fall back.

As different NBI RS resources configured/included in different NBI RS beam sets (which could have a same NBI RS resource index corresponding to a SSB index or a periodic CSI-RS resource configuration index) are associated with different Q consecutive PRACH preamble indexes, upon receiving the preamble reported from the UE, the network could identify the associated NBI RS resource(s) and the NBI RS beam set(s), from which the NBI RS resource(s) is selected/identified by the UE.

In response to a PRACH transmission, a UE attempts to detect a DCI format 1_0 with CRC scrambled by a corresponding RA-RNTI during a window controlled by higher layers. The UE could assume same DM-RS antenna port quasi co-location properties as for the selected/identified NBI RS resource (and therefore, the corresponding SSB or periodic CSI-RS resource), regardless of whether or not the UE is provided TCI-State for the CORESET where the UE receives the PDCCH with the DCI format 1_0.

As mentioned herein, the UE could identify more than one new beam, i.e., more than one NBI RS resources (and therefore, the corresponding SSBs or periodic CSI-RS resources), from more than one NBI RS beam sets. For instance, for S_q1=2, the UE could identify a first new beam, i.e., a first NBI RS resource (and therefore, the corresponding SSB or periodic CSI-RS resource), from the NBI RS beam set q1-0, and a second new beam, i.e., a second NBI RS resource (and therefore, the corresponding SSB or periodic CSI-RS resource), from the NBI RS beam set q1-1.

In one example, the UE could send to the network a single contention based PRACH preamble associated with/corresponding to an identified NBI RS resource (and therefore, the corresponding SSB or periodic CSI-RS resource) from a NBI RS beam set. The identified NBI RS could have the largest measured radio link quality (e.g., measured L1-RSRP) among the measured radio link qualities (e.g., measured L1-RSRPs) from all the NBI RSs.

Alternatively, the UE could be indicated by the network (e.g., via higher layer RRC signalling) the NBI RS beam set or the set index of the NBI RS beam set, with which the PRACH preamble to be reported (or the corresponding set of contention based PRACH preambles) may be associated; this indication could be via higher layer (RRC) or/and MAC CE or/and DCI based signaling; this indication could be via a separate (dedicated) parameter or joint with another parameter. Or the UE could autonomously determine the NBI RS beam set, with which the PRACH preamble to be reported (or the corresponding set of contention based PRACH preambles) may be associated. For instance, for S_q1=2, the UE could send to the network the PRACH preamble, randomly selected from the Q consecutive contention based PRACH preamble indexes, associated with the first new beam, i.e., the first NBI RS resource (and therefore, the corresponding SSB or periodic CSI-RS resource) from q1-0, where the Q PRACH preambles with consecutive indexes in increasing order are from the (first) set of contention based PRACH preambles associated with q1-0, if the measured radio link quality (e.g., measured L1-RSRP) for the first NBI RS is greater than that for the second NBI RS.

If the measured radio link quality (e.g., measured L1-RSRP) for the second NBI RS is greater than that for the first NBI RS, the UE could send to the network the PRACH preamble, randomly selected from the Q consecutive contention based PRACH preamble indexes, associated with the second new beam, i.e., the second NBI RS resource (and therefore, the corresponding SSB or periodic CSI-RS resource) from q1-1, wherein the Q PRACH preambles with consecutive indexes in increasing order are from the (second) set of contention based PRACH preambles associated with q1-1.

In response to a PRACH transmission, a UE attempts to detect a DCI format 1_0 with CRC scrambled by a corresponding RA-RNTI during a window controlled by higher layers. The UE could assume same DM-RS antenna port quasi co-location properties as for the selected/identified NBI RS resource (and therefore, the corresponding SSB or periodic CSI-RS resource), regardless of whether or not the UE is provided TCI-State for the CORESET where the UE receives the PDCCH with the DCI format 1_0.

In another example, the UE could send to the network multiple (more than one) contention based PRACH preambles associated with/corresponding to more than one identified NBI RS resources (and therefore, the corresponding SSBs or periodic CSI-RS resources) from more than one NBI RS beam sets. The UE could be indicated by the network (e.g., via higher layer RRC signalling) the NBI RS beam sets or the set indexes of the NBI RS beam sets, with which the PRACH preambles to be reported (or the corresponding sets of contention based PRACH preambles) may be associated; this indication could be via higher layer (RRC) or/and MAC CE or/and DCI based signaling; this indication could be via a separate (dedicated) parameter or joint with another parameter.

Alternatively, the UE could autonomously determine the NBI RS beam sets, with which the PRACH preambles to be reported (or the corresponding sets of contention based PRACH preambles) may be associated. For instance, for S_q1=2, the UE could send to the network the PRACH preamble, randomly selected from the Q consecutive contention based PRACH preamble indexes, associated with the first new beam, i.e., the first NBI RS resource (and therefore, the corresponding SSB or periodic CSI-RS resource) from q1-0, where the Q PRACH preambles with consecutive indexes in increasing order are from the (first) set of contention based PRACH preambles associated with q1-0, and the PRACH preamble, randomly selected from the Q consecutive contention based PRACH preamble indexes, associated with the second new beam, i.e., the second NBI RS resource (and therefore, the corresponding SSB or periodic CSI-RS resource) from q1-1, wherein the Q PRACH preambles with consecutive indexes in increasing order are from the (second) set of contention based PRACH preambles associated with q1-1.

In response to PRACH transmissions, a UE attempts to detect a DCI format 1_0 with CRC scrambled by a corresponding RA-RNTI during a window controlled by higher layers. The UE could assume same DM-RS antenna port quasi co-location properties as for one or more of the identified NBI RS resources (e.g., the first NBI RS resource in q1-0 or the second NBI RS resource in q1-1 or both), regardless of whether or not the UE is provided TCI-State for the CORESET where the UE receives the PDCCH with the DCI format 1_0; the one or more of the identified NBI RS resources are from one or more of the NBI RS beam sets, with which the reported PRACH preambles are associated.

In another example, the UE could be configured by the network (e.g., via higher layer RRC signaling) a pool of N_p consecutive PRACH preamble indexes in increasing order. For the pool of N_p contention based PRACH preambles, the UE could be indicated/configured by the network the association(s)/mapping(s) between one or more SSB indexes and one or more PRACH preambles configured in the pool of contention based PRACH preambles. For instance, a SSB index could be mapped to a total of Q consecutive PRACH preamble indexes configured in the pool of N_p contention based PRACH preambles. If the SSB index is k_ssb (k_ssb∈{0, . . . , K_ssb−1}), the Q consecutive PRACH preamble indexes are (k_ssb−1)·Q+1, (k_ssb−1)·Q+2, . . . , k_ssb·Q, where K_ssb is the number of consecutive SSB indexes associated with the pool of N_p contention based PRACH preambles.

For instance, for S_q1=2, a NBI RS resource (and therefore, the corresponding SSB index or periodic CSI-RS resource configuration index) in the NBI RS beam set q1-0 and a NBI RS resource (and therefore, the corresponding SSB index or periodic CSI-RS resource configuration index) in the NBI RS beam set q1-1 could be associated with same Q consecutive contention based PRACH preambles, e.g., 1, 2, . . . , Q.

For this design example, the UE could first identity one or more new beams, i.e., one or more NBI RS resources corresponding to periodic CSI-RS resource configuration indexes or SSB indexes, from one or more NBI RS beam sets, whose associated radio link quality is greater than or equal to the BFR threshold. The UE could identify Q consecutive PRACH preamble indexes associated with the selected/identified NBI RS resource index(es) if the selected/identified NBI RS resource(s) corresponds to SSB(s). If the selected/identified NBI RS resource(s) corresponds to periodic CSI-RS resource(s), the UE could use the corresponding SSB(s) having the same value(s) as the QCL source RS(s) for the periodic CSI-RS resource(s) to determine the PRACH preamble(s).

From the identified Q consecutive PRACH preamble indexes, the UE could randomly select one preamble to initiate/trigger the CBRA based transmission/fall back. As different NBI RS resources configured/included in different NBI RS beam sets (which could have a same NBI RS resource index corresponding to a SSB index or a periodic CSI-RS resource configuration index) could be associated with the same Q consecutive PRACH preamble indexes, upon receiving the preamble reported from the UE, the network could not identify the NBI RS beam set(s), from which the NBI RS resource(s) is selected/identified by the UE.

In response to a PRACH transmission, a UE attempts to detect a DCI format 1_0 with CRC scrambled by a corresponding RA-RNTI during a window controlled by higher layers. The UE could assume same DM-RS antenna port quasi co-location properties as for the selected/identified NBI RS resource (and therefore, the corresponding SSB or periodic CSI-RS resource), or a NBI RS resource (and therefore, the corresponding SSB or periodic CSI-RS resource) in the NBI RS beam set k (k∈{1, . . . , S_q1}) having the same resource index as the selected/identified NBI RS resource, or one or more NBI RS resources (and therefore, the corresponding SSB(s) or periodic CSI-RS resource(s)) in one or more NBI RS beam sets having the same resource index as the selected/identified NBI RS resource, regardless of whether or not the UE is provided TCI-State for the CORESET where the UE receives the PDCCH with the DCI format 1_0. Here, the NBI RS beam set index k could be determined according to: (1) fixed in the system specifications or per RRC configuration, (2) configured by the network, e.g., via higher layer RRC signalling, or (3) autonomously determined by the UE.

As mentioned herein, the UE could identify more than one new beam, i.e., more than one NBI RS resources (and therefore, the corresponding SSBs or periodic CSI-RS resources), from more than one NBI RS beam sets. For instance, for S_q1=2, the UE could identify a first new beam, i.e., a first NBI RS resource (and therefore, the corresponding SSB or periodic CSI-RS resource), from the NBI RS beam set q1-0, and a second new beam, i.e., a second NBI RS resource (and therefore, the corresponding SSB or periodic CSI-RS resource), from the NBI RS beam set q1-1.

In one example, the UE could send to the network a single contention based PRACH preamble associated with/corresponding to an identified NBI RS resource (and therefore, the corresponding SSB or periodic CSI-RS resource) from a NBI RS beam set. The identified NBI RS could have the largest measured radio link quality (e.g., measured L1-RSRP) among the measured radio link qualities (e.g., measured L1-RSRPs) from all the NBI RSs. Alternatively, the UE could be indicated by the network (e.g., via higher layer RRC signalling) the NBI RS beam set or the set index of the NBI RS beam set, from which the NBI RS resource corresponding to the PRACH preamble, randomly selected from the Q PRACH preambles with consecutive indexes in increasing order associated with the NBI RS resource, to be reported is selected; this indication could be via higher layer (RRC) or/and MAC CE or/and DCI based signaling; this indication could be via a separate (dedicated) parameter or joint with another parameter.

Or the UE could autonomously determine the NBI RS beam set, from which the NBI RS resource corresponding to the PRACH preamble to be reported (randomly selected from the Q contention based PRACH preambles with consecutive indexes in increasing order associated with the NBI RS resource), is selected. For instance, for S_q1=2, the UE could send to the network the PRACH preamble, randomly selected from first Q contention based PRACH preambles with consecutive indexes in increasing order associated with the first new beam, i.e., the first NBI RS resource (and therefore, the corresponding SSB or periodic CSI-RS resource) from q1-0, where the first Q consecutive PRACH preamble indexes are from the pool of N_p contention based PRACH preamble indexes, if the measured radio link quality (e.g., measured L1-RSRP) for the first NBI RS is greater than that for the second NBI RS. If the measured radio link quality (e.g., measured L1-RSRP) for the second NBI RS is greater than that for the first NBI RS, the UE could send to the network the PRACH preamble, randomly selected from second Q contention based PRACH preambles with consecutive indexes in increasing order associated with the second new beam, i.e., the second NBI RS resource (and therefore, the corresponding SSB or periodic CSI-RS resource) from q1-1, wherein the second Q consecutive PRACH preamble indexes are from the pool of N_p contention based PRACH preamble indexes.

In response to a PRACH transmission, a UE attempts to detect a DCI format 1_0 with CRC scrambled by a corresponding RA-RNTI during a window controlled by higher layers. The UE could assume same DM-RS antenna port quasi co-location properties as for the selected/identified NBI RS resource (and therefore, the corresponding SSB or periodic CSI-RS resource), or a NBI RS resource (and therefore, the corresponding SSB or periodic CSI-RS resource) in the NBI RS beam set k (k∈{1, . . . , S_q1}) having the same resource index as the selected/identified NBI RS resource, or one or more NBI RS resources (and therefore, the corresponding SSB or periodic CSI-RS resource) in one or more NBI RS beam sets having the same resource index as the selected/identified NBI RS resource, regardless of whether or not the UE is provided TCI-State for the CORESET where the UE receives the PDCCH with the DCI format 1_0. Here, the NBI RS beam set index k could be determined according to: (1) fixed in the system specifications or per RRC configuration, (2) configured by the network, e.g., via higher layer RRC signalling, or (3) autonomously determined by the UE.

In another example, the UE could send to the network multiple (more than one) contention based PRACH preambles associated with/corresponding to more than one identified NBI RS resources (and therefore, the corresponding SSBs or periodic CSI-RS resources) from more than one NBI RS beam sets. The UE could be indicated by the network (e.g., via higher layer RRC signalling) the NBI RS beam sets or the set indexes of the NBI RS beam sets, from which the NBI RS resources corresponding to the PRACH preambles, each randomly selected from the Q consecutive contention based PRACH preamble indexes associated with the corresponding NBI RS resource, to be reported are selected; this indication could be via higher layer (RRC) or/and MAC CE or/and DCI based signaling; this indication could be via a separate (dedicated) parameter or joint with another parameter. Or the UE may send to the network the PRACH preambles, each randomly selected from the Q consecutive contention based PRACH preambles associated with the corresponding NBI RS resource, associated with/corresponding to all identified NBI RS resources (and therefore, the corresponding SSBs or periodic CSI-RS resources) from all NBI RS beam sets.

Alternatively, the UE could autonomously determine the NBI RS beam sets, from which the NBI RS resources corresponding to the PRACH preambles, each randomly selected from the Q consecutive contention based PRACH preambles associated with the corresponding NBI RS resource, to be reported are selected. For instance, for S_q1=2, the UE could send to the network the PRACH preamble randomly selected from first Q consecutive contention based PRACH preamble indexes associated with the first new beam, i.e., the first NBI RS resource (and therefore, the corresponding SSB or periodic CSI-RS resource) from q1-0, where the first Q PRACH preambles with consecutive indexes in increasing order are from the pool of N_p contention based PRACH preamble indexes, and the PRACH preamble randomly selected from second Q consecutive contention based PRACH preamble indexes associated with the second new beam, i.e., the second NBI RS resource (and therefore, the corresponding SSB or periodic CSI-RS resource) from q1-1, wherein the second Q PRACH preambles with consecutive indexes in increasing order are from the pool of N_p contention based PRACH preamble indexes.

In response to PRACH transmissions, a UE attempts to detect a DCI format 1_0 with CRC scrambled by a corresponding RA-RNTI during a window controlled by higher layers. The UE could assume same DM-RS antenna port quasi co-location properties as for one or more of the identified NBI RS resources (and therefore, the corresponding SSBs or periodic CSI-RS resources), or one or more NBI RS resources (and therefore, the corresponding SSBs or periodic CSI-RS resources) in one or more NBI RS beam sets having the same resource indexes as the one or more of the identified NBI RS resources, regardless of whether or not the UE is provided TCI-State for the CORESET where the UE receives the PDCCH with the DCI format 1_0.

The UE could be configured by the network (e.g., via higher layer RRC signaling) a pool of N_p consecutive PRACH preamble indexes in increasing order. For the pool of N_p contention based PRACH preambles, the UE could be indicated/configured by the network the association(s)/mapping(s) between one or more RS resource indexes and one or more PRACH preambles configured in the pool of N_p contention based PRACH preambles. For instance, a RS resource index could be mapped to a total of Q consecutive PRACH preamble indexes configured in the pool of N_p contention based PRACH preambles. If the RS resource index is k_rs (k_rs∈{0, . . . , K_rs−1}), the Q consecutive PRACH preamble indexes are (k_rs−1)·Q+1, (k_rs−1)·Q+2, . . . , k_rs·Q, where K_rs is the number of consecutive RS resource indexes associated with the pool of N_p contention based PRACH preambles.

For example, the UE could first identity one or more new beams, i.e., one or more NBI RS resources, from one or more NBI RS beam sets, whose associated radio link quality is greater than or equal to the BFR threshold. The UE could identify Q consecutive PRACH preamble indexes, from the pool of N_p contention based PRACH preambles, associated with the selected/identified NBI RS resource index(es). From the identified Q consecutive PRACH preamble indexes, the UE could randomly select one preamble to initiate/trigger the CBRA based transmission/fall back. As different NBI RS resources configured/included in different NBI RS beam sets (which have different NBI RS resource indexes) are associated with different Q consecutive PRACH preamble indexes, upon receiving the preamble reported from the UE, the network could first identify the selected NBI RS resource index(es) and the corresponding NBI RS beam set(s), from which the NBI RS resource(s) is selected/identified by the UE. Based on the offset value(s) associated with the identified NBI RS beam set(s), the network could then identify the SSB index(es) or the periodic CSI-RS resource configuration index(es) corresponding to the identified NBI RS resource index(es).

For example, the UE could first identity one or more new beams, i.e., one or more NBI RS resources, from one or more NBI RS beam sets, whose associated radio link quality is greater than or equal to the BFR threshold. The UE could identify Q consecutive PRACH preamble indexes, from the pool of N_p contention based PRACH preambles, associated with the selected/identified NBI RS resource index(es). From the identified Q consecutive PRACH preamble indexes, the UE could randomly select one preamble to initiate/trigger the CBRA based transmission/fall back. As different NBI RS resources configured/included in different NBI RS beam sets (which have different NBI RS resource indexes) are associated with different Q consecutive PRACH preamble indexes, upon receiving the preamble reported from the UE, the network could first identify the selected NBI RS resource index(es) and the corresponding NBI RS beam set(s), from which the NBI RS resource(s) is selected/identified by the UE. The network could then identify the SSB index(es) or the periodic CSI-RS resource configuration index(es) having the same value(s) as the identified NBI RS resource index(es).

In response to a PRACH transmission, a UE attempts to detect a DCI format 1_0 with CRC scrambled by a corresponding RA-RNTI during a window controlled by higher layers. The UE could assume same DM-RS antenna port quasi co-location properties as the SSB or periodic CSI-RS resource derived from the identified NBI RS resource, regardless of whether or not the UE is provided TCI-State for the CORESET where the UE receives the PDCCH with the DCI format 1_0.

As mentioned herein, the UE could identify more than one new beam, i.e., more than one NBI RS resources (and therefore, the corresponding SSBs or periodic CSI-RS resources), from more than one NBI RS beam sets. For instance, for S_q1=2, the UE could identify a first new beam, i.e., a first NBI RS resource (and therefore, the corresponding SSB or periodic CSI-RS resource), from the NBI RS beam set q1-0, and a second new beam, i.e., a second NBI RS resource (and therefore, the corresponding SSB or periodic CSI-RS resource), from the NBI RS beam set q1-1.

In one example, the UE could send to the network a single contention based PRACH preamble associated with/corresponding to an identified NBI RS resource (and therefore, the corresponding SSB or periodic CSI-RS resource) from a NBI RS beam set. The identified NBI RS could have the largest measured radio link quality (e.g., measured L1-RSRP) among the measured radio link qualities (e.g., measured L1-RSRPs) from all the NBI RSs. Alternatively, the UE could be indicated by the network (e.g., via higher layer RRC signalling) the NBI RS beam set or the set index of the NBI RS beam set, from which the NBI RS resource corresponding to the PRACH preamble, randomly selected from the Q consecutive PRACH preamble indexes associated with the NBI RS resource, to be reported is selected; this indication could be via higher layer (RRC) or/and MAC CE or/and DCI based signaling; this indication could be via a separate (dedicated) parameter or joint with another parameter.

Or the UE could autonomously determine the NBI RS beam set, from which the NBI RS resource corresponding to the PRACH preamble, randomly selected from the Q consecutive PRACH preamble indexes associated with the NBI RS resource, to be reported is selected. For instance, for S_q1=2, the UE could send to the network the PRACH preamble randomly selected from first Q consecutive contention based PRACH preamble indexes associated with the first new beam, i.e., the first NBI RS resource (and therefore, the corresponding SSB or periodic CSI-RS resource) from q1-0, where the first Q PRACH preambles with consecutive indexes in increasing order are from the pool of N_p contention based PRACH preambles, if the measured radio link quality (e.g., measured L1-RSRP) for the first NBI RS is greater than that for the second NBI RS.

If the measured radio link quality (e.g., measured L1-RSRP) for the second NBI RS is greater than that for the first NBI RS, the UE could send to the network the PRACH preamble randomly selected from second Q consecutive contention based PRACH preamble indexes associated with the second new beam, i.e., the second NBI RS resource (and therefore, the corresponding SSB or periodic CSI-RS resource) from q1-1, wherein the second Q PRACH preambles with consecutive indexes in increasing order are from the pool of N_p contention based PRACH preambles.

In response to a PRACH transmission, a UE attempts to detect a DCI format 1_0 with CRC scrambled by a corresponding RA-RNTI during a window controlled by higher layers. The UE could assume same DM-RS antenna port quasi co-location properties as the SSB or periodic CSI-RS resource derived from the identified NBI RS resource (e.g., the first NBI RS resource in q1-0 or the second NBI RS resource in q1-1), regardless of whether or not the UE is provided TCI-State for the CORESET where the UE receives the PDCCH with the DCI format 1_0.

In another example, the UE could send to the network multiple (more than one) contention based PRACH preambles associated with/corresponding to more than one identified NBI RS resources (and therefore, the corresponding SSBs or periodic CSI-RS resources) from more than one NBI RS beam sets. The UE could be indicated by the network (e.g., via higher layer RRC signalling) the NBI RS beam sets or the set indexes of the NBI RS beam sets, from which the NBI RS resources corresponding to the PRACH preambles (each randomly selected from the Q consecutive PRACH preamble indexes associated with the corresponding NBI RS resource) to be reported are selected; this indication could be via higher layer (RRC) or/and MAC CE or/and DCI based signaling; this indication could be via a separate (dedicated) parameter or joint with another parameter.

Alternatively, the UE could autonomously determine the NBI RS beam sets, from which the NBI RS resources corresponding to the PRACH preambles (each randomly selected from the Q consecutive PRACH preamble indexes associated with the corresponding NBI RS resource) to be reported are selected. For instance, for S_q1=2, the UE could send to the network the PRACH preamble randomly selected from first Q consecutive contention based PRACH preamble indexes associated with the first new beam, i.e., the first NBI RS resource (and therefore, the corresponding SSB or periodic CSI-RS resource) from q1-0, where the first Q PRACH preambles with consecutive indexes in increasing order are from the pool of N_p contention based PRACH preambles, and the PRACH preamble randomly selected from second Q consecutive contention based PRACH preamble indexes associated with the second new beam, i.e., the second NBI RS resource (and therefore, the corresponding SSB or periodic CSI-RS resource) from q1-1, wherein the second Q PRACH preambles with consecutive indexes in increasing order are from the pool of N_p contention based PRACH preambles.

In response to a PRACH transmissions, a UE attempts to detect a DCI format 1_0 with CRC scrambled by a corresponding RA-RNTI during a window controlled by higher layers. The UE could assume same DM-RS antenna port quasi co-location properties as one or more SSBs or periodic CSI-RS resources derived from one or more of the identified NBI RS resources (e.g., the first NBI RS resource in q1-0 or the second NBI RS resource in q1-1 or both), regardless of whether or not the UE is provided TCI-State for the CORESET where the UE receives the PDCCH with the DCI format 1_0; the one or more of the identified NBI RS resources are from one or more of the NBI RS beam sets, with which the reported PRACH preambles are associated.

After the UE has received the BFRR from the network, the UE may expect the network to update/reset the beam(s) for control channels with the newly identified beam(s) corresponding to the identified NBI RS resource(s) from one or more NBI RS beam sets. In a multi-TRP system, the beam(s) for one or more control resource sets (CORESETs) may be updated/reset based on the association between the one or more CORESETs and the RS sets for beam failure detection (BFD RS beam sets), or the configured RS sets for new beam identification (NBI RS beam sets).

The UE could be indicated by the network the association(s) between the BFD RS beam sets (or the NBI RS beam sets) and one or more CORESETs; this indication could be via higher layer (RRC) or/and MAC CE or/and DCI based signaling; this indication could be via a separate (dedicated) parameter or joint with another parameter.

In one example, the UE could be explicitly indicated by the network the association(s)/mapping relationship(s) between one or more BFD RS beam sets and one or more CORESETs. For example, the higher layer parameter configuring a BFD RS beam set could indicate/include one or more CORESET ID values. For S_q0=2, the higher layer parameter failureDetectionResourcesToAddModList1 configuring the BFD RS beam set q0-0 could include/indicate one or more CORESET ID values for first CORESETs, and the higher layer parameter failureDetectionResourcesToAddModList2 configuring the BFD RS beam set q0-1 could include/indicate one or more CORESET ID values for second CORESETs. For another example, the higher layer parameter configuring a CORESET could indicate/include a BFD RS beam set ID value. For S_q0=2, the higher layer parameter ControlResourceSet configuring a CORESET could include/indicate the set index of either the BFD RS beam set q0-0 or q0-1. Yet for another example, the UE could be configured by the network one or more parameters indicating the association(s)/mapping relationship(s) between one or more BFD RS beam sets and one or more CORESETs.

For instance, the UE could be provided by the network a parameter BFD-RS-Set-CORESET indicating a BFD RS beam set index and one or more CORESET ID values; the BFD RS beam set and the one or more CORESET ID values indicated in the same parameter BFD-RS-Set-CORESET are associated. For S_q0=2, the UE could be provided by the network a parameter BFD-RS-Set-CORESET indicating BFD RS beam set q0-0 and one or more CORESET ID values for the first CORESETs; furthermore, the UE could be provided by the network a parameter BFD-RS-Set-CORESET indicating BFD RS beam set q0-1 and one or more CORESET ID values for the second CORESETs.

In another example, the UE could be explicitly indicated by the network the association(s)/mapping relationship(s) between one or more NBI RS beam sets and one or more CORESETs. For example, the higher layer parameter configuring a NBI RS beam set could indicate/include one or more CORESET ID values. For S_q1=2, the higher layer parameter candidateBeamRSList0 configuring the NBI RS beam set q1-0 could include/indicate one or more CORESET ID values for the first CORESETs, and the higher layer parameter candidateBeamRSList1 configuring the NBI RS beam set q1-1 could include/indicate one or more CORESET ID values for the second CORESETs.

For another example, the higher layer parameter configuring a CORESET could indicate/include a NBI RS beam set ID value. For S_q1=2, the higher layer parameter ControlResourceSet configuring a CORESET could include/indicate the set index of either the NBI RS beam set q1-0 or q1-1. Yet for another example, the UE could be configured by the network one or more parameters indicating the association(s)/mapping relationship(s) between one or more NBI RS beam sets and one or more CORESETs. For instance, the UE could be provided by the network a parameter NBI-RS-Set-CORESET indicating a NBI RS beam set index and one or more CORESET ID values; the NBI RS beam set and the one or more CORESET ID values indicated in the same parameter NBI-RS-Set-CORESET are associated. For S_q1=2, the UE could be provided by the network a parameter NBI-RS-Set-CORESET indicating NBI RS beam set q1-0 and one or more CORESET ID values for the first CORESETs; the UE could be provided by the network a parameter NBI-RS-Set-CORESET indicating NBI RS beam set q1-1 and one or more CORESET ID values for the second CORESETs.

In yet another example, the higher layer parameter configuring a CORESET could indicate/include a higher layer signaling index CORESETGroupIndex, where CORESETGroupIndex can be configured as either 0 or 1. That is, for each BWP of a serving cell, the UE is provided two CORESETGroupIndex values 0 and 1 for respective first and second CORESETs or is not provided CORESETGroupIndex value for the first CORESETs and is provided CORESETGroupIndex value of 1 for the second CORESETs, each having at least one activated TCI state. For instance, the higher layer parameter ControlResourceSet configuring a CORESET could include/indicate a CORESETGroupIndex value (either 0 or 1). For S_q0=2, the BFD RS beam set q0-0 is associated with the first CORESETs configured/associated with CORESETGroupIndex value 0, and the BFD RS beam set q0-1 is associated with the second CORESETs configured/associated with CORESETGroupIndex value 1. For S_q1=2, the NBI RS beam set q1-0 is associated with the first CORESETs configured/associated with CORESETGroupIndex value 0, and the NBI RS beam set q1-1 is associated with the second CORESETs configured/associated with CORESETGroupIndex value 1.

In yet another example, the association(s)/mapping relationship(s) between one or more BFD RS beam sets and one or more CORESETs could be fixed in the system specifications or per RRC configuration. For instance, for S_q0=2, the BFD RS beam set q0-0 could be associated with CORESETs with IDs 0, 1 and 2, while the BFD RS beam set q0-1 could be associated with CORESETs with IDs 3, 4, and 5. Other associations/mapping relationships between the BFD RS beam sets q0-0 and q0-1 and the CORESETs are also possible.

In yet another example, the association(s)/mapping relationship(s) between one or more NBI RS beam sets and one or more CORESETs could be fixed in the system specifications or per RRC configuration. For instance, for S_q1=2, the NBI RS beam set q1-0 could be associated with CORESETs with IDs 0, 1, and 2, while the NBI RS beam set q1-1 could be associated with CORESETs with IDs 3, 4, and 5. Other associations/mapping relationships between the NBI RS beam sets q1-0 and q1-1 and the CORESETs are also possible.

For serving cells associated with sets q0-0 and q1-0, and with sets q0-1 and q1-1, after 28 symbols from a last symbol of a PDCCH reception with a DCI format scheduling a PUSCH transmission with a same HARQ process number as for the transmission of the first PUSCH and having a toggled NDI field value, or after 28 symbols from a last symbol of a PDCCH reception in a search space set provided by the higher layer parameter recoverySearchSpaceId where a UE detects a DCI format with CRC scrambled by C-RNTI or MCS-C-RNTI, the UE assumes antenna port quasi-collocation parameters: (1) corresponding to the new beam, i.e., the NBI RS resource, identified from q1-0, if any, for the first CORESETs associated with q0-0 or q1-0; and/or (2) corresponding to the new beam, i.e., the NBI RS resource, identified from q1-1, if any, for the second CORESETs associated with q0-1 or q1-1, where the SCS configuration for the 28 symbols is the smallest of the SCS configurations of the active DL BWP for the PDCCH reception and of the active DL BWP(s) of the serving cells reported in the MAC CE.

The UE could be indicated by the network the association(s) between the BFD RS beam sets (or the NBI RS beam sets) and one or more TCI states indicated for PDCCH reception in one or more CORESETs; this indication could be via higher layer (RRC) or/and MAC CE or/and DCI based signaling; this indication could be via a separate (dedicated) parameter or joint with another parameter.

In one example, a BFD RS resource (corresponding to a periodic 1-port CSI-RS resource or an SSB), and therefore the corresponding BFD RS beam set, is associated with a TCI state indicated for PDCCH reception in a CORESET if the BFD RS resource having the same value as the QCL source RS indicated in the TCI state. For instance, for S_q0=2, the BFD RS beam set q0-0 could be associated with first active TCI states for PDCCH reception in one or more CORESETs if the BFD RS beam set q0-0 includes/contains the BFD RS resources having the same values as the QCL (typeD) source RSs indicated in the first active TCI states. Furthermore, the BFD RS beam set q0-1 could be associated with second active TCI states for PDCCH reception in one or more CORESETs if the BFD RS beam set q0-1 includes/contains the BFD RS resources having the same values as the QCL (typeD) source RSs indicated in the second active TCI states.

In another example, a NBI RS resource (corresponding to a periodic 1-port or 2-port CSI-RS resource or an SSB), and therefore the corresponding NBI RS beam set, is associated with a TCI state indicated for PDCCH reception in a CORESET if the NBI RS resource having the same value as the QCL source RS indicated in the TCI state. For instance, for S_q1=2, the NBI RS beam set q1-0 could be associated with first active TCI states for PDCCH reception in one or more CORESETs if the NBI RS beam set q1-0 includes/contains the NBI RS resources having the same values as the QCL (typeD) source RSs indicated in the first active TCI states. Furthermore, the NBI RS beam set q1-1 could be associated with second active TCI states for PDCCH reception in one or more CORESETs if the NBI RS beam set q1-1 includes/contains the NBI RS resources having the same values as the QCL (typeD) source RSs indicated in the second active TCI states.

In yet another example, a BFD RS beam set is associated with one or more active TCI states for PDCCH reception in one or more CORESETs if the NBI RS beam set associated with the BFD RS beam set is associated with the one or more active TCI states for PDCCH reception in one or more CORESETs. Alternatively, a NBI RS beam set is associated with one or more active TCI states for PDCCH reception in one or more CORESETs if the BFD RS beam set associated with the NBI RS beam set is associated with the one or more active TCI states for PDCCH reception in one or more CORESETs. For S_q0=2 and S_q1=2, the NBI RS beam set q1-0 is associated with the first active TCI states for PDCCH reception if the BFD RS beam set q0-0 is associated with the first active TCI states. Furthermore, the NBI RS beam set q1-1 is associated with the second active TCI states for PDCCH reception if the BFD RS beam set q0-1 is associated with the second active TCI states.

In yet another example, the UE could be explicitly indicated by the network the association(s)/mapping relationship(s) between one or more BFD RS beam sets and one or more active TCI states for PDCCH reception in one or more CORESETs. For example, the higher layer parameter configuring a BFD RS beam set could indicate/include one or more TCI state ID values. For S_q0=2, the higher layer parameter failureDetectionResourcesToAddModList1 configuring the BFD RS beam set q0-0 could include/indicate one or more TCI state ID values for first TCI states, and the higher layer parameter failureDetectionResourcesToAddModList2 configuring the BFD RS beam set q0-1 could include/indicate one or more TCI state ID values for second TCI states. For another example, the higher layer parameter configuring a TCI state could indicate/include a BFD RS beam set ID value.

For S_q0=2, the higher layer parameter TCI-State configuring a TCI state for PDCCH reception could include/indicate the set index of either the BFD RS beam set q0-0 or q0-1. Yet for another example, the UE could be configured by the network one or more parameters indicating the association(s)/mapping relationship(s) between one or more BFD RS beam sets and one or more active TCI states for PDCCH reception in one or more CORESETs. For instance, the UE could be provided by the network a parameter BFD-RS-Set-TCI indicating a BFD RS beam set index and one or more TCI state ID values; the BFD RS beam set, and the one or more TCI state ID values indicated in the same parameter BFD-RS-Set-TCI are associated. For S_q1=2, the UE could be provided by the network a parameter BFD-RS-Set-TCI indicating BFD RS beam set q0-0 and one or more TCI state ID values for the first TCI states; furthermore, the UE could be provided by the network a parameter BFD-RS-Set-TCI indicating BFD RS beam set q0-1 and one or more TCI state ID values for the second TCI states.

In yet another example, the UE could be explicitly indicated by the network the association(s)/mapping relationship(s) between one or more NBI RS beam sets and one or more active TCI states for PDCCH reception in one or more CORESETs. For example, the higher layer parameter configuring a NBI RS beam set could indicate/include one or more TCI state ID values. For S_q1=2, the higher layer parameter candidateBeamRSList0 configuring the NBI RS beam set q1-0 could include/indicate one or more TCI state ID values for first TCI states, and the higher layer parameter candidateBeamRSList1 configuring the NBI RS beam set q1-1 could include/indicate one or more TCI state ID values for second TCI states.

For another example, the higher layer parameter configuring a TCI state could indicate/include a NBI RS beam set ID value. For S_q1=2, the higher layer parameter TCI-State configuring a TCI state for PDCCH reception could include/indicate the set index of either the NBI RS beam set q1-0 or q1-1. Yet for another example, the UE could be configured by the network one or more parameters indicating the association(s)/mapping relationship(s) between one or more NBI RS beam sets and one or more active TCI states for PDCCH reception in one or more CORESETs. For instance, the UE could be provided by the network a parameter NBI-RS-Set-TCI indicating a NBI RS beam set index and one or more TCI state ID values; the NBI RS beam set, and the one or more TCI state ID values indicated in the same parameter NBI-RS-Set-TCI are associated. For S_q1=2, the UE could be provided by the network a parameter NBI-RS-Set-TCI indicating NBI RS beam set q1-0 and one or more TCI state ID values for the first TCI states; furthermore, the UE could be provided by the network a parameter NBI-RS-Set-TCI indicating NBI RS beam set q1-1 and one or more TCI state ID values for the second TCI states.

For serving cells associated with sets q0-0 and q1-0, and with sets q0-1 and q1-1, after 28 symbols from a last symbol of a PDCCH reception with a DCI format scheduling a PUSCH transmission with a same HARQ process number as for the transmission of the first PUSCH and having a toggled NDI field value, or after 28 symbols from a last symbol of a PDCCH reception in a search space set provided by the higher layer parameter recoverySearchSpaceId where a UE detects a DCI format with CRC scrambled by C-RNTI or MCS-C-RNTI, the UE assumes antenna port quasi-collocation parameters: (1) corresponding to the new beam, i.e., the NBI RS resource, identified from q1-0, if any, for the first active TCI states for PDCCH reception in one or more CORESETs, associated with q0-0 or q1-0; and/or (2) corresponding to the new beam, i.e., the NBI RS resource, identified from q1-1, if any, for the second active TCI states for PDCCH reception in one or more CORESETs, associated with q0-1 or q1-1, where the SCS configuration for the 28 symbols is the smallest of the SCS configurations of the active DL BWP for the PDCCH reception and of the active DL BWP(s) of the serving cells reported in the MAC CE.

In a multi-DCI based multi-TRP system, for each BWP of a serving cell, the UE is provided two CORESETPoolIndex values 0 and 1 for respective third and fourth CORESETs or is not provided CORESETPoolIndex value for the third CORESETs and is provided CORESETPoolIndex value of 1 for the fourth CORESETs, each having at least one activated TCI state. For S_q0=2, the BFD RS beam set q0-0 is associated with the third CORESETs configured/associated with CORESETPoolIndex value 0, and the BFD RS beam set q0-1 is associated with the fourth CORESETs configured/associated with CORESETPoolIndex value 1. For S_q1=2, the NBI RS beam set q1-0 is associated with the third CORESETs configured/associated with CORESETPoolIndex value 0, and the NBI RS beam set q1-1 is associated with the fourth CORESETs configured/associated with CORESETPoolIndex value 1.

For serving cells associated with sets q0-0 and q1-0, and with sets q0-1 and q1-1, after 28 symbols from a last symbol of a PDCCH reception with a DCI format scheduling a PUSCH transmission with a same HARQ process number as for the transmission of the first PUSCH and having a toggled NDI field value, or after 28 symbols from a last symbol of a PDCCH reception in a search space set provided by the higher layer parameter recoverySearchSpaceId where a UE detects a DCI format with CRC scrambled by C-RNTI or MCS-C-RNTI, the UE assumes antenna port quasi-collocation parameters: (1) corresponding to the new beam, i.e., the NBI RS resource, identified from q1-0, if any, for the third CORESETs associated with q0-0 or q1-0; and/or (2) corresponding to the new beam, i.e., the NBI RS resource, identified from q1-1, if any, for the fourth CORESETs associated with q0-1 or q1-1, where the SCS configuration for the 28 symbols is the smallest of the SCS configurations of the active DL BWP for the PDCCH reception and of the active DL BWP(s) of the serving cells reported in the MAC CE.

Furthermore, various beam resetting/updating mechanisms for uplink channels such as PUCCHs, PUSCHs and/or SRSs after receiving the BFRR are presented below.

In one example, for serving cells associated with sets q0-0 and q1-0, and with sets q0-1 and q1-1, after 28 symbols from a last symbol of a PDCCH reception with a DCI format scheduling a PUSCH transmission with a same HARQ process number as for the transmission of the first PUSCH and having a toggled NDI field value, or after 28 symbols from a last symbol of a PDCCH reception in a search space set provided by the higher layer parameter recoverySearchSpaceId.

In such case, a UE detects a DCI format with CRC scrambled by C-RNTI or MCS-C-RNTI, the UE transmits a first PUCCH (e.g., on a PUCCH-SCell): (1) using a same spatial domain filter as the one corresponding to the new beam (or the index q_new_0 of the new beam), i.e., the NBI RS resource, identified from q1-0, if any, for periodic CSI-RS or SSB reception, and using a power determined as described in the 3GPP TS 38.213 with q_u=0, q_d=q_new_0 and closed loop index 1=0, if: (i) the set q0-0 associated with q1-0 has the radio link quality worse than the BFD threshold Q_{out,LR}; (ii) the UE is provided PUCCH-SpatialRelationInfo for the first PUCCH, and (iii) a PUCCH with the LRR associated with the set q0-0 having the radio link quality worse than the BFD threshold Q_{out,LR} was transmitted in a PUCCH resource different from that of the first PUCCH; or (2) using a same spatial domain filter as the one corresponding to the new beam (or the index q_new_1 of the new beam), i.e., the NBI RS resource, identified from q1-1, if any, for periodic CSI-RS or SSB reception, and using a power determined as described in the 3GPP TS 38.213 with q_u=0, q_d=q_new_1 and closed loop index 1=0, if: (i) the set q0-1 associated with q1-1 has the radio link quality worse than the BFD threshold Q_{out,LR}; (ii) the UE is provided PUCCH-SpatialRelationInfo for the first PUCCH, and (iii) a PUCCH with the LRR associated with the set q0-1 having the radio link quality worse than the BFD threshold Q_{out,LR} was transmitted in a PUCCH resource different from that of the first PUCCH, where the SCS configuration for the 28 symbols is the smallest of the SCS configurations of the active DL BWP for the PDCCH reception and of the active DL BWP(s) of the serving cells reported in the MAC CE.

In another example, for serving cells associated with sets q0-0 and q1-0, and with sets q0-1 and q1-1, after 28 symbols from a last symbol of a PDCCH reception with a DCI format scheduling a PUSCH transmission with a same HARQ process number as for the transmission of the first PUSCH and having a toggled NDI field value, or after 28 symbols from a last symbol of a PDCCH reception in a search space set provided by the higher layer parameter recoverySearchSpaceId.

In such case, a UE detects a DCI format with CRC scrambled by C-RNTI or MCS-C-RNTI, the UE transmits a PUSCH or a SRS: (1) using a same spatial domain filter as the one corresponding to the new beam (or the index q_new_0 of the new beam), i.e., the NBI RS resource, identified from q1-0, if any, for periodic CSI-RS or SSB reception, and using a power determined as described in the 3GPP TS 38.213 with q_u=0, q_d=q_new_0 and closed loop index 1=0, if: (i) the set q0-0 associated with q1-0 has the radio link quality worse than the BFD threshold Q_{out,LR}, and/or (ii) the PUSCH/SRS is scheduled by a PDCCH transmitted in a CORESET associated with q0-0; or (2) using a same spatial domain filter as the one corresponding to the new beam (or the index q_new_1 of the new beam), i.e., the NBI RS resource, identified from q1-1, if any, for periodic CSI-RS or SSB reception, and using a power determined as described in the 3GPP TS 38.213 with q_u=0, q_d=q_new_1 and closed loop index 1=0, if: (i) the set q0-1 associated with q1-1 has the radio link quality worse than the BFD threshold Q_{out,LR}, and/or (ii) the PUSCH/SRS is scheduled by a PDCCH transmitted in a CORESET associated with q0-0, where the SCS configuration for the 28 symbols is the smallest of the SCS configurations of the active DL BWP for the PDCCH reception and of the active DL BWP(s) of the serving cells reported in the MAC CE.

In yet another example, for serving cells associated with sets q0-0 and q1-0, and with sets q0-1 and q1-1, after 28 symbols from a last symbol of a PDCCH reception with a DCI format scheduling a PUSCH transmission with a same HARQ process number as for the transmission of the first PUSCH and having a toggled NDI field value, or after 28 symbols from a last symbol of a PDCCH reception in a search space set provided by the higher layer parameter recoverySearchSpaceId.

In such case, a UE detects a DCI format with CRC scrambled by C-RNTI or MCS-C-RNTI, the UE transmits a PUCCH (e.g., on a PUCCH-SCell): (1) using a same spatial domain filter as the one used for transmitting the last PRACH associated with q0-0 (e.g., corresponding to the new beam (or the index q_new_0 of the new beam), i.e., the NBI RS resource, identified from q1-0, if any, for periodic CSI-RS or SSB reception), and using a power determined as described in the 3GPP TS 38.213 with q_u=0, q_d=q_new_0 and closed loop index 1=0, if the set q0-0 associated with q1-0 has the radio link quality worse than the BFD threshold Q_{out,LR}; or (2) using a same spatial domain filter as the one used for transmitting the last PRACH associated with q0-1 (e.g., corresponding to the new beam (or the index q_new_1 of the new beam), i.e., the NBI RS resource, identified from q1-1, if any, for periodic CSI-RS or SSB reception), and using a power determined as described in the 3GPP TS 38.213 with q_u=0, q_d=q_new_1 and closed loop index 1=0, if the set q0-1 associated with q1-1 has the radio link quality worse than the BFD threshold Q_{out,LR}, where the SCS configuration for the 28 symbols is the smallest of the SCS configurations of the active DL BWP for the PDCCH reception and of the active DL BWP(s) of the serving cells reported in the MAC CE.

In yet another example, for serving cells associated with sets q0-0 and q1-0, and with sets q0-1 and q1-1, after 28 symbols from a last symbol of a PDCCH reception with a DCI format scheduling a PUSCH transmission with a same HARQ process number as for the transmission of the first PUSCH and having a toggled NDI field value, or after 28 symbols from a last symbol of a PDCCH reception in a search space set provided by the higher layer parameter recoverySearchSpaceId.

In such case, a UE detects a DCI format with CRC scrambled by C-RNTI or MCS-C-RNTI, the UE transmits a PUSCH or a SRS: (1) using a same spatial domain filter as the one used for transmitting the last PRACH associated with q0-0 (e.g., corresponding to the new beam (or the index q_new_0 of the new beam), i.e., the NBI RS resource, identified from q1-0, if any, for periodic CSI-RS or SSB reception), and using a power determined as described in the 3GPP TS 38.213 with q_u=0, q_d=q_new_0 and closed loop index 1=0, if: (i) the set q0-0 associated with q1-0 has the radio link quality worse than the BFD threshold Q_{out,LR}, and/or (ii) the PUSCH/SRS is scheduled by a PDCCH transmitted in a CORESET associated with q0-0; or (2) using a same spatial domain filter as the one used for transmitting the last PRACH associated with q0-1 (e.g., corresponding to the new beam (or the index q_new_1 of the new beam), i.e., the NBI RS resource, identified from q1-1, if any, for periodic CSI-RS or SSB reception), and using a power determined as described in the 3GPP TS 38.213 with q_u=0, q_d=q_new_1 and closed loop index 1=0, if: (i) the set q0-1 associated with q1-1 has the radio link quality worse than the BFD threshold Q_{out,LR}, and/or (ii) the PUSCH/SRS is scheduled by a PDCCH transmitted in a CORESET associated with q0-0, where the SCS configuration for the 28 symbols is the smallest of the SCS configurations of the active DL BWP for the PDCCH reception and of the active DL BWP(s) of the serving cells reported in the MAC CE.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive downlink control information (DCI) including a first TCI field indicating a first transmission configuration indication (TCI) state; and
receive information about a type of the first TCI state; and
a processor operably coupled to the transceiver, the processor configured to determine, based on the first TCI state and the type of the first TCI state, a first set of beam failure detection (BFD) reference signal (RS) resource configuration indexes,
wherein the first TCI state indicates at least one of:
a RS for quasi co-location for at least one of: (1) a demodulation RS (DM-RS) of a first physical downlink shared channel (PDSCH) in a component carrier (CC), (2) a DM-RS of a first physical downlink control channel (PDCCH) in the CC, and (3) a first channel state information RS (CSI-RS), and
a reference for determining an uplink transmission spatial filter for a dynamic-grant and configured-grant based first physical uplink shared channel (PUSCH) and a first physical uplink control channel (PUCCH) resource in a CC, and a first sounding reference signal (SRS),
wherein the type of the first TCI state is a joint TCI state provided by DLorJointTCIState, a separate downlink (DL) TCI state indicated by a DLorJointTCIState parameter, or a separate UL TCI state indicated by a UL-TCIState parameter, and
wherein the BFD RS resource configuration indexes correspond to periodic CSI-RS resource configuration indexes.

2. The UE of claim 1, wherein, when the first TCI state is the joint TCI state or the separate DL TCI state, the processor is further configured to determine the BFD RS resource configuration indexes in the first set as the periodic CSI-RS resource configuration indexes having same values as RS indexes in RS sets indicated by the first TCI state.

3. The UE of claim 1, wherein:
the transceiver is further configured to receive, in the DCI, one or more DCI fields indicating the first set of BFD RS resource configuration indexes,
when the first TCI state is the joint TCI state or the separate DL TCI state, the processor is further configured to assess a radio link quality of one or more of the BFD RS resource configuration indexes in the first set that have same values as RS indexes in RS sets indicated by the first TCI state, and
the one or more DCI fields are: (1) dedicated DCI fields for indicating the first set of BFD RS resource configuration indexes or (2) reserved DCI fields to indicate the first set of BFD RS resource configuration indexes.

4. The UE of claim 1, wherein:
the transceiver is further configured to receive a radio resource control (RRC) parameter or a medium access control (MAC) control element (CE) command indicating the first set of BFD RS resource configuration indexes; and
when the first TCI state is a joint TCI state or a separate DL TCI state, the processor is further configured to assess a radio link quality of one or more of the BFD RS resource configuration indexes in the first set that have same values as RS indexes in RS sets indicated by the first TCI state.

5. The UE of claim 4, wherein:
the transceiver is further configured to receive, in the DCI, a bitmap indicated by one or more DCI fields with each bit position in the bitmap associated to a BFD RS resource configuration index in the first set,
the processor is further configured to determine a second set of BFD RS resource configuration indexes comprising one or more of the BFD RS resource configuration indexes in the first set that have associated bit positions in the bitmap set to ‘1’s,
when the first TCI state is a joint TCI state or a separate DL TCI state, the processor is further configured to assess a radio link quality of one or more of the BFD RS resource configuration indexes in the second set that have same values as RS indexes in RS sets indicated by the first TCI state, and
the one or more DCI fields are: (1) dedicated DCI fields for indicating the bitmap or (2) reserved DCI fields to indicate the bitmap.

6. The UE of claim 1, wherein:
the transceiver is further configured to:
receive, in the DCI, information indicating a second transmission configuration indication (TCI) state in the first TCI field or a second TCI field; and
receive information about a type of the second TCI state,
the processor is further configured to determine, based on the second TCI state and the type of the second TCI state, a second set of BFD RS resource configuration indexes,
the second TCI state indicates at least one of:
a RS for quasi co-location for at least one of: (1) a DM-RS of a second PDSCH in the CC, (2) a DM-RS of a second PDCCH in the CC, and (3) a second CSI-RS, and
a reference for determining an UL transmission spatial filter for at least one of: (1) a dynamic-grant and configured-grant based second PUSCH in the CC, (2) a second PUCCH resource in the CC, and (3) a second SRS, and
the type of the second TCI state is the joint TCI state indicated by the DLorJointTCIState parameter, the separate DL TCI state indicated by the DLorJointTCIState parameter, or the separate UL TCI state indicated by the UL-TCIState parameter.

7. The UE of claim 6, wherein, when the second TCI state is the joint TCI state or the separate DL TCI state, the processor is further configured to determine the BFD RS resource configuration indexes in the second set as periodic CSI-RS resource configuration indexes with same values as RS indexes in RS sets indicated by the second TCI state.

8. The UE of claim 7, wherein:
the processor is further configured to determine both the first set of BFD RS resource configuration indexes and the second set of BFD RS resource configuration indexes for each bandwidth part (BWP) of a serving cell.

9. A base station (BS), comprising:
a transceiver configured to:
transmit downlink control information (DCI) including a first TCI field indicating a first transmission configuration indication (TCI) state; and
transmit information about a type of the first TCI state,
wherein the first TCI state and the type of the first TCI state indicate, at least in part, a first set of beam failure detection (BFD) reference signal (RS) resource configuration indexes,
wherein the first TCI state indicates at least one of:
a RS for quasi co-location for at least one of: (1) a demodulation RS (DM-RS) of a first physical downlink shared channel (PDSCH) in a component carrier (CC), (2) a DM-RS of a first physical downlink control channel (PDCCH) in the CC, and (3) a first channel state information RS (CSI-RS), and
a reference for determining an uplink (UL) transmission spatial filter for at least one of: (1) a dynamic-grant and configured-grant based first physical uplink shared channel (PUSCH) in the CC, (2) a first physical uplink control channel (PUCCH) resource in the CC, and (3) a first sounding reference signal (SRS),
wherein the type of the first TCI state is a joint TCI state indicated by a DLorJointTCIState parameter, a separate downlink (DL) TCI state indicated by a DLorJointTCIState parameter, or a separate UL TCI state indicated by a UL-TCIState parameter, and
wherein the BFD RS resource configuration indexes correspond to periodic CSI-RS resource configuration indexes.

10. The BS of claim 9, wherein, when the first TCI state is the joint TCI state or the separate DL TCI state, the BFD RS resource configuration indexes in the first set as the periodic CSI-RS resource configuration indexes have same values as RS indexes in RS sets indicated by the first TCI state.

11. The BS of claim 9, wherein:
the DCI includes one or more DCI fields indicating the first set of BFD RS resource configuration indexes,
when the first TCI state is the joint TCI state or the separate DL TCI state, the BFD RS resource configuration indexes in the first set have same values as RS indexes in RS sets indicated by the first TCI state, and
the one or more DCI fields are: (1) dedicated DCI fields for indicating the first set of BFD RS resource configuration indexes or (2) reserved DCI fields to indicate the first set of BFD RS resource configuration indexes.

12. The BS of claim 9, wherein:
the transceiver is further configured to transmit a radio resource control (RRC) parameter or a medium access control (MAC) control element (CE) command indicating the first set of BFD RS resource configuration indexes; and
when the first TCI state is a joint TCI state or a separate DL TCI state, the BFD RS resource configuration indexes in the first set have same values as RS indexes in RS sets indicated by the first TCI state.

13. The BS of claim 12, wherein:
the DCI includes a bitmap indicated by one or more DCI fields with each bit position in the bitmap associated to a BFD RS resource configuration index in the first set,
when the first TCI state is a joint TCI state or a separate DL TCI state, one or more of the BFD RS resource configuration indexes in the first set, that have associated bit positions in the bitmap set to ‘1’s, have same values as RS indexes in RS sets indicated by the first TCI state, and
the one or more DCI fields are: (1) dedicated DCI fields for indicating the bitmap or (2) reserved DCI fields to indicate the bitmap.

14. The BS of claim 9, wherein:
the transceiver is further configured to:
transmit, in the DCI, information indicating a second transmission configuration indication (TCI) state in the first TCI field or a second TCI field; and
transmit information about a type of the second TCI state,
the second TCI state and the type of the second TCI state indicate, at least in part, a second set of BFD RS resource configuration indexes,
the second TCI state indicates at least one of:
a RS for quasi co-location for at least one of: (1) a DM-RS of a second PDSCH in the CC, (2) a DM-RS of a second PDCCH in the CC, and (3) a second CSI-RS, and
a reference for determining an UL transmission spatial filter for at least one of: (1) a dynamic-grant and configured-grant based second PUSCH in the CC, (2) a second PUCCH resource in the CC, and (3) a second SRS, and
the type of the second TCI state is the joint TCI state indicated by the DLorJointTCIState parameter, the separate DL TCI state indicated by the DLorJointTCIState parameter, or the separate UL TCI state indicated by the UL-TCIState parameter.

15. The BS of claim 14, wherein, when the second TCI state is the joint TCI state or the separate DL TCI state, the BFD RS resource configuration indexes in the second set as periodic CSI-RS resource configuration indexes have same values as RS indexes in RS sets indicated by the second TCI state.

16. The BS of claim 14, wherein both the first set of BFD RS resource configuration indexes and the second set of BFD RS resource configuration indexes are indicated for each bandwidth part (BWP) of a serving cell.

17. A method for operating a user equipment (UE), the method comprising:
receiving downlink control information (DCI) including a first TCI field indicating a first transmission configuration indication (TCI) state;
receiving information about a type of the first TCI state; and
determining, based on the first TCI state and the type of the first TCI state, a first set of beam failure detection (BFD) reference signal (RS) resource configuration indexes,
wherein the first TCI state indicates at least one of:
a RS for quasi co-location for at least one of: (1) a demodulation RS (DM-RS) of a first physical downlink shared channel (PDSCH) in a component carrier (CC), (2) a DM-RS of a first physical downlink control channel (PDCCH) in the CC, and (3) a first channel state information RS (CSI-RS), and
a reference for determining an uplink (UL) transmission spatial filter for at least one of: (1) a dynamic-grant and configured-grant based first physical uplink shared channel (PUSCH) in the CC, (2) a first physical uplink control channel (PUCCH) resource in the CC, and (3) a first sounding reference signal (SRS),
wherein the type of the first TCI state is a joint TCI state indicated by a DLorJointTCIState parameter, a separate downlink (DL) TCI state indicated by a DLorJointTCIState parameter, or a separate UL TCI state indicated by a UL-TCIState parameter, and
wherein the BFD RS resource configuration indexes correspond to periodic CSI-RS resource configuration indexes.

18. The method of claim 17, wherein:
the first TCI state is the joint TCI state or the separate DL TCI state, and
determining the BFD RS resource configuration indexes further comprises determining the BFD RS resource configuration indexes in the first set as the periodic CSI-RS resource configuration indexes having same values as RS indexes in RS sets indicated by the first TCI state.

19. The method of claim 17, wherein:
receiving the DCI further comprises receiving, in the DCI, one or more DCI fields indicating the first set of BFD RS resource configuration indexes,
the first TCI state is the joint TCI state or the separate DL TCI state,
the method further comprises assessing a radio link quality of one or more of the BFD RS resource configuration indexes in the first set that have same values as RS indexes in RS sets indicated by the first TCI state, and
the one or more DCI fields are: (1) dedicated DCI fields for indicating the first set of BFD RS resource configuration indexes or (2) reserved DCI fields to indicate the first set of BFD RS resource configuration indexes.

20. The method of claim 17, further comprising:
receiving a radio resource control (RRC) parameter or a medium access control (MAC) control element (CE) command indicating the first set of BFD RS resource configuration indexes; and
assessing a radio link quality of one or more of the BFD RS resource configuration indexes in the first set that have same values as RS indexes in RS sets indicated by the first TCI state, wherein the first TCI state is a joint TCI state or a separate DL TCI state.
